(19) United States
(12) Patent Application Publication
(10) Pub. No.: US 2021/0396955 A1
(43) Pub. Date: Dec. 23, 2021

(54) IMAGING LENS AND IMAGING APPARATUS

(71) Applicants: SONY SEMICONDUCTOR SOLUTIONS CORPORATION, KANAGAWA (JP); SONY CORPORATION, TOKYO (JP)

(72) Inventors: HIDEAKI OKANO, TOKYO (JP); KATSUJI KIMURA, KANAGAWA (JP)

(21) Appl. No.: 17/284,064

(22) PCT Filed: Sep. 26, 2019
(86) PCT No.: PCT/JP2019/037735

§ 371 Date: Apr. 9, 2021

(30) Foreign Application Priority Data
Oct. 17, 2018 (JP) 2018-195691

(51) Int. Cl. G02B 9/10; G02B 13/00

(52) U.S. Cl. CPC G02B 9/10; G02B 13/0045

(57) ABSTRACT

An imaging lens that includes, sequentially from an imaging object side, a first lens group having a positive refractive power and a second lens group having a negative refractive power, and in which the first lens group includes a first lens (L1) having a positive refractive power; a second lens (L2) having a positive refractive power; a third lens (L3) having a negative refractive power; a fourth lens (L4) having a positive or a negative refractive power; a fifth lens (L5) having a positive or a negative refractive power; a sixth lens (L6) having a positive or a negative refractive power; and a seventh lens (L7) having a negative refractive power, and the second lens group includes, sequentially from the imaging object side, an eighth lens (L8) having a positive or a negative refractive power; and a ninth lens (L9) having a positive or a negative refractive power, and that causes an imaging device (201) to form an image of a subject is provided.

### FIELD

The present disclosure relates to an imaging lens and an imaging apparatus.

### BACKGROUND

Conventionally, imaging apparatuses (or apparatuses equipped with an imaging apparatus) including a camera-equipped mobile phone, a smartphone, a digital still camera, or the like using an imaging device, such as a charge coupled device (CCD) and a complementary metal oxide semiconductor (CMOS), have been known. Further downsizing and reduction in thickness are needed for such an imaging apparatus and an imaging lens mounted on the imaging apparatus.

Moreover, particularly in a device, such as a camera-equipped mobile phone or a smartphone, along with downsizing and reduction in thickness, pixels and size of an imaging device have been increasing, and those models equipped with a high-definition imaging device having an equivalent performance to a digital still camera have become popular models. Accordingly, a high lens performance supporting increased definition and size of the imaging device is needed also for an imaging lens mounted on a device as a camera-equipped mobile phone or a smartphone, for example. Furthermore, an imaging lens having a large aperture, that is, a small f/number (bright), to achieve faster shutter speed while suppressing deterioration of image quality by noises, for example, in shooting in a dark place is needed.

To realize downsizing, reduction in thickness, and high performance of an imaging lens, there is a tendency to use more imaging lenses (for example, five or more pieces of lenses, or the like) in combination. For example, in Patent Literature 1 below, an imaging lens that has sufficient brightness equivalent to f/number of 2.0 while being capable of well correcting respective aberrations by providing a five-lens group is disclosed. When a first lens to a fifth lens are provided sequentially from an imaging object side, by arranging the first lens and the second lens relatively close to each other, the imaging lens according to Patent Literature 1 is enabled to correct a chromatic aberration favorably, and to correct a coma aberration caused by keeping the f/number small favorably also with the third lens and the fourth lens.

### CITATION LIST

### Patent Literature

Patent Literature 1: JP 2011-232772 A

### SUMMARY

### Technical Problem

However, by techniques of Patent Literature 1 and the like, there has been a case in which a optical performance corresponding to increased definition and size of an imaging device cannot be implemented while achieving downsizing and reduction in thickness of an imaging lens. For example, as for the imaging lens disclosed in Patent Literature 1, because the refractive power of the fourth lens is high, the assemblability of the imaging lens is deteriorated, and the optical performance of the entire imaging lens system is lowered. Moreover, the focal length and the entire optical path length are long compared to the size of the imaging device. Therefore, if downsizing or reduction in thickness of an imaging lens, expansion of an angle of view, or reduction of f/number is done further, it is considered to be difficult to correct respective aberrations, particularly, a spherical aberration and a coma aberration.

The present disclosure is achieved in view of the above situation, and provides a novel and improved imaging lens and an imaging apparatus that enable to implement an optical performance corresponding to high definition and increased size of an imaging device while achieving compact size and reduced thickness of an imaging lens.

### Solution to Problem

According to the present disclosure, an imaging lens that causes an imaging device to form an image of a subject is provided, the imaging lens including, sequentially from an imaging object side: a first lens group that has a positive refractive power; and a second lens group that has a negative refractive power, wherein the first lens group includes, sequentially from the imaging object side, a first lens having a positive refractive power; a second lens having a positive refractive power; a third lens having a negative refractive power; a fourth lens having any one of positive and negative refractive powers; a fifth lens having any one of positive and negative refractive powers; a sixth lens having any one of positive and negative refractive powers; and a seventh lens having a negative refractive power, and the second lens group includes, sequentially from the imaging object side, an eighth lens having any one of positive and negative refractive powers; and a ninth lens having any one of positive and negative refractive powers.

Moreover, according to the present disclosure, an imaging apparatus is provided that includes, sequentially from an imaging object side: a first lens group that has a positive refractive power; a second lens group that has a negative refractive power; and an imaging device that converts a subject image formed by the first lens group and the second lens group into an electrical signal, wherein the first lens group includes, sequentially from the imaging object side, a first lens having a positive refractive power; a second lens having a positive refractive power; a third lens having a negative refractive power; a fourth lens having any one of positive and negative refractive powers; a fifth lens having any one of positive and negative refractive powers; a sixth lens having any one of positive and negative refractive powers; and a seventh lens having a negative refractive power, and the second lens group includes, sequentially from the imaging object side, an eighth lens having any one of positive and negative refractive powers; and a ninth lens having any one of positive and negative refractive powers.

### BRIEF DESCRIPTION OF DRAWINGS

FIG. 1 is a diagram illustrating a structure of an imaging lens according to a first example.

FIG. 2 is a longitudinal aberration diagram in a visible light wavelength band acquired by the imaging lens according to the first example.

FIG. 3 is a diagram illustrating a structure of an imaging lens according to a second example.

FIG. 4 is a longitudinal aberration diagram in a visible light wavelength band acquired by the imaging lens according to the second example.

FIG. 5 is a diagram illustrating a structure of an imaging lens according to a third example.

FIG. 6 is a longitudinal aberration diagram in a visible light wavelength band acquired by the imaging lens according to the third example.

FIG. 7 is a diagram illustrating a structure of an imaging lens according to a fourth example.

FIG. 8 is a longitudinal aberration diagram in a visible light wavelength band acquired by the imaging lens according to the fourth example.

FIG. 9 is a diagram illustrating a structure of an imaging lens according to a fifth example.

FIG. 10 is a longitudinal aberration diagram in a visible light wavelength band acquired by the imaging lens according to the fifth example.

FIG. 11 is a diagram illustrating a structure of an imaging lens according to a sixth example.

FIG. 12 is a longitudinal aberration diagram in a visible light wavelength band acquired by the imaging lens according to the sixth example.

FIG. 13 is a diagram illustrating a structure of an imaging lens according to a seventh example.

FIG. 14 is a longitudinal aberration diagram in a visible light wavelength band acquired by the imaging lens according to the seventh example.

FIG. 15 is a diagram illustrating a structure of an imaging lens according to an eighth example.

FIG. 16 is a longitudinal aberration diagram in a visible light wavelength band acquired by the imaging lens according to the eighth example.

FIG. 17 is a diagram illustrating a structure of an imaging lens according to a ninth example.

FIG. 18 is a longitudinal aberration diagram in a visible light wavelength band acquired by the imaging lens according to the ninth example.

FIG. 19 is a diagram illustrating a structure of an imaging lens according to a tenth example.

FIG. 20 is a longitudinal aberration diagram in a visible light wavelength band acquired by the imaging lens according to the tenth example.

FIG. 21 is a diagram illustrating a structure of an imaging lens according to a eleventh example.

FIG. 22 is a longitudinal aberration diagram in a visible light wavelength band acquired by the imaging lens according to the eleventh example.

FIG. 23 is a diagram illustrating a structure of an imaging lens according to a twelfth example.

FIG. 24 is a longitudinal aberration diagram in a visible light wavelength band acquired by the imaging lens according to the twelfth example.

FIG. 25 is a diagram illustrating a structure of an imaging lens according to a thirteenth example.

FIG. 26 is a longitudinal aberration diagram in a visible light wavelength band acquired by the imaging lens according to the thirteenth example.

FIG. 27 is a block diagram illustrating a configuration of an imaging apparatus that is equipped with the imaging lens according to the present embodiment.

### DESCRIPTION OF EMBODIMENTS

Hereinafter, exemplary embodiments of the present disclosure will be explained in detail with reference to the accompanying drawings. An identical reference sign is assigned to components having a substantially identical functional configuration throughout the specification and drawings, and duplicated explanation will be thereby omitted.

Explanation will be given in following order.

### 1. One Embodiment of Imaging Lens

### 2. Example of Imaging Lens

3. One embodiment of Imaging Apparatus

### One Embodiment of Imaging Lens

First, one embodiment of an imaging lens according to the present disclosure will be explained.

The imaging lens according to the present embodiment is assumed to cause an imaging device to form an image of a subject, and to be equipped in an imaging apparatus, such as a camera-equipped mobile phone, a smartphone, or a digital still camera. Moreover, because the present disclosure enables further downsizing and reduction in thickness of an imaging lens, the imaging lens according to the present embodiment is assumed to be equipped in a particularly compact and thin imaging apparatus. It is noted that a type of an apparatus in which the imaging lens is equipped, or the size thereof are not particularly limited. Details of the imaging apparatus in which the imaging lens according to the present embodiment will be explained in a later part.

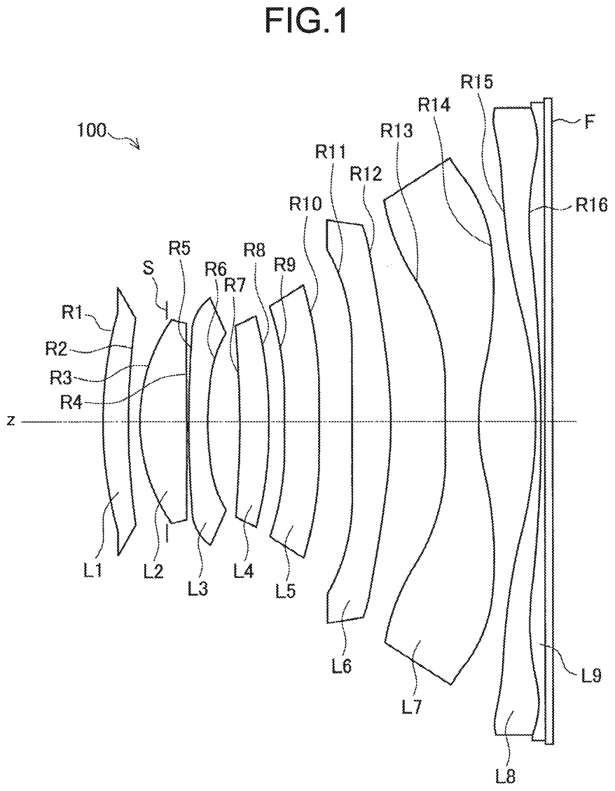

FIG. 1 is a diagram illustrating one example of an imaging lens 100 according to the present embodiment. As illustrated in FIG. 1, the imaging lens 100 according to the present embodiment includes nine pieces of lenses. When the imaging lens 100 is explained in the viewpoint of refractive powers of the respective lenses, the imaging lens 100 includes a first lens group La1 having a positive refractive power, and a second lens group La2 having a negative refractive power. The first lens group La1 includes, sequentially from an imaging object side, a first lens L1 having a positive refractive power, a second lens L2 having a positive refractive power, a third lens L3 having a negative refractive power, a fourth lens L4 having a positive or negative refractive power, a fifth lens L5 having a positive or negative refractive power, a sixth lens L6 having a positive or negative refractive power, and a seventh lens L7 having a negative refractive power. On the other hand, the second lens group La2 includes, sequentially from the imaging object side, an eighth lens L8 having a positive or negative refractive power, and a ninth lens L9 having a positive or negative refractive power.

The first lens L1 to the eighth lens L8 are assumed to be arranged in a state of being separated from one another (not necessarily required to be separated), and the eighth lens L8 and the ninth lens L9 are assumed to be joined such that a surface on an image side of the eighth lens L8 and a surface on the imaging object side (at least a part of each surface) of the ninth lens L9 are in intimate connection. Note that a method of joining the eight lens L8 and the ninth lens L9 is not particularly limited.

As illustrated in FIG. 1, on a surface on the image side of the ninth lens L9, a seal glass F is arranged. The seal glass F is a part (glass substrate) to fix an imaging device, and the seal glass F and the imaging device are unified to form a chip size package (CSP) imaging device. On the image side of the seal glass F, the imaging device (not illustrated) is arranged, and a surface of the seal glass F on the image side is to be an image forming surface.

Furthermore, when surface numbers of the respective lenses are explained, as illustrated in FIG. 1, a first surface (in the respective lenses, a surface on the imaging object side is denoted as the first surface, and a surface on the image side is denoted as a second surface) of the first lens L1 is denoted as R1, a second surface thereof is denoted as R2, a first surface of the second lens L2 is denoted as R3, and a second surface thereof is denoted as R4, a first surface of the third lens L3 is denoted as R5, and a second surface thereof is denoted as R6, a first surface of the fourth lens L4 is denoted as R7, a second surface thereof is denoted as R8, a first surface of the fifth lens L5 is denoted as R9, and a second surface thereof is denoted as R10, a first surface of the sixth lens L6 is denoted as R11, a second surface thereof is denoted as R12, a first surface of the seventh lens L7 is denoted as R13, and a second surface thereof is denoted as R14, a first surface of the eighth lens L8 is denoted as R15, and a first surface of the ninth lens L9 (in other words, a second surface of the eighth lens L8) is denoted as R16. At this time, an aperture stop S is assumed to be arranged between R2, which is the second surface of the first lens L1, and R3, which is the first surface of the second lens L2 (not necessarily limited this arrangement).

The structure of the imaging lens 100 according to the present embodiment is not necessarily limited to the example in FIG. 1. More specifically, a part of the structure illustrated in FIG. 1 (assumed to be a part other than the respective lenses) may be omitted or replaced with another structure, or other structure not illustrated in FIG. 1 (for example, various kinds of filters, such as an infrared cut filter, and the like) may be provided in the imaging lens 100. For example the imaging lens 100 according to the present embodiment may include only the first lens L1 to the ninth lens L9.

In the present embodiment, when a focal length with respect to the d-line (wavelength approximately 587.6 [nm]) of the entire system of the imaging lens 100 is f, and a focal length with respect to the d-line of the first lens group La1 is fa1, and a focal length with respect to the d-line of the second lens group La2 is fa2, the imaging lens 100 satisfies a condition expressed by following inequation (101).

$$5.0 < \vert \frac{f}{f a 1 \text{/} f a 2} \vert < 500 \qquad ( 101 )$$

Inequation (101) defines an appropriate relationship of refractive powers (or focal lengths) of the first lens group La1 and the second lens group La2 with respect to the refractive power (or focal length) of the entire system of the imaging lens 100. It is requested to pay attention to a point that a reason why an absolute value is used in Inequation (101) is because the second lens group La2 has a negative refractive power (or focal length).

In Inequation (101), when a value expressed by |f/(fa1/fa2)| is 500 or larger, the refractive power (absolute value) of the second lens group La2 is too small with respect to the refractive power (absolute value) of the entire system of the imaging lens 100 and the refractive power (absolute value) of the first lens group La1, and the imaging lens 100 cannot exert a sufficient aberration correction effect. Particularly, correction of an off-axis aberration (astigmatism, coma aberration, or the like), distortion, or field curvature by the imaging lens 100 becomes difficult.

Moreover, in Inequation (101), when a value expressed by |f/(fa1/fa2)| is 5.0 or smaller, the refractive power (absolute value) of the second lens group La2 is too large with respect to the refractive power (absolute value) of the entire system of the imaging lens 100 and the refractive power (absolute value) of the first lens group La1, and the balance in the aberration correction effect between the first lens group La1 and the second lens group La2 becomes worse, and because the entire optical length of the imaging lens 100 becomes longer, it leads to an opposite result to the demand for downsizing and reduction in thickness.

The imaging lens 100 is more preferable to satisfy a condition expressed by following Inequation (102) in which the condition expressed by Inequation (101) is further restricted. By this condition, the imaging lens 100 can correct respective aberrations more favorably while being compact and thin.

$$8.0 < \vert \frac{f}{f a 1 \text{/} f a 2} \vert < 400 \qquad ( 102 )$$

Moreover, when a focal length with respect to the d-line of the eighth lens L8 is f8, and a focal length with respect to the d-line of the ninth lens L9 is f9, the imaging lens 100 satisfies a condition expressed by following Inequation (201).

$$10 < \vert \frac{f a 2}{f 9 \text{/} f 8} \vert < 5000 \qquad ( 201 )$$

Inequation (201) defines an appropriate relationship of respective refractive powers (or focal lengths) of the eighth lens L8 and the ninth lens L9 with respect to the refractive power (or focal length) of the second lens group La2. It is requested to pay attention to a point that a reason why an absolute value is used in Inequation (201) is because the second lens group La2 has a negative refractive power (or focal length).

In Inequation (201), when a value expressed by |fa2/(f9/f8)| is 5000 or larger, the refractive power (absolute value) of the ninth lens is too large with respect to the refractive power (absolute value) of the second lens group La2 and the refractive power (absolute value) of the eighth lens and, particularly, the field curvature or the distortion are thereby excessively corrected.

Moreover, in Inequation (201), when a value expressed by |fa2/(f9/f8)| is 10 or smaller, the refractive power (absolute value) of the ninth lens is too small with respect to the refractive power (absolute value) of the second lens group La2 and the refractive power (absolute value) of the eighth lens, and because the ninth lens L9 becomes difficult to function as a lens, the aberration correction effect cannot be exerted sufficiently. Particularly, correction of an off-axis aberration (astigmatism, coma aberration, or the like), distortion, or field curvature by the imaging lens 100 becomes difficult.

The imaging lens 100 is more preferable to satisfy a condition expressed by following Inequation (202) in which the condition expressed by Inequation (201) is further restricted. By this condition, the imaging lens 100 can correct respective aberrations more favorably while being compact and thin.

$$10 < \vert \frac{f a 2}{f 9 \text{/} f 8} \vert < 4200 \qquad ( 202 )$$

Moreover, when a refractive index with respect to the d-line of the eighth lens L8 is Nd8, and a refractive index with respect to the d-line of the ninth lens L9 is Nd9, the imaging lens 100 satisfies a condition expressed by following Inequation (301).

$$\vert \frac{f 8 \times N d 8}{f 9 \times N d 9} ⌉ < 30 \qquad ( 301 )$$

Inequation (301) defines an appropriate relationship between the refractive index of the eight lens L8 with respect to the refractive power of the eighth lens L8 and the refractive index of the night lens L9 with respect to the refractive power of the ninth lens L9. It is requested to pay attention to a point that a reason why an absolute value is used in Inequation (301) is because either one of the eighth lens L8 and the ninth lens L9 has a negative refractive index.

In Inequation (301), when a value expressed by |(f8×Nd8)/(f9×Nd9)| is 30 or larger, the refractive power (absolute value) of the eighth lens L8 is too small with respect to the refractive power (absolute value) of the ninth lens L9, and it becomes difficult to correct the respective aberrations, particularly, the field curvature by the imaging lens 100.

The imaging lens 100 is more preferable to satisfy a condition expressed by following Inequation (302) in which the condition expressed by Inequation (301) is further restricted. By this condition, the imaging lens 100 can correct respective aberrations more favorably while being compact and thin.

$$\vert \frac{f 8 \times N d 8}{f 9 \times N d 9} ⌉ < 22 \qquad ( 302 )$$

Moreover, when a curvature radius of a surface (first surface R15 of the eighth lens L8) positioned on the imaging object side of the eighth lens L8 is r15, and a curvature radius of a surface (first surface R16 of the ninth lens L9) positioned on the imaging object side is r16, the imaging lens 100 satisfies a condition expressed by following Inequation (401).

$$\vert \frac{r 15 - r 16}{r 15 + r 16} \vert < 3.5 \qquad ( 401 )$$

Inequation (401) defines an appropriate relationship between the curvature radius r15 of the first surface R15 of the eighth lens L8 and the curvature radius r16 of the first surface R16 of the ninth lens L9 (or a second surface of the eighth lens L8). In Inequation (401), when a value expressed by |(r15−r16)/(r15+r16)| is 3.5 or larger and a degree of curve expressed by the curvature radius r16 becomes too sharp with respect to a degree of curve expressed by the curvature radius r15, the imaging lens 100 cannot correct the field curvature appropriately (in other words, the image plane is deteriorated).

The imaging lens 100 is more preferable to satisfy a condition expressed by following Inequation (402) in which the condition expressed by Inequation (401) is further restricted. By this condition, the imaging lens 100 can correct respective aberrations more favorably while being compact and thin.

$$\vert \frac{r 15 - r 16}{r 15 + r 16} \vert < 3.0 \qquad ( 402 )$$

Furthermore, the imaging lens 100 satisfies a condition expressed by following Inequation (501) when an entire optical length of the imaging lens 100 is TL, and a maximum image height on the image forming surface is IH.

$$\frac{T L}{I H} < 1.6 \qquad ( 501 )$$

Inequation (501) defines an appropriate relationship between the entire optical length TL of the imaging lens 100 and the maximum image height IH on the image forming surface. In Inequation (501), when a value expressed by TL/IH is 1.6 or larger, the entire optical length TL is too long with respect to the maximum image height IH, and it leads to an opposite result to the demand for downsizing and reduction in thickness of the imaging lens 100 (correction of aberrations is possible).

The imaging lens 100 is more preferable to satisfy a condition expressed by following Inequation (502) in which the condition expressed by Inequation (501) is further restricted. By this condition, the imaging lens 100 that is high performance and is more compact and thinner is implemented.

$$\frac{T L}{I H} < 1.5 \qquad ( 502 )$$

Moreover, a surface of the second lens L2 on the imaging object side (first surface R3 of the second lends L2) is a convex surface. This makes an offset distance between the second surface R2 of the first lens L1 and the first surface R3 of the second lens L2 becomes short and, therefore, respective aberrations, particularly, a chromatic aberration can be corrected well by the imaging lens 100. Note that a surface of the second lens L2 on the image side (second surface R4 of the second lens L2) may be either a convex surface or a concave surface.

Furthermore, a surface of the third lens L3 on the imaging object side (second surface R6 of the third lends L3) is a concave surface. This implements a favorable aberration correction effect, and enables to make the imaging lens 100 be more compact and thinner. Note that a surface of the third lens L3 on the imaging object side (first surface R5 of the third lens L3) may be either a convex surface or a concave surface.

Moreover, when a focal length with respect to the d-line of the first lens L1 is f1, and a focal length with respect to the d-line of the second lens L2 is f2, and a focal length with respect to the d-line of the third lens L3 is f3, the imaging lens 100 satisfies a condition expressed by following inequation (601).

$$\vert \frac{f 1 + f 2}{f 3} \vert < 8.0 \qquad ( 601 )$$

Inequation (601) defines an appropriate relationship of a total value of the refractive powers of the first lens L1 and the second lens L2 and a refractive power of the third lens L3. It is requested to pay attention to a point that a reason why an absolute value is used in Inequation (601) is because the third lens L3 has a negative refractive power.

In Inequation (601), when a value expressed by |(f1+f2)/f3| is 8.0 or larger, the refractive power (absolute value) of the third lens L3 is too high with respect to the total value (absolute value) of the refractive powers of the first lens L1 and the second lens L2, and it becomes difficult to appropriately correct respective aberrations, particularly, a chromatic aberration by the imaging lens 100.

The imaging lens 100 is more preferable to satisfy a condition expressed by following Inequation (602) in which the condition expressed by Inequation (601) is further restricted. By this condition, the imaging lens 100 can correct respective aberrations, particularly, a chromatic aberration more favorably while being compact and thin.

$$\vert \frac{f 1 + f 2}{f 3} \vert < 7.0 \qquad ( 602 )$$

Moreover, when an Abbe number with respect to the d-line of the second lens L2 is νd2, an Abbe number with respect to the d-line of the third lens L3 is νd3, an Abbe number with respect to the d-line of the fourth lens L4 is νd4, and an Abbe number with respect to the d-line of the fifth lens L5 is νd5, the imaging lens 100 satisfies a condition expressed by following inequation (701).

$$\frac{v d 2 \text{/} v d 3}{v d 4 \text{/} v d 5} < 3.5 \qquad ( 701 )$$

Inequation (701) defines an appropriate relationship of the Abbe number νd2 of the second lens L2, the Abbe number νd3 of the third lens L3, the Abbe number νd4 of the fourth lens L4, and the Abbe number νd5 of the fifth lens L5. In Inequation (701), when a value expressed by (νd2/νd3)/(νd4/νd5) is 3.5 or larger, the balance in the aberration correction effect by the respective lenses is disrupted, and the imaging lens 100 becomes impossible to correct a chromatic aberration favorably.

The imaging lens 100 is more preferable to satisfy a condition expressed by following Inequation (702) in which the condition expressed by Inequation (701) is further restricted. By this condition, the imaging lens 100 can correct the chromatic aberrations more favorably while being compact and thin.

$$\frac{v d 2 \text{/} v d 3}{v d 4 \text{/} v d 5} < 3.0 \qquad ( 702 )$$

When a focal length with respect to the d-line of the fourth lens L4 is f4, a focal length with respect to the d-line of the fifth lens L5 is f5, a focal length with respect to the d-line of the sixth lens L6 is f6, and a focal length with respect to the d-line of the seventh lens L7 is f7, the imaging lens 100 satisfies a condition expressed by following inequation (801).

$$\vert \frac{f 4 + f 5 + f 6}{f 7} \vert < 14.0 \qquad ( 801 )$$

Inequation (801) defines an appropriate relationship of a total value of the refractive powers of the fourth lens L4, the fifth lens L5, and the sixth lens L6 and a refractive power of the seventh lens L7. In Inequation (801), when a value expressed by |(f4+f5+f6)/f7| is 14.0 or larger, the refractive power (absolute value) of the seventh lens L7 is too high with respect to the total value (absolute value) of the refractive powers of the fourth lens L4, the fifth lens L5, and the sixth lens L6, and it becomes difficult to appropriately correct respective aberrations, particularly, a coma aberration or a field curvature by the imaging lens 100.

The imaging lens 100 is more preferable to satisfy a condition expressed by following Inequation (802) in which the condition expressed by Inequation (801) is further restricted. By this condition, the imaging lens 100 can correct respective aberrations, particularly, the coma aberration or the field curvature more favorably while being compact and thin.

$$\vert \frac{f 4 + f 5 + f 6}{f 7} \vert < 11.0 \qquad ( 802 )$$

### 2. Examples of Imaging Lens

In the above description, one embodiment of the imaging lens 100 according to the present disclosure has been explained. Subsequently, various examples of the imaging lens 100 according to the present embodiment will be specifically explained. The disclosers of this case performed simulation about optical characteristics of the imaging lens 100 by using a predetermined lens design application in a first example to a thirteenth example described below. Set-up conditions of the respective examples and obtained simulation results will be specifically explained.

The first example to the thirteenth example described below are only an example of the imaging lens 100 according to the present embodiment, and the imaging lens 100 according to the present embodiment is not limited to these examples. Moreover, although all of the above inequations (namely, Inequation (101) to Inequation (801) and Inequation (102) to Inequation (802) expressing more preferable conditions) are satisfied in the first example to the thirteenth example described below, it is not limited thereto. More specifically, a part of or all of the above inequations may be unsatisfied.

### 2.1. First Example

First, the first example of the imaging lens 100 according to the present embodiment will be specifically explained.

FIG. 1 is a diagram illustrating a structure of the imaging lens 100 according to the first example. As described above, the imaging lens 100 according to the first example includes nine pieces of lenses. Moreover, in the viewpoint of shape, a surface of the second lens on the imaging object side (the first surface R3 of the second lens L2) is a convex surface, and the surface of the third lens L3 on the image side (the second surface R6 of the third lens L3) is a concave surface.

Table 1 to Table 3 show specific lens data of the imaging lens 100 according to the first example. More specifically, Table 1 shows basic lens data of the respective lenses provided in the imaging lens 100 according to the first example. Table 2 shows basic lens data about the entire system (or the first lens group La1 and the second lens group La2) of the imaging lens 100 according to the first example. Table 3 shows aspheric surface data of the respective lenses provided in the imaging lens 100 according to the first example.

“Surface Number” in Table 1 indicates a surface number of the first surface and the second surface of the respective lenses explained in the above description, referring to FIG. 1. “Curvature Radius” in Table 1 indicates a curvature radius [mm] of a surface corresponding to each surface number. “Interval” in Table 1 indicates an offset distance [mm] on the optical axis between a surface of a surface number Ri and a surface of s surface number Ri+1. “Refractive Index”, “Abbe Number”, and “Focal Length” in Table 1 indicate a refractive index, an Abbe number, and a focal length [mm] with respect to the d-line (wavelength approximately 587.6 [nm]) of the respective lenses (In Table 1, “Refractive Index”, “Abbe Number”, and “Focal Length” are indicated in columns of the first surface of the respective lenses for convenience).

Furthermore, “Fno” in Table 2 indicates f/number of the entire system of the imaging lens 100. “Focal Length of Entire System of Imaging Lens”, “Focal Length of First Lens Group”, and “Focal Length of Second Lens Group” in Table 2 indicate focal lengths [mm] with respect to the respective d-line (wavelength approximately 587.6 [nm]) of the entire system of the imaging lens 100, the first lens group La1, and the second lens group La2. “Half Angle of View” and “Angle of View” in Table 2 indicate a half angle of view [deg] and an angle of view [deg] of an opposite angle. “Entire Optical Length” in Table 2 indicates an entire optical length [mm] of the imaging lens 100. “Image Height” in Table 2 indicates a maximum image height [mm] on the image forming surface.

Moreover, an aspheric shape of each surface of the respective lenses is expressed by following Equation (1) when a depth of an aspheric surface is Z [mm], a height from the optical axis is Y [mm], a conic constant is K, a curvature radius is r [mm], and a high-order aspheric coefficient is Ai (i is a positive integer of 3 or larger).

$$Z = \frac{{Y}^{2} \text{/} r}{1 + \sqrt{1 - ( 1 + K ) \cdot {( Y \text{/} r )}^{2}}} + \sum A i \cdot {Y}^{i} \qquad ( 1 )$$

Furthermore, in Table 3, the conic coefficient K relating to an aspheric surface shape of each surface of the respective lenses and the high-order aspheric surface coefficient Ai are indicated. In Table 3, a sign “E” indicates that a following numeric value is an “exponent” of the base 10, and that a numeric value before the sign “E” is multiplied by the numeric value expressed by an exponential function of the base 10. For example, “1.0E-2” indicates “1.0×10⁻²”. The imaging lens 100 according to the relevant example is expressed by using coefficients up to an order of 20 effectively as the high-order aspheric coefficient Ai. Although omitted in the table, high-order aspheric coefficients A1 and A2 of the order of 1 and 2 are 0.

TABLE 1
First Example Lens Data 1

| Surface | Curvature | | Refractive | Abbe | Focal |
|---|---|---|---|---|---|
| number | radius | Interval | index | number | length |
| R1 | 4.4122 | 0.4437 | 1.5400 | 54.0000 | 16.983 |
| R2 | 8.1480 | 0.1904 | — | — | — |
| R3 | 3.6859 | 0.8276 | 1.5400 | 54.0000 | 6.295 |
| R4 | −44.3730 | 0.0321 | — | — | — |
| R5 | 44.9585 | 0.3242 | 1.6320 | 23.6000 | —9.450 |
| R6 | 5.2829 | 0.5553 | — | — | — |
| R7 | −102.2515 | 0.5159 | 1.5400 | 54.0000 | 23.333 |
| R8 | −11.3098 | 0.2646 | — | — | — |
| R9 | 101.3131 | 0.5957 | 1.6320 | 23.6000 | −36.772 |
| R10 | 18.9451 | 0.5638 | — | — | — |
| R11 | 18.7875 | 0.6952 | 1.5400 | 54.0000 | 10.967 |
| R12 | −8.6252 | 0.9124 | — | — | — |
| R13 | 8.8492 | 0.6045 | 1.5350 | 53.0000 | −8.693 |
| R14 | 2.9775 | 0.9934 | — | — | — |
| R15 | −6.4769 | 0.1000 | 1.6200 | 48.0000 | −14.989 |
| R16 | −70.7100 | 0.0500 | 1.3840 | 71.2000 | 454.778 |

TABLE 2
First Example Lens Data 2

| | |
|---|---|
| Fno | 1.740 |
| Focal length of entire system of imaging lens | 6.279 |
| Focal length of first lens group | 6.118 |
| Focal length of second lens group | −16.390 |
| Half angle of view | 39.421 |
| Angle of view | 78.842 |
| Entire optical length | 7.800 |
| Image height | 5.560 |

TABLE 3
First Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.41225E+00 | — | −1.62944E−02 | — | −1.47029E−03 | — | 1.89869E−04 |
| R2 | 8.14798E+00 | — | −1.20627E−02 | — | 1.80441E−03 | — | −1.39903E−04 |
| R3 | 3.68587E+00 | — | 1.99579E−02 | — | 8.17017E−04 | — | 1.57120E−04 |
| R4 | −4.43730E+01 | — | 9.16249E−03 | — | −5.28518E−03 | — | 1.29628E−03 |
| R5 | 4.49585E+01 | — | 1.58865E−04 | — | −4.50363E−04 | — | 9.56276E−04 |
| R6 | 5.28287E+00 | — | −3.08049E−03 | — | 5.58232E−03 | — | −4.78673E−04 |
| R7 | −1.02252E+02 | — | −7.11950E−03 | — | −2.26310E−03 | — | −1.79034E−04 |
| R8 | −1.13098E+01 | — | −2.28221E−03 | — | −9.05439E−03 | — | 4.24745E−03 |
| R9 | −9.33322E+00 | −9.04076E−03 | 3.41342E−03 | −2.01506E−02 | 4.61143E−03 | 5.74429E−04 | −8.77301E−05 |
| R10 | −9.33322E+00 | −9.04076E−03 | 3.41342E−03 | −2.01506E−02 | 4.61143E−03 | 5.74429E−04 | −8.77301E−05 |
| R11 | 1.00000E+01 | −1.46549E−02 | 1.50632E−02 | −9.51887E−03 | 3.69799E−05 | 4.41866E−05 | 6.77019E−05 |
| R12 | −3.28274E+00 | −1.63012E−02 | 1.74773E−02 | −3.09678E−03 | −1.18056E−03 | 2.61801E−04 | 9.48887E−05 |
| R13 | 7.69882E−02 | −2.04664E−02 | −4.37724E−02 | 1.08665E−02 | 1.12154E−03 | −9.27832E−05 | −9.28362E−05 |
| R14 | −5.40490E+00 | −1.61235E−02 | −2.42263E−02 | 1.05887E−02 | −7.68109E−05 | −5.73717E−04 | 6.66711E−05 |
| R15 | 0.00000E+00 | — | 3.95943E−03 | — | −1.26435E−04 | — | 1.29501E−05 |
| R16 | 0.00000E+00 | — | −2.01844E−03 | — | −6.26309E−05 | — | 2.55090E−05 |

| | A9 | A10 | A11 | A12 | A13 | A14 | A15 |
|---|---|---|---|---|---|---|---|
| R1 | — | 4.32234E−05 | — | −9.33611E−06 | — | — | — |
| R2 | — | 3.52704E−05 | — | −2.54880E−06 | — | — | — |
| R3 | — | −1.07320E−04 | — | 3.07806E−06 | — | — | — |
| R4 | — | −1.38820E−04 | — | 6.33110E−06 | — | — | — |
| R5 | — | −4.84204E−05 | — | −9.64942E−06 | — | 2.05430E−06 | — |
| R6 | — | 3.80274E−04 | — | −3.91000E−05 | — | 8.02849E−06 | — |
| R7 | — | 6.34596E−04 | — | −1.27637E−04 | — | 1.25216E−05 | — |
| R8 | — | −8.32921E−04 | — | 1.02113E−04 | — | −5.47174E−06 | — |
| R9 | 2.04743E−04 | 6.93404E−05 | −3.45675E−06 | −2.46478E−05 | −5.72952E−06 | 9.93122E−07 | 6.94057E−08 |
| R10 | 2.04743E−04 | 6.93404E−05 | −3.45675E−06 | −2.46478E−05 | −5.72952E−06 | 9.93122E−07 | 6.94057E−08 |
| R11 | −1.12106E−05 | 5.10591E−06 | 4.20145E−06 | −1.12378E−06 | 4.11812E−07 | −1.42068E−07 | 4.13851E−08 |
| R12 | −9.14728E−06 | −5.04841E−06 | −4.78819E−07 | −1.46423E−08 | 9.17789E−08 | 1.11519E−08 | −3.27761E−09 |
| R13 | 1.66240E−06 | 2.56623E−06 | 2.34164E−08 | −5.67373E−08 | 2.68806E−10 | 6.09352E−10 | −7.94150E−11 |
| R14 | 4.87174E−07 | 5.14935E−07 | 8.83120E−08 | −5.36226E−08 | −5.324823E−10 | 1.50654E−09 | −8.76977E−11 |
| R15 | | −6.80347E−07 | — | 1.12885E−08 | — | — | — |
| R16 | | −1.14405E−06 | — | 1.46507E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | −3.12710E−08 | −8.99037E−08 | −7.24477E−08 | −2.06553E−08 | 2.62554E−08 |
| R10 | −3.12710E−08 | −8.99037E−08 | −7.24477E−08 | −2.06553E−08 | 2.62554E−08 |
| R11 | 7.13932E−09 | −2.38596E−09 | −1.72057E−09 | −1.52824E−10 | 8.20642E−11 |
| R12 | −1.44476E−10 | −7.67951E−12 | −7.40998E−12 | −2.28885E−12 | −1.70502E−12 |
| R13 | −5.97337E−12 | −1.27287E−12 | −1.31038E−13 | 8.33023E−14 | 5.78819E−14 |
| R14 | −2.91874E−11 | −2.70874E−12 | −1.46594E−13 | 7.40290E−14 | 5.27514E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 4 below.

TABLE 4

| | | |
|---|---|---|
| (101) | 5.0<f/(\|fa1/fa2\|)<500 | 16.821 |
| (201) | 10<\|fa2/(f9/f8)\|<5000 | 497.280 |
| (301) | \|(f8*Nd8)/(f9*Nd9)\|<30 | 0.074 |
| (401) | \|((R15 − R16)/(R15 + R16))\|<3.5 | 0.832 |
| (501) | TL/IH<1.6 | 1.403 |
| (601) | \|(f1 + f2)/f3\|<8.0 | 2.463 |
| (701) | (Vd2/Vd3)/ (Vd4/Vd5)<3.5 | 1.000 |
| (801) | \|(f4 + f5 + f6)/f7\|<14 | 0.284 |

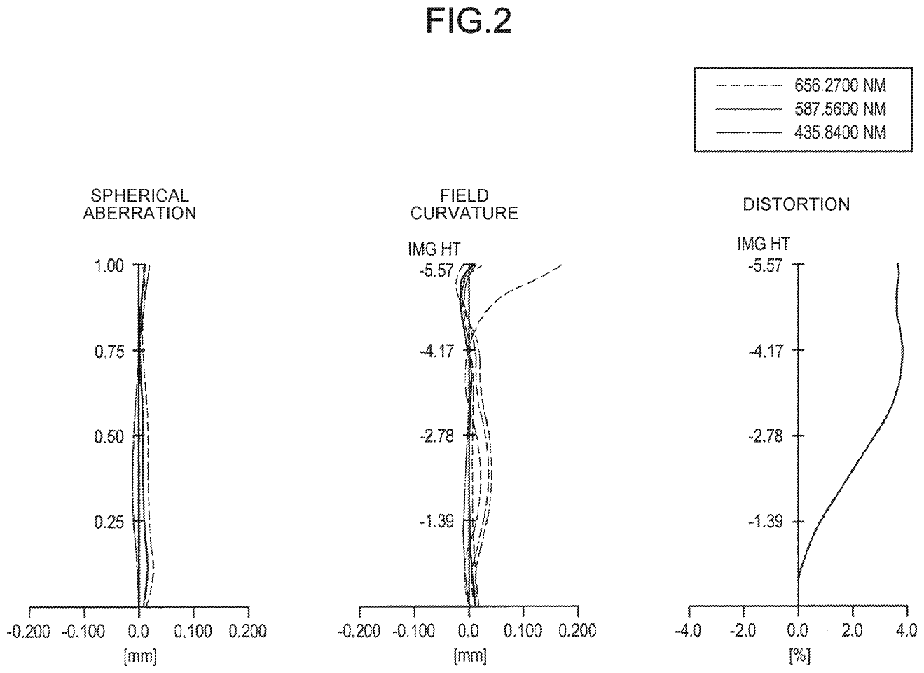

FIG. 2 is a longitudinal aberration diagram in a visible light wavelength band acquired by the imaging lens 100 according to the first example. In FIG. 2, aberration diagrams corresponding to a spheric aberration, a field curvature, and a distortion are presented sequentially from the left side.

### 2.2. Second Example

Subsequently, the second example of the imaging lens 100 according to the present embodiment will be specifically explained.

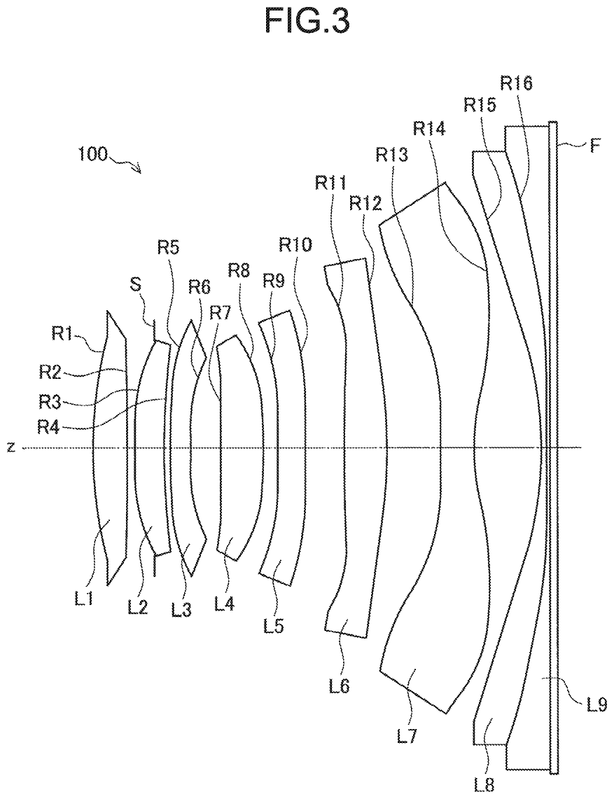

FIG. 3 is a diagram illustrating a structure of an imaging lens 100 according to a second example. The imaging lens 100 according to the second example also has nine pieces of lenses similarly to the first example. Moreover, in terms of shape also, similarly to the first example, the surface of the second lens L2 on the imaging object side (the first surface R3 of the second lens L2) is a convex surface, and the surface of the third lens L3 on the image side (the second surface R6 of the third lens L3) is a concave surface.

Table 5 to Table 7 show specific lens data of the imaging lens 100 according to the second example. More specifically, Table 5 shows basic lens data of the respective lenses provided in the imaging lens 100 according to the second example. Table 6 shows basic lens data about the entire system (or the first lens group La1 and the second lens group La2) of the imaging lens 100 according to the second example. Table 7 shows aspheric surface data of the respective lenses provided in the imaging lens 100 according to the second example. What is described in the respective tables are similar to those of the first example explained above and, therefore, explanation thereof is omitted.

TABLE 5
Second Example Lens Data 1

| Surface | Curvature | | Refractive | Abbe | Focal |
|---|---|---|---|---|---|
| number | radius | Interval | index | number | length |
| R1 | 4.4286 | 0.6000 | 1.5400 | 54.0000 | 7.261 |
| R2 | −34.7526 | 0.1120 | — | — | — |
| R3 | 10.9058 | 0.5188 | 1.5400 | 54.0000 | 71.814 |
| R4 | 14.8768 | 0.1000 | — | — | — |
| R5 | 12.4204 | 0.3394 | 1.6600 | 20.5000 | −14.461 |
| R6 | 5.3438 | 0.2749 | — | — | — |
| R7 | 17.0983 | 0.7583 | 1.5400 | 54.0000 | 12.446 |
| R8 | −11.0307 | 0.2661 | — | — | — |
| R9 | −45.9216 | 0.4500 | 1.6320 | 23.6000 | −27.148 |
| R10 | 27.7405 | 0.6612 | — | — | — |
| R11 | 15.3615 | 0.7464 | 1.5400 | 54.0000 | 10.471 |
| R12 | −8.8957 | 0.8636 | — | — | — |
| R13 | 5.4983 | 0.6000 | 1.5350 | 53.0000 | −10.563 |
| R14 | 2.6818 | 1.1948 | — | — | — |
| R15 | −5.8639 | 0.1000 | 1.6600 | 19.5000 | −12.094 |
| R16 | 143.1692 | 0.0500 | 1.3840 | 71.2000 | −787.066 |

TABLE 6
Second Example Lens Data 2

| | |
|---|---|
| Fno | 1.645 |
| Focal length of entire system of imaging lens | 6.244 |
| Focal length of first lens group | 6.059 |
| Focal length of second lens group | −13.224 |
| Half angle of view | 39.825 |
| Angle of view | 79.650 |
| Entire optical length | 8.000 |
| Image height | 5.560 |

TABLE 7
Second Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.32680E+00 | — | −1.73574E−02 | — | −1.62784E−03 | — | 2.12161E−04 |
| R2 | 6.62899E+00 | — | −1.37315E−02 | — | 1.94390E−03 | — | −1.50747E−04 |
| R3 | 3.46755E+00 | — | 2.05704E−02 | — | 5.88637E−04 | — | 1.47526E−04 |
| R4 | 1.84353E+02 | — | 9.85236E−03 | — | −5.75452E−03 | — | 1.34735E−03 |
| R5 | 1.28517E+01 | — | −1.87373E−04 | — | −5.30901E−04 | — | 1.09157E−03 |
| R6 | 5.11471E+00 | — | −2.58223E−03 | — | 5.82137E−03 | — | −5.15514E−04 |
| R7 | −4.63314E+01 | — | −7.69659E−03 | — | −2.25182E−03 | — | −2.45618E−04 |
| R8 | −1.03730E+01 | — | −3.96084E−03 | — | −1.00607E−02 | — | 4.87118E−03 |
| R9 | −9.33322E+00 | −4.09757E−03 | 4.63974E−03 | −2.33720E−02 | 4.77405E−03 | 7.50402E−04 | −6.52055E−06 |
| R10 | −9.80322E+00 | −8.40808E−03 | 3.11323E−03 | −1.50951E−02 | 9.70501E−04 | 1.97771E−03 | 1.09355E−04 |
| R11 | 1.00000E+01 | −1.67301E−02 | 1.82017E−02 | −1.01994E−02 | 5.32249E−04 | 1.67613E−04 | 6.51317E−05 |
| R12 | −3.28274E+00 | −2.24143E−02 | 1.89399E−02 | −2.68516E−03 | −1.24495E−03 | 2.87092E−04 | 1.04433E−04 |
| R13 | 7.69882E−02 | −2.49552E−02 | −4.78798E−02 | 1.15090E−02 | 1.21170E−03 | −1.05158E−04 | −1.06019E−04 |
| R14 | −5.40490E+00 | −9.97740E−03 | −2.98645E−02 | 1.14911E−02 | 3.80925E−05 | −6326105E−04 | 7.74189E−05 |
| R15 | 0.00000E+00 | — | 1.35749E−03 | — | 1.35393E−04 | — | −6.03392E−07 |
| R16 | 0.00000E+00 | — | −3.99507E−03 | — | 6.69345E−05 | — | 1.37045E−05 |

| | A9 | A10 | A11 | A12 | A13 | A14 | A15 |
|---|---|---|---|---|---|---|---|
| R1 | — | 5.17954E−05 | — | −1.09625E−05 | — | — | — |
| R2 | — | 4.46859E−05 | — | −2.72336E−06 | — | — | — |
| R3 | — | −1.22646E−04 | — | 6.43315E−06 | — | — | — |
| R4 | — | −1.74914E−04 | — | 1.11006E−05 | — | — | — |
| R5 | — | −4.73632E−05 | — | −1.03643E−05 | — | 1.59087E−06 | — |
| R6 | — | 4.83762E−04 | — | −4.59974E−05 | — | 6.59076E−06 | — |
| R7 | — | 7.22512E−04 | — | −1.68788E−04 | — | 1.45232E−05 | — |
| R8 | — | −1.00575E−03 | — | 1.27102E−04 | — | −8.67258E−06 | — |
| R9 | 2.77509E−04 | 9.08966E−05 | −5.18338E−06 | −3.19121E−05 | −7.89121E−06 | 1.15572E−06 | 1.61729E−07 |
| R10 | −4.49645E−05 | −4.30752E−05 | −1.93962E−06 | −8.83491E−07 | −1.08773E−07 | 4.66062E−07 | 7.20006E−08 |
| R11 | −3.12323E−05 | −1.56424E−06 | 2.87784E−06 | −1.90698E−06 | 4.50762E−07 | −1.78202E−07 | 6.38866E−08 |
| R12 | −1.23108E−05 | −6.42550E−06 | −6.68897E−07 | −3.34837E−08 | 1.15345E−07 | 1.50971E−08 | −3.94124E−09 |
| R13 | 2.27301E−06 | 3.15868E−06 | 4.85912E−08 | −6.62469E−08 | 1.20095E−09 | 8.90370E−10 | −9.88468E−11 |
| R14 | 7.03274E−08 | 4.66237E−07 | 8.20032E−08 | −6.90507E−08 | −4.69338E−10 | 2.08854E−09 | −7.62116E−11 |
| R15 | — | −3.31423E−07 | — | 8.09527E−09 | — | — | — |
| R16 | — | −7.63887E−07 | — | 1.13569E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 5.08143E−08 | −6.50613E−08 | −6.78843E−08 | −1.72375E−08 | 3.97071E−08 |
| R10 | −2.11081E−08 | −2.38911E−08 | −7.48852E−09 | 2.56451E−09 | 2.39891E−09 |
| R11 | 1.39696E−08 | −1.66569E−09 | −1.93077E−09 | −9.71582E−11 | 1.39273E−10 |
| R12 | −3.90514E−11 | 3.94405E−11 | 3.23655E−12 | −3.06941E−13 | −2.12053E−12 |
| R13 | −1.09114E−11 | −3.51790E−12 | −7.33326E−13 | −4.78228E−14 | 3.87509E−14 |
| R14 | −3.09369E−11 | −2.51692E−12 | −1.60823E−13 | 5.35231E−14 | 5.00703E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 8 below.

TABLE 8

| | | |
|---|---|---|
| (101) | 5.0<f/(\|fa1/fa2\|)<500 | 13.627 |
| (201) | 10<\|fa2/(f9/f8)\|<5000 | 860.620 |
| (301) | \|(f8*Nd8)/(f9*Nd9) \|<30 | 0.035 |
| (401) | \|((R15 − R16)/(R15 + R16))\|<3.5 | 1.085 |
| (501) | TL/IH<1.6 | 1.439 |
| (601) | \|(f1 + f2)/f3\|<8.0 | 5.468 |
| (701) | (Vd2/Vd3)/(Vd4/Vd5)<3.5 | 1.151 |
| (801) | \|(f4 + f5 + f6)/f7\|<14 | 0.401 |

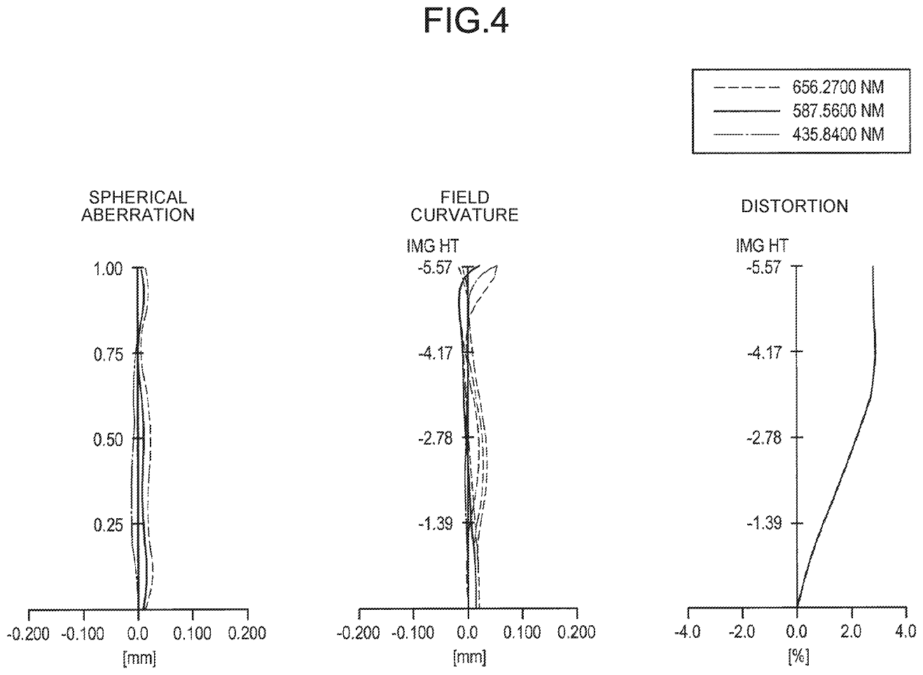

FIG. 4 is a longitudinal aberration diagram in a visible light wavelength band acquired by the imaging lens 100 according to the second example.

### 2.3. Third Example

Subsequently, the third example of the imaging lens 100 according to the present embodiment will be specifically explained.

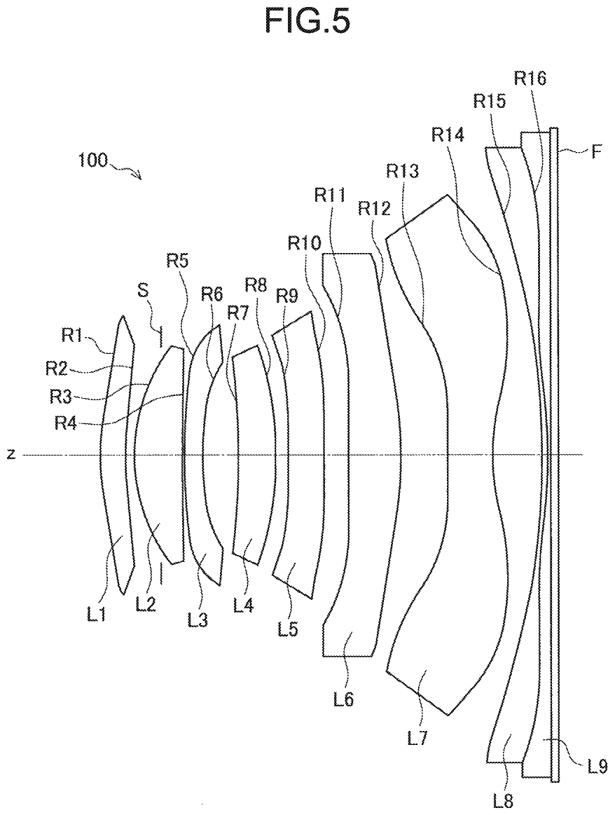

FIG. 5 is a diagram illustrating a structure of an imaging lens 100 according to the third example. The imaging lens 100 according to the third example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 9 to Table 11 show specific lens data of the imaging lens 100 according to the third example. More specifically, Table 9 shows basic lens data of the respective lenses provided in the imaging lens 100 according to the third example. Table 10 shows basic lens data about the entire system (or the first lens group La1 and the second lens group La2) of the imaging lens 100 according to the third example. Table 11 shows aspheric surface data of the respective lenses provided in the imaging lens 100 according to the third example. What is described in the respective tables are similar to those of the above examples and, therefore, explanation thereof is omitted.

TABLE 9
Third Example Lens Data 1

| Surface | Curvature | | Refractive | Abbe | Focal |
|---|---|---|---|---|---|
| number | radius | Interval | index | number | length |
| R1 | 4.3268 | 0.4317 | 1.5400 | 54.0000 | 21.487 |
| R2 | 6.6290 | 0.1477 | — | — | — |
| R3 | 3.4675 | 0.8376 | 1.5400 | 54.0000 | 6.487 |
| R4 | 184.3530 | 0.0300 | — | — | — |
| R5 | 12.8517 | 0.3200 | 1.6600 | 20.5000 | −13.064 |
| R6 | 5.1147 | 0.3870 | — | — | — |
| R7 | −46.3314 | 0.6353 | 1.5400 | 54.0000 | 24.421 |
| R8 | −10.3730 | 0.2286 | — | — | — |
| R9 | 133.5994 | 0.5972 | 1.6320 | 23.6000 | −32.647 |
| R10 | 17.9273 | 0.4374 | — | — | — |
| R11 | 34.3453 | 0.8943 | 1.5360 | 54.0000 | 11.516 |
| R12 | −7.5902 | 0.8372 | — | — | — |
| R13 | 12.4097 | 0.7750 | 1.5360 | 53.0000 | −6.928 |
| R14 | 2.7936 | 0.8459 | — | — | — |
| R15 | −14.9795 | 0.1000 | 1.6600 | 19.5000 | −191.312 |
| R16 | −7.4989 | 0.0500 | 1.3840 | 71.2000 | 41.225 |

TABLE 10
Third Example Lens Data 2

| | |
|---|---|
| Fno | 1.645 |
| Focal length of entire system of imaging lens | 6.287 |
| Focal length of first lens group | 6.215 |
| Focal length of second lens group | −209.192 |
| Half angle of view | 39.307 |
| Angle of view | 78.614 |
| Entire optical length | 7.919 |
| Image height | 5.560 |

TABLE 11
Third Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.32680E+00 | — | −1.73574E−02 | — | −1.62784E−03 | — | 2.12161E−04 |
| R2 | 6.62899E+00 | — | −1.37315E−02 | — | 1.94390E−03 | — | −1.50747E−04 |
| R3 | 3.46755E+00 | — | 2.05704E−02 | — | 5.88637E−04 | — | 1.47526E−04 |
| R4 | 1.84353E+02 | — | 9.85236E−03 | — | −5.75452E−03 | — | 1.34735E−03 |
| R5 | 1.28517E+01 | — | −1.87373E−04 | — | −5.30901E−04 | — | 1.09157E−03 |
| R6 | 5.11471E+00 | — | −2.58223E−03 | — | 5.82137E−03 | — | −5.15514E−04 |
| R7 | −4.63314E+01 | — | −7.69659E−03 | — | −2.25182E−03 | — | −2.45618E−04 |
| R8 | −1.03730E+01 | — | −3.96084E−03 | — | −1.00607E−02 | — | 4.87118E−03 |
| R9 | −9.33322E+00 | −8.17563E−03 | 3.66671E−03 | −2.19832E−02 | 5.12330E−03 | 7.06551E−04 | −7.19279E−05 |
| R10 | −9.80322E+00 | −1.36421E−02 | 6.45799E−03 | −1.57499E−02 | 5.81494E−04 | 1.91087E−03 | 1.23528E−04 |
| R11 | 1.00000E+01 | −1.31936E−02 | 1.58233E−02 | −1.05093E−02 | 9.18931E−05 | 9.65254E−05 | 9.25867E−05 |
| R12 | −3.28274E+00 | −1.74811E−02 | 1.85253E−02 | −3.29391E−03 | −1.27822E−03 | 3.01867E−04 | 1.10661E−04 |
| R13 | 7.69882E−02 | −2.28251E−02 | −4.57754E−02 | 1.19075E−02 | 1.25908E−03 | −1.01899E−04 | −1.06604E−04 |
| R14 | −5.40490E+00 | −1.34391E−02 | −2.76301E−02 | 1.12419E−02 | −7.76876E−05 | −6.41535E−04 | 7.76911E−05 |
| R15 | 0.00000E+00 | — | −5.48842E−04 | — | −7.58224E−05 | — | 1.22991E−05 |
| R16 | 0.00000E+00 | — | 1.10417E−02 | — | −8.42173E−04 | — | 3.57059E−05 |

| | A9 | A10 | A11 | A12 | A13 | A14 | A15 |
|---|---|---|---|---|---|---|---|
| R1 | — | 5.17954E−05 | — | −1.09625E−05 | — | — | — |
| R2 | — | 4.46859E−05 | — | −2.72336E−06 | — | — | — |
| R3 | — | −1.22646E−04 | — | 6.43315E−06 | — | — | — |
| R4 | — | −1.74914E−04 | — | 1.11006E−05 | — | — | — |
| R5 | — | −4.73632E−05 | — | −1.03643E−05 | — | 1.59087E−06 | — |
| R6 | — | 4.83762E−04 | — | −4.59974E−05 | — | 6.59076E−06 | — |
| R7 | — | 7.22512E−04 | — | −1.68788E−04 | — | 1.45232E−05 | — |
| R8 | — | −1.00575E−03 | — | 1.27102E−04 | — | −8.67258E−06 | — |
| R9 | 2.48178E−04 | 8.26594E−05 | −5.71124E−06 | −3.14371E−05 | −7.47694E−06 | 1.33537E−06 | 2.02648E−07 |
| R10 | −2.83025E−05 | −3.46614E−05 | 1.25558E−06 | 1.64397E−07 | 1.85214E−07 | 5.30700E−07 | 7.80719E−08 |
| R11 | −1.02461E−05 | 6.25140E−06 | 4.99578E−06 | −1.47618E−06 | 4.99312E−07 | −1.89998E−07 | 5.34409E−08 |
| R12 | −1.05506E−05 | −6.03012E−06 | −6.00545E−07 | −2.77712E−08 | 1.13157E−07 | 1.36342E−08 | −4.51103E−09 |
| R13 | 1.96543E−06 | 3.07026E−06 | 2.66147E−08 | −7.07248E−08 | 3.24561E−10 | 7.35699E−10 | −1.20425E−10 |
| R14 | 7.23027E−07 | 6.32923E−07 | 1.10280E−07 | −6.65072E−08 | −5.72173E−10 | 1.96396E−09 | −1.14574E−10 |
| R15 | — | −5.49794E−07 | — | 8.30002E−09 | — | — | — |
| R16 | — | −8.33054E−07 | — | 8.17083E−09 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 4.74364E−08 | −7.53472E−08 | −7.89681E−08 | −2.36155E−08 | 3.69251E−08 |
| R10 | −2.75342E−08 | −3.00909E−08 | −1.14662E−08 | 4.29336E−10 | 1.37786E−09 |
| R11 | 9.33095E−09 | −3.30994E−09 | −2.43379E−09 | −2.30736E−10 | 1.11006E−10 |
| R12 | −2.12826E−10 | −4.09503E−12 | −4.76762E−12 | −6.42258E−13 | −1.45339E−12 |
| R13 | −1.30432E−11 | −3.33925E−12 | −7.12813E−13 | −2.43721E−14 | 5.33045E−14 |
| R14 | −3.95380E−11 | −3.79410E−12 | −2.54327E−13 | 8.88764E−14 | 7.10804E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 12 below.

TABLE 12

| | | |
|---|---|---|
| (101) | 5.0<f/(\|fa1/fa2\|)<500 | 211.631 |
| (201) | 10<\|fa2/(f9/f8)\|<5000 | 45.078 |
| (301) | \|(f8*Nd8)/(f9*Nd9)\|<30 | 10.662 |
| (401) | \|((R15 − R16)/(R15 + R16))\|<3.5 | 0.333 |
| (501) | TL/IH<1.6 | 1.424 |
| (601) | \|(f1 + f2)/f3\|<8.0 | 2.141 |
| (701) | (Vd2/Vd3)/(Vd4/Vd5)<3.5 | 1.151 |
| (801) | \|(f4 + f5 + f6)/f7\|<14 | 0.475 |

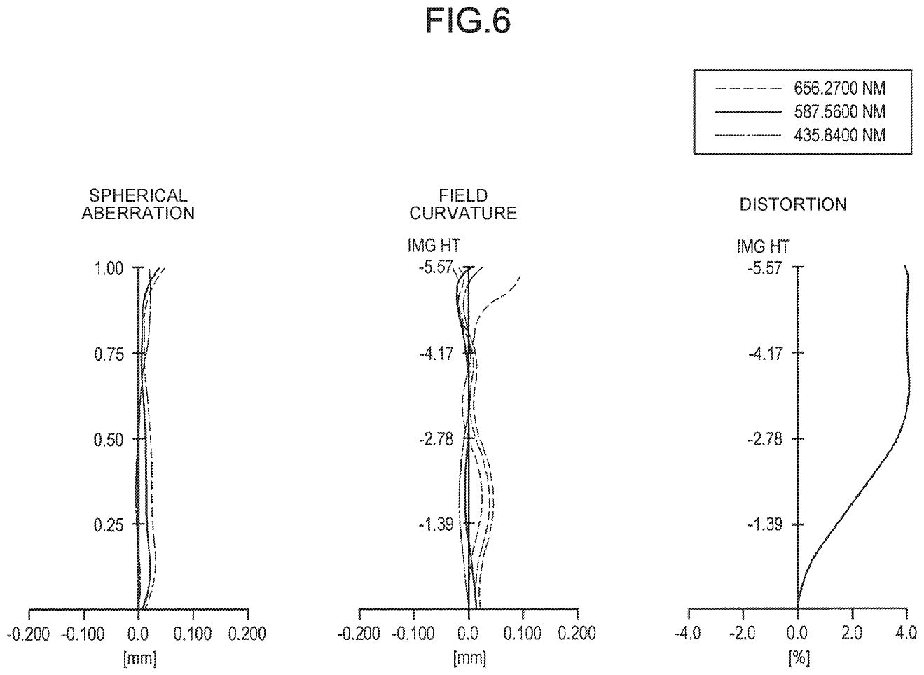

FIG. 6 is a longitudinal aberration diagram in a visible light wavelength band acquired by the imaging lens 100 according to the third example.

### 2.4. Fourth Example

Subsequently, the fourth example of the imaging lens 100 according to the present embodiment will be specifically explained.

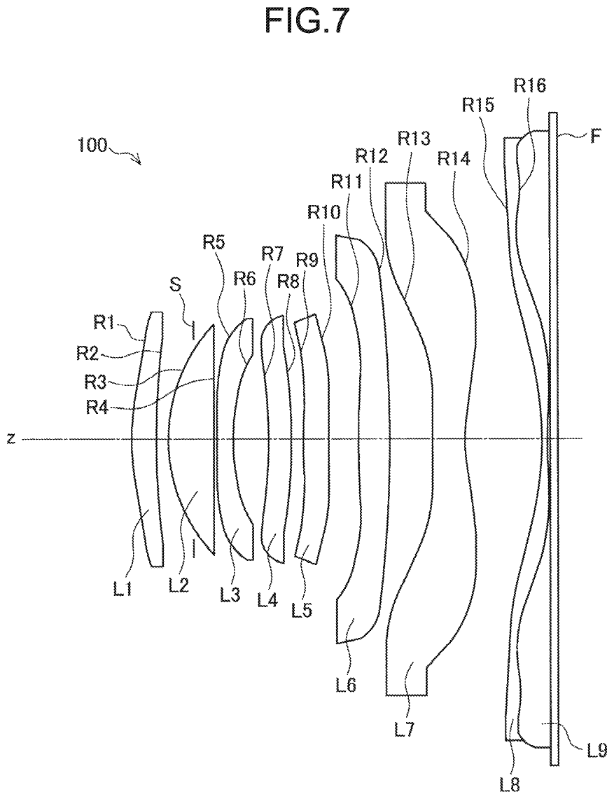

FIG. 7 is a diagram illustrating a structure of an imaging lens 100 according to the fourth example. The imaging lens 100 according to the fourth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 13 to Table 15 show specific lens data of the imaging lens 100 according to the fourth example. More specifically, Table 13 shows basic lens data of the respective lenses provided in the imaging lens 100 according to the fourth example. Table 14 shows basic lens data about the entire system (or the first lens group La1 and the second lens group La2) of the imaging lens 100 according to the fourth example. Table 15 shows aspheric surface data of the respective lenses provided in the imaging lens 100 according to the fourth example. What is described in the respective tables are similar to those of the above examples and, therefore, explanation thereof is omitted.

TABLE 13
Fourth Example Lens Data 1

| | | | Refrac- | | |
|---|---|---|---|---|---|
| Surface | Curvature | | tive | Abbe | Focal |
| number | radius | Interval | index | number | length |
| R1 | 4.3552 | 0.4590 | 1.5400 | 54.0000 | 15.322 |
| R2 | 8.7843 | 0.2128 | — | — | — |
| R3 | 3.7229 | 0.8466 | 1.5400 | 54.0000 | 6.824 |
| R4 | −1097.8262 | 0.0491 | — | — | — |
| R5 | 14.2886 | 0.3200 | 1.6600 | 20.5000 | −10.370 |
| R6 | 4.5920 | 0.3919 | — | — | — |
| R7 | −23.7845 | 0.4506 | 1.5400 | 54.0000 | 75.685 |
| R8 | −15.1753 | 0.2180 | — | — | — |
| R9 | 15.1527 | 0.4500 | 1.6320 | 23.6000 | −186.490 |
| R10 | 13.2799 | 0.5631 | — | — | — |
| R11 | 11.7834 | 0.5748 | 1.5360 | 54.0000 | 12.196 |
| R12 | −14.9158 | 0.7917 | — | — | — |
| R13 | 11.9165 | 0.6119 | 1.5360 | 53.0000 | −8.990 |
| R14 | 3.3670 | 1.3439 | — | — | — |
| R15 | −5.5006 | 0.1000 | 1.6600 | 19.5000 | −9.596 |
| R16 | 11.4123 | 0.0500 | 1.3840 | 71.2000 | −62.739 |

TABLE 14
Fourth Example Lens Data 2

| | |
|---|---|
| Fno | 1.820 |
| Focal length of entire system of imaging lens | 6.779 |
| Focal length of first lens group | 6.534 |
| Focal length of second lens group | −10.493 |
| Half angle of view | 38.073 |
| Angle of view | 76.147 |
| Entire optical length | 7.800 |
| Image height | 5.560 |

TABLE 15
Fourth Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.35523E+00 | — | −1.72293E−02 | — | −1.54981E−03 | — | 2.13501E−04 |
| R2 | 8.78431E+00 | — | −1.23859E−02 | — | 1.89038E−03 | — | −1.43282E−04 |
| R3 | 3.72294E+00 | — | 2.09055E−02 | — | 8.34628E-−04 | — | 1.45000E−04 |
| R4 | −1.09783E+03 | — | 9.47291E−03 | — | −5.51977E−03 | — | 1.27233E−03 |
| R5 | 1.42886E+01 | — | −1.76090E−04 | — | −4.87767E−04 | — | 1.00314E−03 |
| R6 | 4.59197E+00 | — | −3.05753E−03 | — | 5.84752E−03 | — | −4.51146E−04 |
| R7 | −2.37845E+01 | — | −7.81170E−03 | — | −2.25704E−03 | — | −9.47740E−05 |
| R8 | −1.51753E+01 | — | −2.37877E−03 | — | −9.20613E−03 | — | 4.63627E−03 |
| R9 | −9.33322E+00 | −8.17591E−03 | 3.86488E−03 | −2.08357E−02 | 4.80459E−03 | 5.57820E−04 | −1.21597E−04 |
| R10 | −9.80322E+00 | −1.56345E−02 | 4.12765E−03 | −1.58101E−02 | 5.05164E−04 | 1.83056E−03 | 1.31837E−04 |
| R11 | 1.00000E+01 | −1.64220E−02 | 1.47253E−02 | −1.00101E−02 | −1.37565E−05 | 2.63688E−05 | 6.92131E−05 |
| R12 | −3.28274E+00 | −1.60331E−02 | 1.80799E−02 | −3.27308E−03 | −1.25555E−03 | 2.74390E−04 | 1.01161E−04 |
| R13 | 7.69882E−02 | −1.37972E−02 | −4.48114E−02 | 1.12893E−02 | 1.17496E−03 | −9.79153E−05 | −9.93529E−05 |
| R14 | −5.40490E+00 | −1.98203E−02 | −2.44022E−02 | 1.10704E−02 | −9.59677E−05 | −6.18658E−04 | 6.92212E−05 |
| R15 | 0.00000E+00 | — | 4.25780E−03 | — | −4.59931E−05 | — | 1.14564E−05 |
| R16 | 0.00000E+00 | — | −2.04776E−02 | — | 1.30298E−03 | — | −5.15971E−06 |

| | A9 | A10 | A11 | A12 | A13 | A14 | A15 |
|---|---|---|---|---|---|---|---|
| R1 | — | 5.04674E−05 | — | −1.00824E−05 | — | — | — |
| R2 | — | 4.00050E−05 | — | −1.56135E−06 | — | — | — |
| R3 | — | −1.15803E−04 | — | 5.66538E−06 | — | — | — |
| R4 | — | −1.54742E−04 | — | 9.17435E−06 | — | — | — |
| R5 | — | −4.65780E−05 | — | −8.80892E−06 | — | 1.76581E−06 | — |
| R6 | — | 4.27438E−04 | — | −4.15300E−05 | — | 1.46904E−05 | — |
| R7 | — | 7.20893E−04 | — | −1.42208E−04 | — | 9.77506E−06 | — |
| R8 | — | −8.99149E−04 | — | 1.13925E−04 | — | −5.86288E−06 | — |
| R9 | 2.12253E−04 | 7.33239E−05 | −3.94161E−06 | −2.69892E−05 | −6.02807E−06 | 1.39598E−06 | 2.35181E−07 |
| R10 | −2.05548E−05 | −3.01503E−05 | 1.52526E−06 | 2.39772E−07 | 1.85816E−07 | 4.70699E−07 | 6.82080E−08 |
| R11 | −1.27486E−05 | 5.58243E−06 | 4.69586E−06 | −1.23331E−06 | 4.72695E−07 | −1.58823E−07 | 4.82644E−08 |
| R12 | −1.00581E−05 | −5.53137E−06 | −5.27784E−07 | −1.56223E−08 | 1.03832E−07 | 1.29516E−08 | −3.69948E−09 |
| R13 | 1.88071E−06 | 2.82224E−06 | 2.72299E−08 | −6.29842E−08 | 3.39744E−10 | 6.50186E−10 | −1.05410E−10 |
| R14 | 9.87527E−08 | 5.00468E−07 | 9.15724E−08 | −5.97785E−08 | −2.92037E−10 | 1.81399E−09 | −7.37713E−11 |
| R15 | — | −7.67264E−07 | — | 1.48123E−08 | — | — | — |
| R16 | — | −1.46406E−06 | — | 2.89437E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 4.90867E−08 | −6.35666E−08 | −6.28930E−08 | −1.32901E−08 | 3.75510E−08 |
| R10 | −2.42518E−08 | −2.62630E−08 | −1.01245E−08 | 8.69894E−11 | 9.94565E−10 |
| R11 | 8.32238E−09 | −2.83531E−09 | −2.06902E−09 | −1.96440E−10 | 9.27123E−11 |
| R12 | −1.45029E−10 | −1.41472E−12 | −6.37556E−12 | −2.03537E−12 | −1.85843E−12 |
| R13 | −1.13208E−11 | −2.83734E−12 | −5.61867E−13 | −2.99852E−14 | 3.07765E−14 |
| R14 | −2.71468E−11 | −1.60718E−12 | 1.67942E−13 | 1.60545E−13 | 7.84755E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 16 below.

TABLE 16

| | | |
|---|---|---|
| (101) | 5.0<f/(\|fa1/fa2\|)<500 | 10.887 |
| (201) | 10<\|fa2/(f9/f8)\|<5000 | 68.602 |
| (301) | \|(f8*Nd8)/(f9*Nd9)\|<30 | 0.351 |
| (401) | \|((R15 − R16)/(R15 + R16))\|<3.5 | 2.861 |
| (501) | TL/IH<1.6 | 1.403 |
| (601) | \|(f1 + f2)/f3\|<8.0 | 2.136 |
| (701) | (Vd2/Vd3)/ (Vd4/vd5)<3.5 | 1.151 |
| (801) | \|(f4 + f5 + f6)/f7\|<14 | 10.969 |

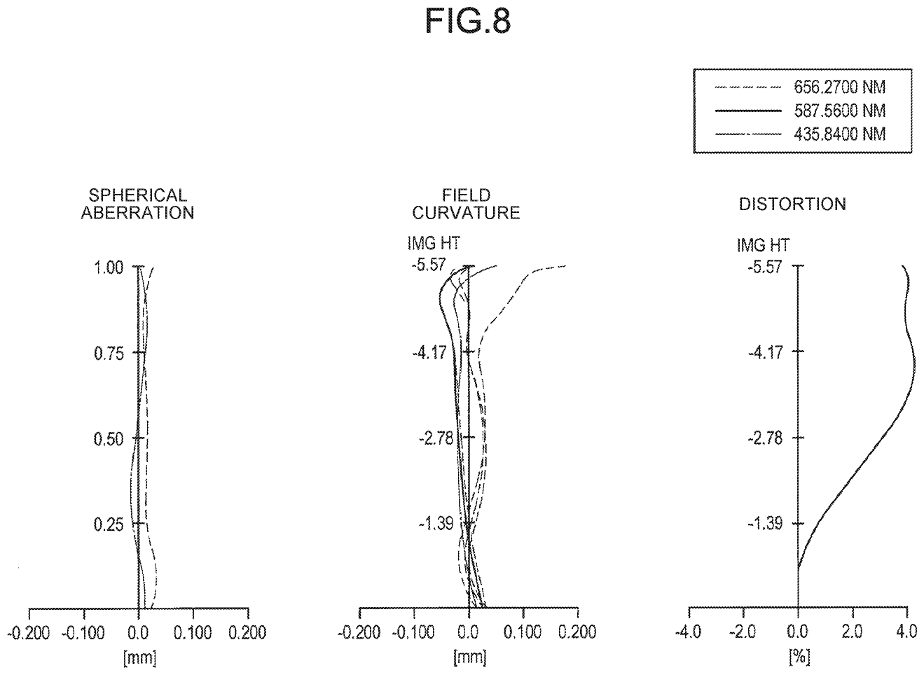

FIG. 8 is a longitudinal aberration diagram in a visible light wavelength band acquired by the imaging lens 100 according to the fourth example.

### 2.5. Fifth Example

Subsequently, the fifth example of the imaging lens 100 according to the present embodiment will be specifically explained.

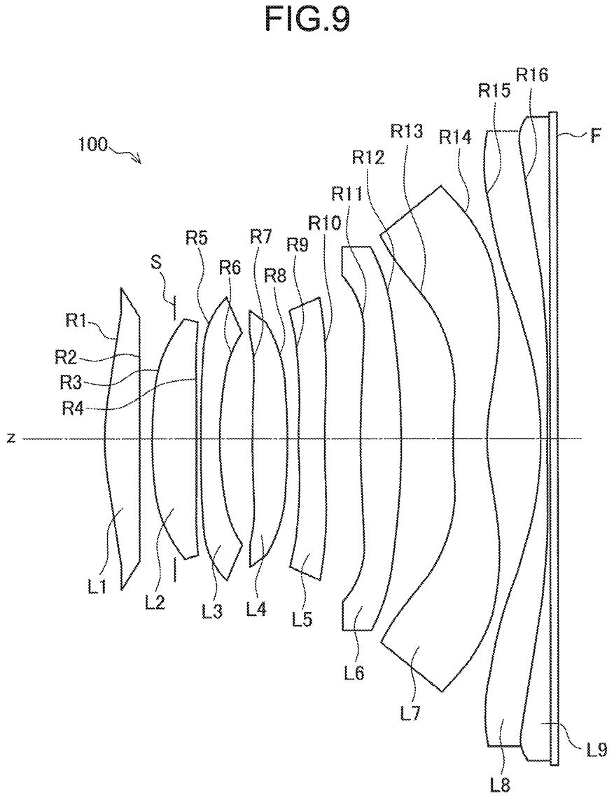

FIG. 9 is a diagram illustrating a structure of the imaging lens 100 according to a fifth example. The imaging lens 100 according to the fifth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 17 to Table 19 show specific lens data of the imaging lens 100 according to the fifth example. More specifically, Table 17 shows basic lens data of the respective lenses provided in the imaging lens 100 according to the fifth example. Table 18 shows basic lens data about the entire system (or the first lens group La1 and the second lens group La2) of the imaging lens 100 according to the fifth example. Table 19 shows aspheric surface data of the respective lenses provided in the imaging lens 100 according to the fifth example. What is described in the respective tables are similar to those of the above examples and, therefore, explanation thereof is omitted.

TABLE 17
Fifth Example Lens Data 1

| Surface | Curvature | | Refractive | Abbe | Focal |
|---|---|---|---|---|---|
| number | radius | Interval | index | number | length |
| R1 | 4.6907 | 0.6000 | 1.5400 | 54.0000 | 8.548 |
| R2 | −501.4566 | 0.2281 | — | — | — |
| R3 | 8.7163 | 0.7628 | 1.5400 | 54.0000 | 15.596 |
| R4 | −306.4109 | 0.0800 | — | — | — |
| R5 | 29.6450 | 0.3297 | 1.6600 | 20.5000 | −11.898 |
| R6 | 6.1896 | 0.3787 | — | — | — |
| R7 | 16.7431 | 0.5918 | 1.5400 | 54.0000 | 16.988 |
| R8 | −20.3617 | 0.2025 | — | — | — |
| R9 | 19.9479 | 0.4500 | 1.6320 | 23.6000 | −48.649 |
| R10 | 12.0185 | 0.6237 | — | — | — |
| R11 | 11.9524 | 0.6999 | 1.5360 | 54.0000 | 13.025 |
| R12 | −17.0336 | 0.9133 | — | — | — |
| R13 | 6.6074 | 0.6000 | 1.5360 | 53.0000 | −12.324 |
| R14 | 3.1969 | 0.9433 | — | — | — |
| R15 | −5.5269 | 0.1000 | 1.6600 | 19.5000 | −11.092 |
| R16 | 51.2167 | 0.0500 | 1.3840 | 71.2000 | −281.562 |

TABLE 18
Fifth Example Lens Data 2

| | |
|---|---|
| Fno | 1.460 |
| Focal length of entire system of imaging lens | 6.163 |
| Focal length of first lens group | 5.960 |
| Focal length of second lens group | −12.128 |
| Half angle of view | 39.910 |
| Angle of view | 79.819 |
| Entire optical length | 7.880 |
| Image height | 5.560 |

TABLE 19
Fifth Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.69068E+00 | — | −1.31158E−02 | — | −1.51382E−03 | — | 1.90739E−04 |
| R2 | −5.01457E+02 | — | −2.75371E−03 | — | 7.68083E−04 | — | −8.17784E−05 |
| R3 | 8.71631E+00 | — | 1.66783E−02 | — | 1.44332E−03 | — | −1.00579E−04 |
| R4 | −3.06411E+02 | — | 8.70212E−03 | — | −3.85804E−03 | — | 7.48550E−04 |
| R5 | 2.96450E+01 | — | −1.92217E−03 | — | 4.42159E−04 | — | 5.25436E−04 |
| R6 | 6.18965E+00 | — | −4.38817E−03 | — | 4.05621E−03 | — | −1.25689E−04 |
| R7 | 1.67431E+01 | — | −7.86588E−03 | — | −2.37593E−03 | — | −2.51220E−04 |
| R8 | −2.03617E+01 | — | −2.96404E−03 | — | −7.88103E−03 | — | 1.99869E−03 |
| R9 | −9.33322E+00 | −4.11229E−03 | 2.49944E−03 | −1.43778E−02 | 2.97055E−03 | 3.75532E−04 | −3.00654E−05 |
| R10 | −9.80322E+00 | −1.02353E−02 | 2.73227E−03 | −9.81554E−03 | 7.22865E−04 | 1.09638E−03 | 5.76622E−05 |
| R11 | 1.00000E+01 | −0.10476E−02 | 1.02672E−02 | −6.86907E−03 | 2.16106E−04 | 6.48040E−05 | 2.82538E−05 |
| R12 | −3.28274E+00 | −1.68506E−02 | 1.37261E−02 | −2.07739E−03 | −8.65219E−04 | 1.25905E−04 | 4.61661E−05 |
| R13 | 7.69882E−02 | −2.51724E−02 | −3.79308E−02 | 7.36813E−03 | 7.56173E−04 | −3.69958E−05 | −4.55231E−05 |
| R14 | −5.40490E+00 | −2.02958E−02 | −1.95869E−02 | 7.50770E−03 | −4.02090E−06 | −3.30662E−04 | 3.62257E−05 |
| R15 | 0.00000E+00 | — | 1.47295E−03 | — | 1.67855E−04 | — | −1.18398E−06 |
| R16 | 0.00000E+00 | — | −4.18984E−03 | — | 1.25974E−04 | — | 9.74650E−06 |

| | A9 | A10 | A11 | A12 | A13 | A14 | A15 |
|---|---|---|---|---|---|---|---|
| R1 | — | 3.06655E−05 | — | −6.33206E−06 | — | — | — |
| R2 | — | 2.22468E−05 | — | −2.49484E−06 | — | — | — |
| R3 | — | −7.10381E−05 | — | 9.41944E−06 | — | — | — |
| R4 | — | −3.91048E−05 | — | −7.14220E−08 | — | — | — |
| R5 | — | −3.16738E−05 | — | −3.38902E−06 | — | 1.83741E−07 | — |
| R6 | — | 1.44184E−04 | — | −3.47459E−05 | — | 5.60978E−06 | — |
| R7 | — | 2.28536E−04 | — | −5.79319E−05 | — | 6.86251E−06 | — |
| R8 | — | −3.31040E−04 | — | 3.91390E−05 | — | −3.07547E−06 | — |
| R9 | 1.06937E−04 | 3.14199E−05 | −2.62700E−06 | −9.82341E−06 | −2.17915E−06 | 2.78614E−07 | 1.42900E−08 |
| R10 | −2.31199E−05 | −1.95761E−05 | −1.98231E−06 | −6.75072E−07 | −1.13034E−07 | 1.14978E−07 | 2.62937E−08 |
| R11 | −1.45519E−05 | −1.53143E−06 | 5.33348E−07 | −7.56196E−07 | 7.46254E−08 | −5.57416E−08 | 1.25102E−08 |
| R12 | −5.23890E−06 | −2.28679E−06 | −1.60279E−07 | 9.60161E−09 | 3.66177E−08 | 4.70969E−09 | −7.52981E−10 |
| R13 | 1.94618E−06 | 1.39603E−06 | 5.07154E−08 | −1.51442E−08 | 9.59632E−10 | 2.18467E−10 | −3.88837E−11 |
| R14 | −1.05481E−07 | 1.27718E−07 | 1.66207E−08 | −2.36554E−08 | −5.91115E−10 | 4.50981E−10 | −2.96762E−11 |
| R15 | — | −3.14337E−07 | — | 8.89907E−09 | — | — | — |
| R16 | — | −6.79683E−07 | — | 1.13858E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 8.93589E−10 | −1.41015E−08 | −1.02224E−08 | −8.99020E−10 | 6.73786E−09 |
| R10 | 2.85691E−09 | −9.62184E−10 | 7.66168E−12 | 6.81153E−10 | 3.22157E−10 |
| R11 | 2.65994E−09 | −3.79173E−11 | −1.28268E−10 | 7.83827E−11 | 5.82659E−11 |
| R12 | −1.26971E−11 | −4.96205E−12 | −5.00887E−12 | −2.43218E−12 | −1.18720E−12 |
| R13 | −1.38176E−11 | −5.03778E−12 | −1.52426E−12 | −4.16422E−13 | −1.04248E−13 |
| R14 | −6.01685E−12 | 2.36015E−13 | 2.71754E−13 | 1.07530E−13 | 3.54408E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 20 below.

TABLE 20

| | | |
|---|---|---|
| (101) | 5.0<f/(\|fa1/fa2\|)<500 | 12.541 |
| (201) | 10<\|fa2/(f9/f8)\|<5000 | 307.876 |
| (301) | \|(f8*Nd8)/(f9*Nd9)\|<30 | 0.091 |
| (401) | \|((R15 − R16)/(R15 + R16))\|<3.5 | 1.242 |
| (501) | TL/IH<1.6 | 1.417 |
| (601) | \|(f1 + f2)/f3\|<8.0 | 2.029 |
| (701) | (Vd2/Vd3)/(Vd4/Vd5)<3.5 | 1.151 |
| (801) | \|(f4 + f5 + f6)/f7\|<14 | 1.512 |

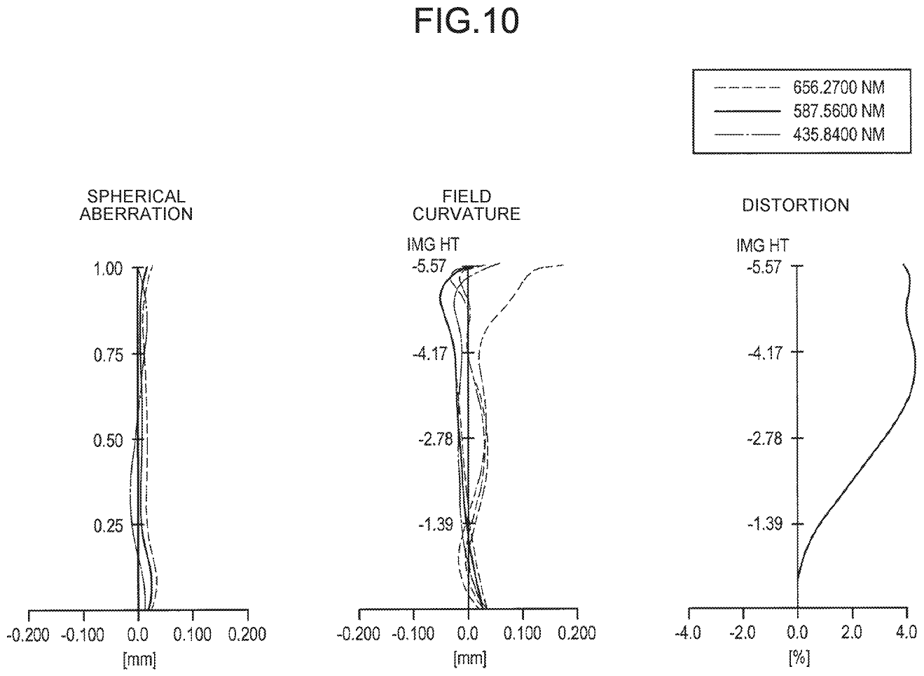

FIG. 10 is a longitudinal aberration diagram in a visible light wavelength band acquired by the imaging lens 100 according to the fifth example.

### 2.6. Sixth Example

Subsequently, the sixth example of the imaging lens 100 according to the present embodiment will be specifically explained.

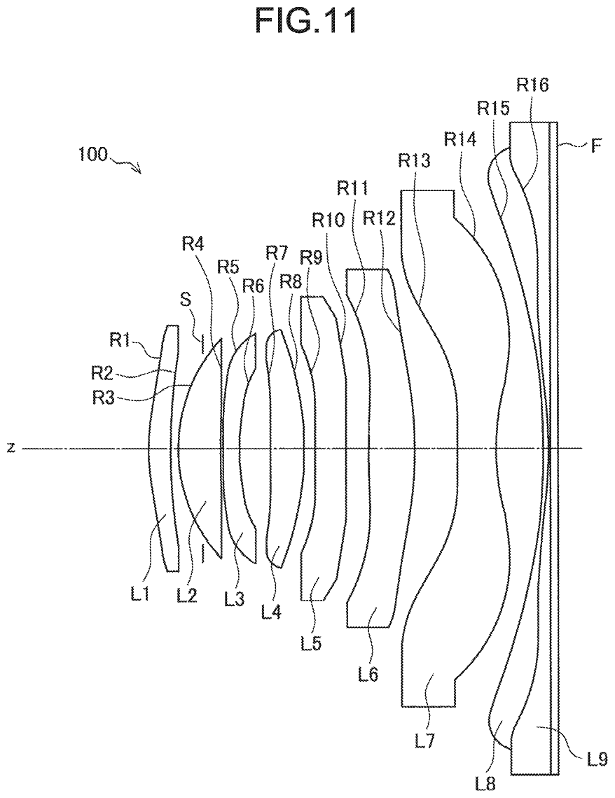

FIG. 11 is a diagram illustrating a structure of the imaging lens 100 according to the sixth example. The imaging lens 100 according to the sixth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 21 to Table 23 show specific lens data of the imaging lens 100 according to the sixth example. More specifically, Table 21 shows basic lens data of the respective lenses provided in the imaging lens 100 according to the sixth example. Table 22 shows basic lens data about the entire system (or the first lens group La1 and the second lens group La2) of the imaging lens 100 according to the sixth example. Table 23 shows aspheric surface data of the respective lenses provided in the imaging lens 100 according to the sixth example. What is described in the respective tables are similar to those of the above examples and, therefore, explanation thereof is omitted.

TABLE 21
Sixth Example Lens Data 1

| Surface | Curvature | | Refractive | Abbe | Focal |
|---|---|---|---|---|---|
| number | radius | Interval | index | number | length |
| R1 | 4.3266 | 0.4342 | 1.5400 | 54.0000 | 21.416 |
| R2 | 6.6402 | 0.1476 | — | — | — |
| R3 | 3.4703 | 0.8354 | 1.5400 | 54.0000 | 6.493 |
| R4 | 182.7597 | 0.0300 | — | — | — |
| R5 | 12.9173 | 0.3200 | 1.6600 | 20.5000 | −13.077 |
| R6 | 5.1284 | 0.3805 | — | — | — |
| R7 | −51.3028 | 0.6304 | 1.5400 | 54.0000 | 24.190 |
| R8 | −10.5169 | 0.2315 | — | — | — |
| R9 | 191.3073 | 0.6022 | 1. 6320 | 23.6000 | −32.140 |
| R10 | 18.4319 | 0.4383 | — | — | — |
| R11 | 30.3370 | 0.8735 | 1.5360 | 54.0000 | 11.441 |
| R12 | −7.7492 | 0.8359 | — | — | — |
| R13 | 12.0328 | 0.7592 | 1.5360 | 53.0000 | −7.158 |
| R14 | 2.8428 | 0.8562 | — | — | — |
| R15 | −11.7970 | 0.1000 | 1.6600 | 19.5000 | −89.719 |
| R16 | −6.8206 | 0.0500 | 1.3840 | 71.2000 | 37.496 |

TABLE 22
Sixth Example Lens Data 2

| | |
|---|---|
| Fno | 1. 670 |
| Focal length of entire system of imaging lens | 6.257 |
| Focal length of first lens group | 6.174 |
| Focal length of second lens group | −98.104 |
| Half angle of view | 39.446 |
| Angle of view | 78.892 |
| Entire optical length | 7.889 |
| Image height | 5.560 |

TABLE 23
Sixth Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.32665E+00 | — | −1.73523E−02 | — | −1.62913E−03 | — | 2.12140E−04 |
| R2 | 6.64018E+00 | — | −1.37059E−02 | — | 1.94771E−03 | — | −1.50846E−04 |
| R3 | 3.47026E+00 | — | 2.05906E−02 | — | 5.95024E−04 | — | 1.48229E−04 |
| R4 | 1.82760E+02 | — | 9.83644E−03 | — | −5.76147E−03 | — | 1.34707E−03 |
| R5 | 1.29173E+01 | — | −1.77744E04 | — | −5.29114E−04 | — | 1.09064E−03 |
| R6 | 5.12837E+00 | — | −2.59226E−03 | — | 5.83245E−03 | — | −5.14980E−04 |
| R7 | −5.13028E+01 | — | −7.71703E−03 | — | −2.25150E−03 | — | −2.42401E−04 |
| R8 | −1.05169E+01 | — | −3.91914E−03 | — | −1.00602E−02 | — | 4.87291E−03 |
| R9 | −9.33322E+00 | −8.14327E−03 | 3.73407E−03 | −2.19397E−02 | 5.13079E−03 | 7.04748E−04 | −7.35503E−05 |
| R10 | −9.80322E+00 | −1.36961E−02 | 6.43284E−03 | −1.57616E−02 | 5.83043E−04 | 1.91291E−03 | 1.24379E−04 |
| R11 | 1.00000E+01 | −1.33417E−02 | 1.57524E−02 | −1.05196E−02 | 8.54297E−05 | 9.38985E−05 | 9.19324E−05 |
| R12 | −3.28274E+00 | −1.75008E−02 | 1.85314E−02 | −3.29658E−03 | −1.27983E−03 | 3.01349E−04 | 1.10541E−04 |
| R13 | 7.69882E−02 | −2.24875E−02 | −4.57996E−02 | 1.18942E−02 | 1.25640E−03 | −1.02291E−04 | −1.06650E−04 |
| R14 | −5.40490E+00 | −1.36563E−02 | −2.75742E−02 | 1.12464E−02 | −7.87002E−05 | −6.41872E−04 | 7.76298E−05 |
| R15 | 0.00000E+00 | — | −3.06218E−05 | — | −7.71494E−05 | — | 1.18416E−05 |
| R16 | 0.00000E+00 | — | 1.10495E−02 | — | −8.04108E−04 | — | 3.45444E−05 |

| | A9 | A10 | A11 | A12 | A13 | A14 | A15 |
|---|---|---|---|---|---|---|---|
| R1 | — | 5.17661E−05 | — | −1.09918E−05 | — | — | — |
| R2 | — | 4.45808E−05 | — | −2.74399E−06 | — | — | — |
| R3 | — | −1.22884E−04 | — | 6.29289E−06 | — | — | — |
| R4 | — | −1.74776E−04 | — | 1.11446E−05 | — | — | — |
| R5 | — | −4.75073E−05 | — | −1.02833E−05 | — | 1.62919E−06 | — |
| R6 | — | 4.383448E−04 | — | −4.60202E−05 | — | 6.70546E−06 | — |
| R7 | — | 7.23597E−04 | — | −1.68774E−04 | — | 1.44635E−05 | — |
| R8 | — | −1.00583E−03 | — | 1.27102E−04 | — | −8.73703E−06 | — |
| R9 | 2.47628E−04 | 8.25899E−05 | −5.67244E−06 | −3.14065E−05 | −7.46659E−06 | 1.33502E−06 | 1.99474E−07 |
| R10 | −2.80441E−05 | −3.45944E−05 | 1.27181E−06 | 1.68407E−07 | 1.86298E−07 | 5.30986E−07 | 7.81066E−08 |
| R11 | −1.03413E−05 | 6.25563E−06 | 5.00445E−06 | −1.47240E−06 | 5.00554E−07 | −1.89642E−07 | 5.35418E−08 |
| R12 | −1.05707E−05 | −6.03115E−06 | −5.99627E−07 | −2.72709E−08 | 1.13330E−07 | 1.36824E−08 | −4.49998E−09 |
| R13 | 1.96129E−06 | 3.07024E−06 | 2.67225E−08 | −7.06878E−08 | 3.36115E−10 | 7.38658E−10 | −1.19698E−10 |
| R14 | 7.13544E−07 | 6.31398E−07 | 1.09965E−07 | −6.65747E−08 | −5.86533E−10 | 1.96125E−09 | −1.14960E−10 |
| R15 | — | −5.61951E−07 | — | 8.91021E−09 | — | — | — |
| R16 | — | −8.67170E−07 | — | 9.47368E−09 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 4.45787E−08 | −7.71128E−08 | −7.98239E−08 | −2.39281E−08 | 3.68733E−08 |
| R10 | −2.75412E−08 | −3.01113E−08 | −1.14850E−08 | 4.15834E−10 | 1.36979E−09 |
| R11 | 9.36363E−09 | −3.29679E−09 | −2.42761E−09 | −2.27701E−10 | 1.12475E−10 |
| R12 | −2.10944E−10 | −4.02404E−12 | −4.91746E−12 | −7.32625E−13 | −1.49331E−12 |
| R13 | −1.28621E−11 | −3.29647E−12 | −7.02333E−13 | −2.20864E−14 | 5.36994E−14 |
| R14 | −3.95443E−11 | −3.77836E−12 | −2.47188E−13 | 9.13850E−14 | 7.18343E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 24 below.

TABLE 24

| | | |
|---|---|---|
| (101) | 5.0<f/(\|fa1/fa2\|)<500 | 99.429 |
| (201) | 10<\|fa2/(f9/f8)\|<5000 | 41.000 |
| (301) | \|(f8*Nd8)/(f9*Nd9)\|<30 | 5.497 |
| (401) | \|((R15 − R16)/(R15 + R16))\|<3.5 | 0.267 |
| (501) | TL/IH<1.6 | 1.419 |
| (601) | \|(f1 + f2)/f3\|<8.0 | 2.134 |
| (701) | (Vd2/Vd3)/(Vd4/Vd5)<3.5 | 1.151 |
| (801) | \|(f4 + f5 + f6)/f7\|<14 | 0.488 |

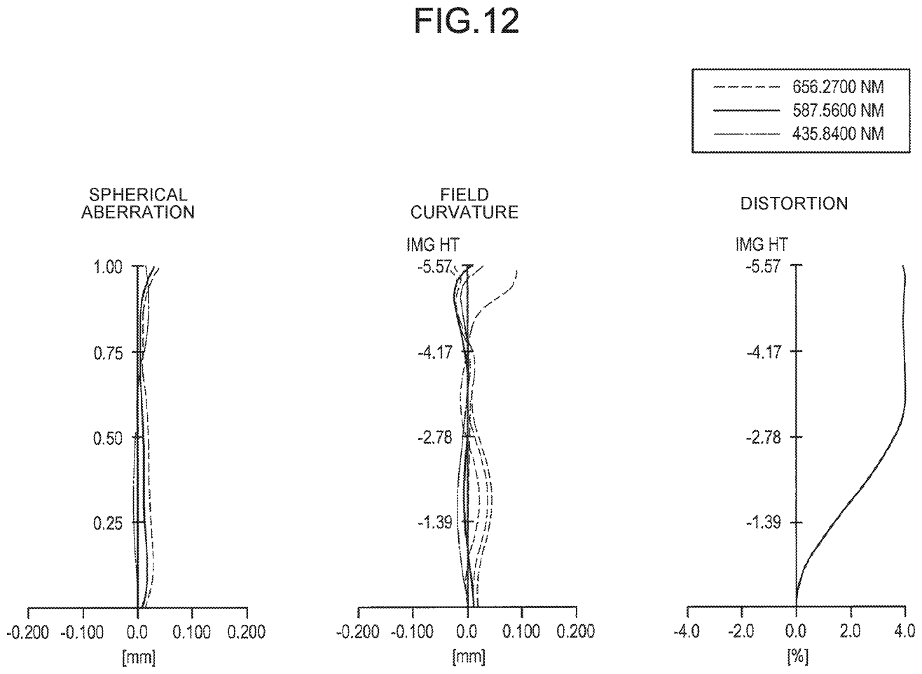

FIG. 12 is a longitudinal aberration diagram in a visible light wavelength band acquired by the imaging lens 100 according to the sixth example.

### 2.7. Seventh Example

Subsequently, the seventh example of the imaging lens 100 according to the present embodiment will be specifically explained.

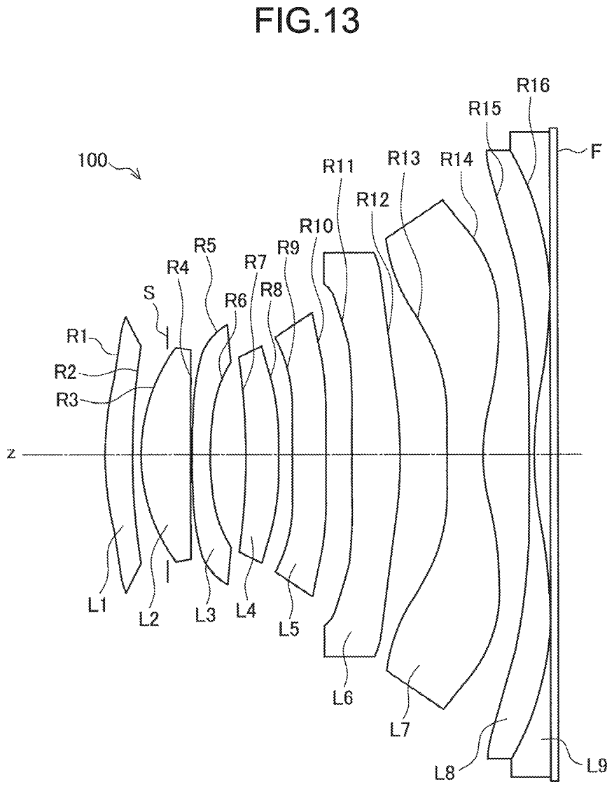

FIG. 13 is a diagram illustrating a structure of an imaging lens 100 according to the seventh example. The imaging lens 100 according to the seventh example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 25 to Table 27 show specific lens data of the imaging lens 100 according to the seventh example. More specifically, Table 25 shows basic lens data of the respective lenses provided in the imaging lens 100 according to the seventh example. Table 26 shows basic lens data about the entire system (or the first lens group La1 and the second lens group La2) of the imaging lens 100 according to the seventh example. Table 27 shows aspheric surface data of the respective lenses provided in the imaging lens 100 according to the seventh example. What is described in the respective tables are similar to those of the above examples and, therefore, explanation thereof is omitted.

TABLE 25
Seventh Example Lens Data 1

| Surface | Curvature | | Refractive | Abbe | Focal |
|---|---|---|---|---|---|
| number | radius | Interval | index | number | length |
| R1 | 4.3304 | 0.4809 | 1.5400 | 54.0000 | 20.471 |
| R2 | 6.8095 | 0.1504 | — | — | — |
| R3 | 3.5172 | 0.8609 | 1.5400 | 54.0000 | 6.450 |
| R4 | −1261.6340 | 0.0300 | — | — | — |
| R5 | 12.8708 | 0.3200 | 1.6600 | 20.5000 | −12.990 |
| R6 | 5.1004 | 0.3627 | — | — | — |
| R7 | −28.9874 | 0.5856 | 1.5400 | 54.0000 | 23.403 |
| R8 | −8.9079 | 0.2457 | — | — | — |
| R9 | 158.9381 | 0.5544 | 1.6320 | 23.6000 | −28.506 |
| R10 | 16.2398 | 0.4531 | — | — | — |
| R11 | 23.8272 | 0.8483 | 1.5360 | 54.0000 | 11.395 |
| R12 | −8.2716 | 0.8203 | — | — | — |
| R13 | 10.6156 | 0.6413 | 1.5360 | 53.0000 | −7.077 |
| R14 | 2.7337 | 0.7787 | — | — | — |
| R15 | −841.2746 | 0.1000 | 1.6600 | 19.5000 | −27.965 |
| R16 | 5.6521 | 0.3000 | 1.3840 | 71.2000 | −31.072 |

TABLE 26
Seventh Example Lens Data 2

| | |
|---|---|
| Fno | 1.720 |
| Focal length of entire system of imaging lens | 6.360 |
| Focal length of first lens group | 6.216 |
| Focal length of second lens group | −30.578 |
| Half angle of view | 38.937 |
| Angle of view | 77.875 |
| Entire optical length | 7.897 |
| Image height | 5.560 |

TABLE 27
Seventh Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.33043E+00 | — | −1.72987E−02 | — | −1.63265E−03 | — | 2.12832E−04 |
| R2 | 6.80945E+00 | — | −1.33696E−02 | — | 1.99213E−03 | — | −1.45634E−04 |
| R3 | 3.51717E+00 | — | 2.06616E−02 | — | 6.68466E−04 | — | 1.53126E−04 |
| R4 | −1.26163E+03 | — | 9.76063E−03 | — | −5.83530E−03 | — | 1.33890E−03 |
| R5 | 1.28708E+01 | — | −2.18142E−04 | — | −5.00137E−04 | — | 1.08762E−03 |
| R6 | 5.10043E+00 | — | −2.67601E−03 | — | 5.92571E−03 | — | −4.74993E−04 |
| R7 | −2.89874E+01 | — | −8.49480E−03 | — | −2.24250E−03 | — | −2.17585E−04 |
| R8 | −8.90790E+00 | — | −3.58639E−03 | — | −1.00781E−02 | — | 4.87651E−03 |
| R9 | −9.33322E+00 | −8.24729E−03 | 3.69371E−03 | −2.21227E−02 | 4.97857E−03 | 6.33064E−04 | −9.78046E−05 |
| R10 | −9.80322E+00 | −1.45899E−02 | 5.77229E−03 | −1.58037E−02 | 6.24296E−04 | 1.93137E−03 | 1.28648E−04 |
| R11 | 1.00000E+01 | −1.60628E−02 | 1.57015E−02 | −1.04406E−02 | 1.02798E−04 | 9.42150E−05 | 9.16675E−05 |
| R12 | −3.28274E+00 | −1.61502E−02 | 1.87113E−02 | −3.26775E−03 | −1.28721E−03 | 2.95356E−04 | 1.08569E−04 |
| R13 | 7.69882E−02 | −2.66385E−02 | −4.54474E−02 | 1.19275E−02 | 1.26452E−03 | −9.99803E−05 | −1.06073E−04 |
| R14 | −5.40490E+00 | −1.44739E−02 | −2.67211E−02 | 1.13313E−02 | −9.97038E−05 | −6.50004E−04 | 7.59704E−05 |
| R15 | 0.00000E+00 | — | −1.37477E−03 | — | −1.77367E−04 | — | 1.80488E−05 |
| R16 | 0.00000E+00 | — | −7.73046E−03 | — | −1.43016E−04 | — | 2.99506E−05 |

| | A9 | A10 | A11 | A12 | A13 | A14 | A15 |
|---|---|---|---|---|---|---|---|
| R1 | — | 5.21936E−05 | — | −1.11304E−05 | — | — | — |
| R2 | — | 4.45925E−05 | — | −2.83746E−06 | — | — | — |
| R3 | — | −1.24774E−04 | — | 5.65398E−06 | — | — | — |
| R4 | — | −1.74765E−04 | — | 1.14958E−05 | — | — | — |
| R5 | — | −4.81921E−05 | — | −9.99584E−06 | — | 1.63422E−06 | — |
| R6 | — | 4.89148E−04 | — | −4.31858E−05 | — | 9.69479E−06 | — |
| R7 | — | 7.38540E−04 | — | −1.62590E−04 | — | 1.68193E−05 | — |
| R8 | — | −1.00209E−03 | — | 1.27102E−04 | — | −7.98697E−06 | — |
| R9 | 2.41383E−04 | 8.14680E−05 | −5.73296E−06 | −3.13923E−05 | −7.50087E−06 | 1.28116E−06 | 1.54161E−07 |
| R10 | −2.77274E−05 | −3.48543E−05 | 1.09556E−06 | 9.29920E−08 | 1.59768E−07 | 5.22676E−07 | 7.55663E−08 |
| R11 | −1.04550E−05 | 6.34756E−06 | 5.07310E−06 | −1.44539E−06 | 5.06619E−07 | −1.89174E−07 | 5.31507E−08 |
| R12 | −1.10403E−05 | −6.10951E−06 | −6.05663E−07 | −2.48164E−08 | 1.15036E−07 | 1.42983E−08 | −4.32669E−09 |
| R13 | 2.05440E−06 | 3.07890E−06 | 2.52243E−08 | −7.19067E−08 | −1.01282E−10 | 6.11725E−10 | −1.51937E−10 |
| R14 | 4.81281E−07 | 6.13669E−07 | 1.11300E−07 | −6.54324E−08 | −2.35098E−10 | 2.04404E−09 | −9.78111E−11 |
| R15 | — | −6.10045E−07 | — | 7.63084E−09 | — | — | — |
| R16 | — | −1.10969E−06 | — | 1.19950E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 1.55919E−08 | −9.42266E−08 | −8.89498E−08 | −2.84093E−08 | 3.47628E−08 |
| R10 | −2.85041E−08 | −3.05466E−08 | −1.17213E−08 | 2.72974E−10 | 1.28706E−09 |
| R11 | 9.05764E−09 | −3.44996E−09 | −2.48551E−09 | −2.47844E−10 | 1.06050E−10 |
| R12 | −1.69993E−10 | 3.13524E−12 | −4.83447E−12 | −1.22760E−12 | −1.79927E−12 |
| R13 | −1.96716E−11 | −4.44432E−12 | −6.92932E−13 | 5.41858E−14 | 9.93486E−14 |
| R14 | −3.62941E−11 | −3.22864E−12 | −1.69613E−13 | 9.99501E−14 | 7.18321E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 28 below.

TABLE 28

| | | |
|---|---|---|
| (101) | 5.0<f/(\|fa1/fa2\|)<500 | 31.284 |
| (201) | 10<\|fa2/(f9/f8)\|<5000 | 33.976 |
| (301) | \|(f8*Nd8)/(f9*Nd9)\|<30 | 2.068 |
| (401) | \|((R15 − R16)/(R15 + R16))\|<3.5 | 1.014 |
| (501) | TL/IH<1.6 | 1.420 |
| (601) | \|(f1 + f2)/f3\|<8.0 | 2.072 |
| (701) | (Vd2/Vd3)/ (Vd4/Vd5)<3.5 | 1.151 |
| (801) | \|(f4 + f5 + f6)/f7\|<14 | 0.889 |

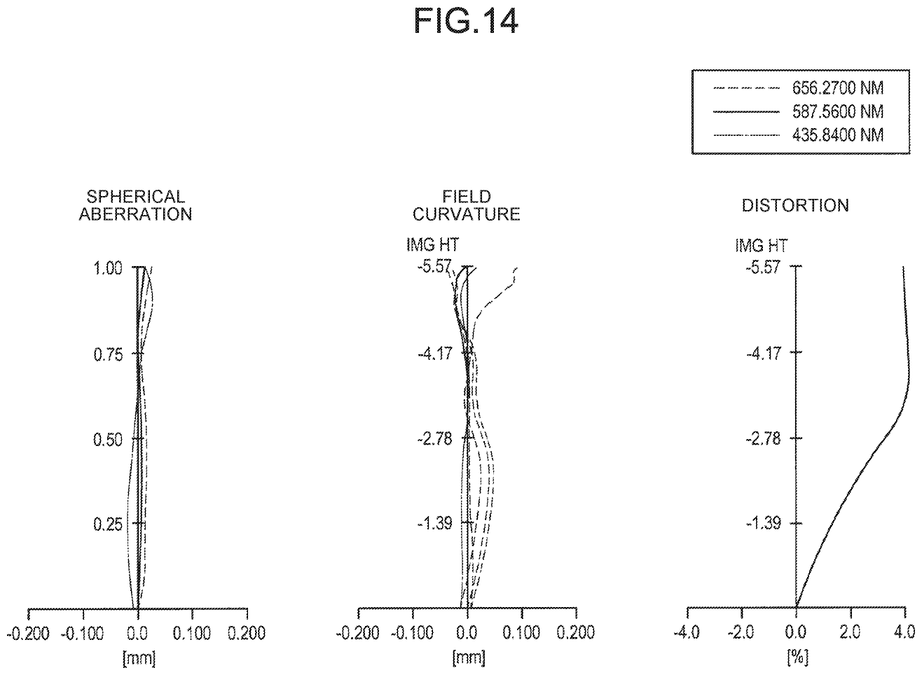

FIG. 14 is a longitudinal aberration diagram in a visible light wavelength band acquired by the imaging lens 100 according to the seventh example.

### 2.8. Eighth Example

Subsequently, the eighth example of the imaging lens 100 according to the present embodiment will be specifically explained.

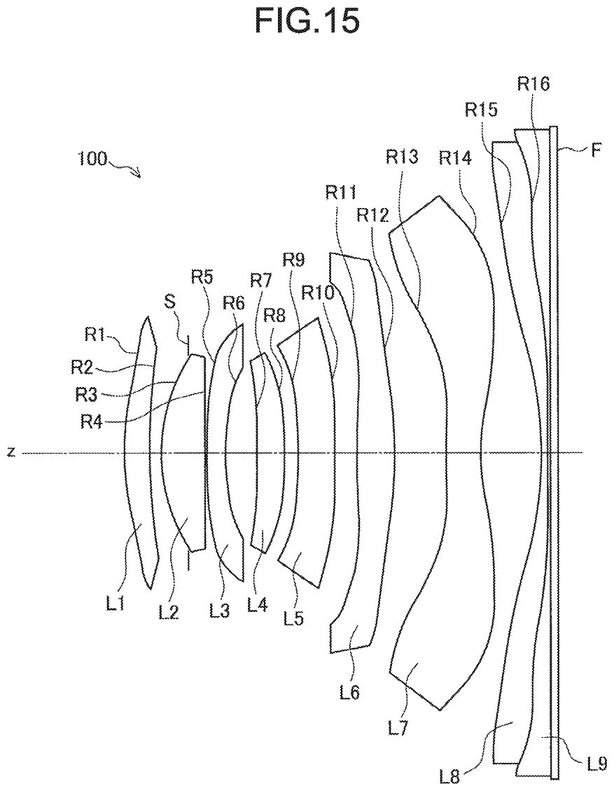

FIG. 15 is a diagram illustrating a structure of an imaging lens 100 according to the eighth example. The imaging lens 100 according to the eighth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 29 to Table 31 show specific lens data of the imaging lens 100 according to the eighth example. More specifically, Table 29 shows basic lens data of the respective lenses provided in the imaging lens 100 according to the eighth example. Table 30 shows basic lens data about the entire system (or the first lens group La1 and the second lens group La2) of the imaging lens 100 according to the eighth example. Table 31 shows aspheric surface data of the respective lenses provided in the imaging lens 100 according to the eighth example. What is described in the respective tables are similar to those of the above examples and, therefore, explanation thereof is omitted.

TABLE 29
Eighth Example Lens Data 1

| Surface | Curvature | | Refracive | Abbe | Focal |
|---|---|---|---|---|---|
| number | radius | Interval | index | number | length |
| R1 | 4.3025 | 0.4486 | 1.5400 | 54.0000 | 15.469 |
| R2 | 8.4819 | 0.1992 | — | — | — |
| R3 | 3.6723 | 0.7498 | 1.5400 | 54.0000 | 6.500 |
| R4 | −88.1863 | 0.0303 | — | — | — |
| R5 | 12.9340 | 0.3202 | 1.6700 | 19.5000 | −10.688 |
| R6 | 4.5695 | 0.3129 | — | — | — |
| R7 | −43.6569 | 0.4758 | 1.5400 | 54.0000 | 18.600 |
| R8 | −8.2450 | 0.2344 | — | — | — |
| R9 | −16.6855 | 0.6230 | 1.6320 | 23.6000 | −16.396 |
| R10 | 28.1505 | 0.3974 | — | — | — |
| R11 | 12.3043 | 0.6448 | 1.5360 | 54.0000 | 9.507 |
| R12 | −8.7552 | 0.9034 | — | — | — |
| R13 | 9.1731 | 0.6000 | 1.5360 | 53.0000 | −9.028 |
| R14 | 3.0933 | 1.0458 | — | — | — |
| R15 | −5.5700 | 0.1000 | 1.6600 | 19.5000 | −11.268 |
| R16 | 36.6321 | 0.0500 | 1.4120 | 62.3000 | −223.633 |

TABLE 30
Eighth Example Lens Data 2

| | |
|---|---|
| Fno | 1.766 |
| Focal length of entire system of imaging lens | 6.149 |
| Focal length of first lens group | 5.938 |
| Focal length of second lens group | −2.082 |
| Half angle of view | 40.391 |
| Angle of view | 80.782 |
| Entire optical length | 7.500 |
| Image height | 5.560 |

TABLE 31
Eighth Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.30253E+00 | — | −1.73221E−02 | — | −1.66877E−03 | — | 2.36975E−04 |
| R2 | 8.48188E+00 | — | −1.23593E−02 | — | 2.04700E−03 | — | −1.48060E−04 |
| R3 | 3.67225E+00 | — | 2.09461E−02 | — | 8.29622E−04 | — | 1.25302E−04 |
| R4 | −8.81863E+01 | — | 1.02800E−02 | — | −5.84574E−03 | — | 1.37185E−03 |
| R5 | 1.9340E+01 | — | 8.31032E−04 | — | −2.39755E−04 | — | 1.06737E−03 |
| R6 | 4.56951E+00 | — | −3.04657E−03 | — | 6.23256E−03 | — | −5.47671E−04 |
| R7 | −4.36569E+01 | — | −8.97951E−03 | — | −2.96907E−03 | — | −3.27008E−04 |
| R8 | −8.24495E+00 | — | −2.22947E−03 | — | −1.10176E−02 | — | 4.74372E−03 |
| R9 | −9.33322E+00 | −7.02479E−03 | 2.78019E−03 | −2.12636E−02 | 5.33100E−03 | 6.53613E−04 | −1.43980E−04 |
| R10 | −9.80322E+00 | −1.93964E−02 | 6.45121E−03 | −1.57696E−02 | 6.98807E−04 | 1.97036E−03 | 1.39234E−04 |
| R11 | 1.00000E+01 | −1.84601E−02 | 1.37791E−02 | −1.03750E−02 | 1.03993E−04 | 7.98734E−05 | 8.57652E−05 |
| R12 | −3.28274E+00 | −1.80149E−02 | 1.91163E−02 | −3.23406E−03 | −1.28998E−03 | 2.93806E−04 | 1.08399E−04 |
| R13 | 7.69882E−02 | −1.87801E−02 | −4.67511E−02 | 1.17816E−02 | 1.24400E−03 | −1.03733E−04 | −1.06815E−04 |
| R14 | −5.40490E+00 | −1.83627E−02 | −2.57415E−02 | 1.14811E−02 | −7.87592E−05 | −6.46190E−04 | 7.65154E−05 |
| R15 | 0.00000E+00 | — | 4.58168E−03 | — | −1.05508E−04 | — | 1.12152E−05 |
| R16 | 0.00000E+00 | — | −5.75584E−03 | — | 1.08668E−04 | — | 2.53012E−05 |

| | A9 | A10 | A11 | A12 | A13 | A14 | A15 |
|---|---|---|---|---|---|---|---|
| R1 | — | 5.61460E−05 | — | −1.19596E−05 | — | — | — |
| R2 | — | 4.71331E−05 | — | −2.56164E−06 | — | — | — |
| R3 | — | −1.40739E−04 | — | 2.27574E−06 | — | — | — |
| R4 | — | −1.74882E−04 | — | 6.84367E−06 | — | — | — |
| R5 | — | −5.80615E−05 | — | −9.64145E−06 | — | 1.38162E−06 | — |
| R6 | — | 4.74060E−04 | — | −4.06627E−05 | — | 8.30658E−06 | — |
| R7 | — | 7.24543E−04 | — | −1.59185E−04 | — | 2.16622E−05 | — |
| R8 | — | −9.86150E−04 | — | 1.27102E−04 | — | −1.17020E−05 | — |
| R9 | 2.08467E−04 | 6.67387E−05 | −1.07749E−05 | −3.26915E−05 | −7.68894E−06 | 1.27663E−06 | 1.22675E−07 |
| R10 | −2.64052E−05 | −3.51211E−05 | 8.81506E−07 | 3.18604E−08 | 1.50037E−07 | 5.29565E−07 | 8.14712E−08 |
| R11 | −1.17390E−05 | 6.29331E−06 | 5.14283E−06 | −1.40757E−06 | 5.18878E−07 | −1.86136E−07 | 5.36412E−08 |
| R12 | −1.10348E−05 | −6.10898E−06 | −6.04399E−07 | −2.47273E−08 | 1.14959E−07 | 1.41675E−08 | −4.40711E−09 |
| R13 | 1.92020E−06 | 3.05862E−06 | 2.35134E−08 | −7.16117E−08 | 1.42977E−10 | 7.08000E−10 | −1.19249E−10 |
| R14 | 4.80216E−07 | 5.92808E−07 | 1.01838E−07 | −6.80734E−08 | −8.46611E−10 | 1.92587E−09 | −1.17517E−10 |
| R15 | — | −6.69696E−07 | — | 1.31755E−08 | — | | — |
| R16 | — | −1.38874E−06 | — | 1.99476E−08 | — | | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | −5.06392E−08 | −1.67601E−07 | −1.55402E−07 | v8.10252E−08 | −3.55303E−09 |
| R10 | −2.59460E−08 | −2.99464E−08 | −1.16851E−08 | 9.43456E−11 | 1.10304E−09 |
| R11 | 9.02144E−09 | −3.49547E−09 | −2.50579E−09 | −2.52926E−10 | 1.06083E−10 |
| R12 | −2.06482E−10 | −1.12307E−11 | −9.84566E−12 | −2.92023E−12 | −2.33772E−12 |
| R13 | −1.05548E−11 | −2.05179E−12 | −1.69360E−13 | 1.41367E−13 | 9.49458E−14 |
| R14 | −3.89945E−11 | −3.49725E−12 | −1.10384E−13 | 1.36145E−13 | 8.50022E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 32 below.

TABLE 32

| | | |
|---|---|---|
| (101) | 5.0<f/(\|fa1/fa2\|)<500 | 12.512 |
| (201) | 10<\|fa2/(f9/f8)\|<5000 | 239.788 |
| (301) | \|(f8*Nd8)/(f9*Nd9)\|<30 | 0.118 |
| (401) | \|((R15 − R16)/(R15 + R16))\|<3.5 | 1.359 |
| (501) | TL/IH<1.6 | 1.349 |
| (601) | \|(f1 + f2)/f3\|<8.0 | 2.055 |
| (701) | (Vd2/Vd3)/ (Vd4/Vd5)<3.5 | 1.210 |
| (801) | \|(f4 + f5 + f6)/f7\|<14 | 1.297 |

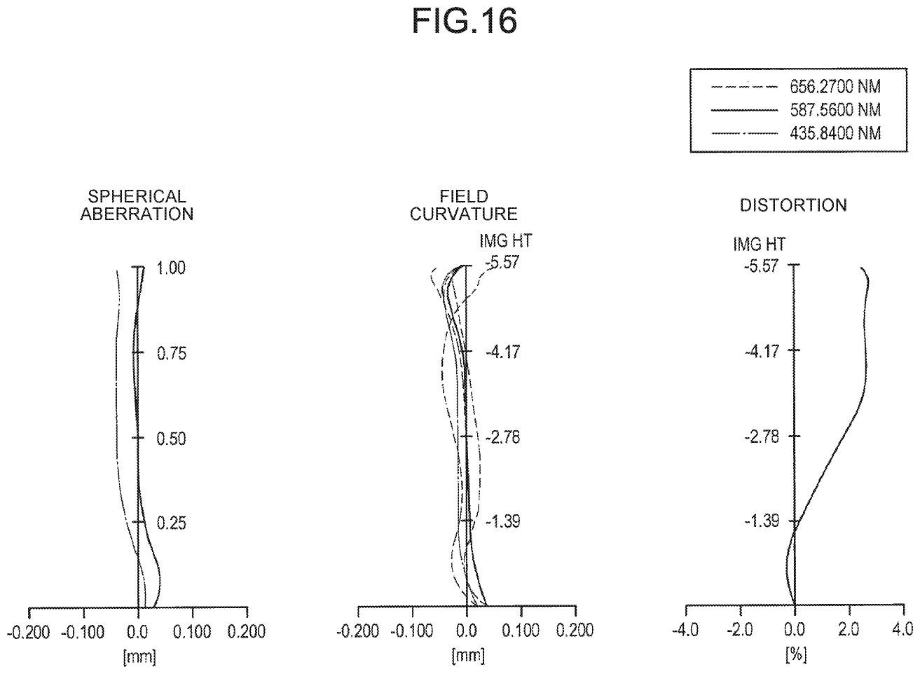

FIG. 16 is a longitudinal aberration diagram in a visible light wavelength band acquired by the imaging lens 100 according to the eighth example.

### 2.9. Ninth Example

Subsequently, the ninth example of the imaging lens 100 according to the present embodiment will be specifically explained.

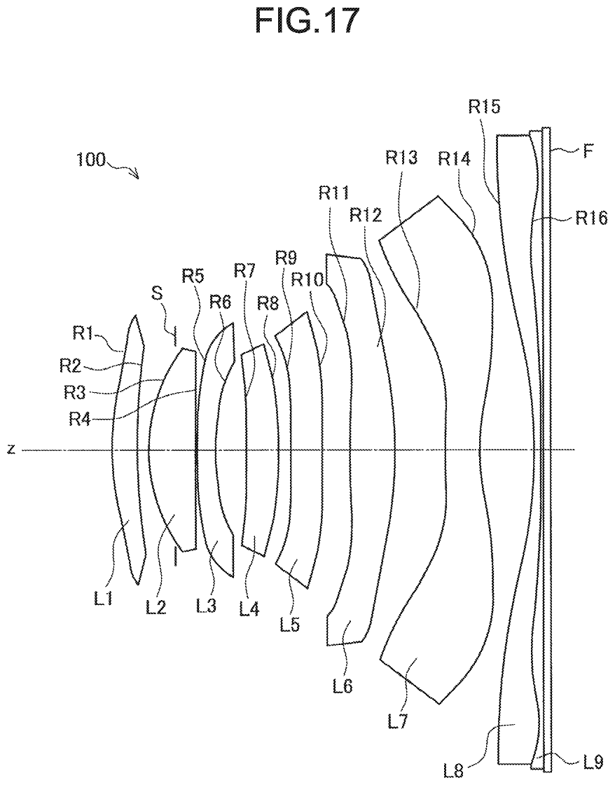

FIG. 17 is a diagram illustrating a structure of the imaging lens 100 according to the ninth example. The imaging lens 100 according to the ninth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 33 to Table 35 show specific lens data of the imaging lens 100 according to the ninth example. More specifically, Table 33 shows basic lens data of the respective lenses provided in the imaging lens 100 according to the ninth example. Table 34 shows basic lens data about the entire system (or the first lens group La1 and the second lens group La2) of the imaging lens 100 according to the ninth example. Table 35 shows aspheric surface data of the respective lenses provided in the imaging lens 100 according to the ninth example. What is described in the respective tables are similar to those of the above examples and, therefore, explanation thereof is omitted.

TABLE 33
Ninth Example Lens Data 1

| | | | Refrac- | | |
|---|---|---|---|---|---|
| Surface | Curvature | | tive | Abbe | Focal |
| number | radius | Interval | index | number | length |
| R1 | 4.3316 | 0.4494 | 1.5400 | 54.0000 | 15.923 |
| R2 | 8.3493 | 0.1861 | — | — | — |
| R3 | 3.7014 | 0.8193 | 1.5400 | 54.0000 | 6.776 |
| R4 | −785.5892 | 0.0300 | — | — | — |
| R5 | 18.0917 | 0.3200 | 1.6500 | 21.5000 | −10.994 |
| R6 | 5.0926 | 0.3197 | — | — | — |
| R7 | −49.1519 | 0.5562 | 1.5400 | 54.0000 | 27.208 |
| R8 | −11.4195 | 0.2349 | — | — | — |
| R9 | 41.9764 | 0.5364 | 1.6320 | 23.6000 | −40.712 |
| R10 | 15.9272 | 0.5131 | — | — | — |
| R11 | 21.7635 | 0.7723 | 1.5360 | 54.0000 | 11.287 |
| R12 | −8.4446 | 0.9051 | — | — | — |
| R13 | 8.9966 | 0.6000 | 1.5360 | 53.0000 | −8.332 |
| R14 | 2.9129 | 0.9636 | — | — | — |
| R15 | −7.3349 | 0.1000 | 1.6000 | 23.0000 | −16.758 |
| R16 | 263.3098 | 0.0500 | 1.4120 | 71.2000 | −1850.750 |

TABLE 34
Ninth Example Lens Data 2

| | |
|---|---|
| Fno | 1.690 |
| Focal length of entire system of imaging lens | 6.230 |
| Focal length of first lens group | 6.085 |
| Focal length of second lens group | −18.324 |
| Half angle of view | 39.675 |
| Angle of view | 79.349 |
| Entire optical length | 7.720 |
| Image height | 5.560 |

TABLE 35
Ninth Example Lens Data 3 (Aspheric surface data)

| Surface | Conic | | | | | | |
|---|---|---|---|---|---|---|---|
| number | Ccoefficient | A3 | A4 | A5 | A6 | A7 | A8 |
| R1 | 4.33159E+00 | — | −1.73241E−02 | — | −1.62582E−03 | — | 2.20094E−04 |
| R2 | 8.34927E+00 | — | −1.27918E−02 | — | 1.96402E−03 | — | −1.61064E−04 |
| R3 | 3.70143E+00 | — | 2.08494E−02 | — | 8.90072E−04 | — | 1.77773E−04 |
| R4 | −7.85589E+02 | — | 9.84839E−03 | — | −5.81003E−03 | — | 1.36695E−03 |
| R5 | 1.80917E+01 | — | 9.48611E−05 | — | −4.25443E−04 | — | 1.08301E−03 |
| R6 | 5.09257E+00 | — | −3.18343E−03 | — | 6.12014E−03 | — | −5.27257E−04 |
| R7 | −4.91519E+01 | — | −7.59113E−03 | — | −2.47437E−03 | — | −2.22622E−04 |
| R8 | −1.14195E+01 | — | −2.90607E−03 | — | −9.97333E−03 | — | 4.87371E−03 |
| R9 | −9.33322E+00 | −8.53771E−03 | 3.39560E−03 | −2.18538E−02 | 5.08727E−03 | 6.39178E−04 | −1.07648E−04 |
| R10 | −9.80322E+00 | −1.38098E−02 | 5.83039E−03 | −1.60266E−02 | 5.72898E−04 | 1.93302E−03 | 1.33500E−04 |
| R11 | 1.00000E+01 | −1.57250E−02 | 1.67290E−02 | −1.02908E−02 | 7.83782E−05 | 5.85603E−05 | 7.90948E−05 |
| R12 | −3.28274E+00 | −1.79386E−02 | 1.85243E−02 | −3.34254E−03 | −1.30669E−03 | 2.93385E−04 | 1.08282E−04 |
| R13 | 7.69882E−02 | −2.31745E−02 | −4.63897E−02 | 1.17359E−02 | 1.23155E−03 | −1.05108E−04 | −1.06881E−04 |
| R14 | −5.40490E+00 | −1.78196E−02 | −2.61437E−02 | 1.14611E−02 | −8.47765E−05 | −6.46294E−04 | 7.70610E−05 |
| R15 | 0.00000E+00 | — | 3.14202E−03 | — | −1.54732E−04 | — | 1.35424E−05 |
| R16 | 0.00000E+00 | — | −2.17873E−03 | — | −1.05173E−04 | — | 2.82673E−05 |

| | A9 | A10 | A11 | A12 | A13 | A14 | A15 |
|---|---|---|---|---|---|---|---|
| R1 | — | 5.33406E−05 | — | −1.11366E−05 | — | — | — |
| R2 | — | 4.40046E−05 | — | −2.41821E−06 | — | — | — |
| R3 | — | −1.31105E−04 | — | 2.74249E−06 | — | — | — |
| R4 | — | −1.67970E−04 | — | 9.79533E−06 | — | — | — |
| R5 | — | −5.37159E−05 | — | −1.06680E−05 | — | 2.91859E−06 | — |
| R6 | — | 4.70311E−04 | — | −4.59439E−05 | — | 1.10082E−05 | — |
| R7 | — | 7.48894E−04 | — | −1.63002E−04 | — | 1.45392E−05 | — |
| R8 | — | −1.00757E−03 | — | 1.27102E−04 | — | −8.20086E−06 | — |
| R9 | 2.35457E−04 | 8.14548E−05 | −4.75290E−06 | −3.07473E−05 | −7.04595E−06 | 1.43308E−06 | 1.98333E−07 |
| R10 | −2.68222E−05 | −3.48357E−05 | 9.50470E−07 | −7.91772E−09 | 9.12498E−08 | 4.90581E−07 | 6.37605E−08 |
| R11 | −1.30149E−05 | 5.85785E−06 | 5.02479E−06 | −1.43391E−06 | 5.15796E−07 | −1.86129E−07 | 5.39336E−08 |
| R12 | −1.09303E−05 | −6.08189E−06 | −5.87844E−07 | −1.95082E−08 | 1.16563E−07 | 1.44938E−08 | −4.33692E−09 |
| R13 | 2.01391E−06 | 3.06019E−06 | 2.89913E−08 | −7.12033E−08 | 3.55427E−10 | 7.31567E−10 | −7.40444E−11 |
| R14 | 4.49525E−07 | 5.96748E−07 | 1.03370E−07 | −6.52843E−08 | −3.05642E−10 | 2.03555E−09 | −8.74873E−11 |
| R15 | — | −5.64422E−07 | — | 8.08939E−09 | — | — | — |
| R16 | — | −1.21860E−06 | — | 1.54790E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | −1.70573E−09 | −1.09423E−07 | −9.78236E−08 | −3.30093E−08 | 3.41174E−08 |
| R10 | −3.22849E−08 | −3.12119E−08 | −1.19462E−08 | 5.53790E−10 | 1.48712E−09 |
| R11 | 9.43052E−09 | −3.35290E−09 | −2.41093E−09 | 2.12840E−10 | 1.23625E−10 |
| R12 | −1.70387E−10 | −7.64644E−12 | −6.74861E−12 | −2.28662E−12 | −2.67235E−12 |
| R13 | −8.95333E−12 | −4.12071E−12 | 4.71299E−13 | −7.28720E−14 | 3.67173E−14 |
| R14 | −3.82651E−11 | −3.28882E−12 | −4.22701E−13 | 5.02150E−14 | 6.49363E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 36 below.

TABLE 36

| | | |
|---|---|---|
| (101) | 5.0<f/(\|fa1/fa2\|)<500 | 18.763 |
| (201) | 10<\|fa2/(f9/f8)\|<5000 | 2023.721 |
| (301) | \|(f8*Nd8)/(f9*Nd9)\|<30 | 0.020 |
| (401) | \|((R15 − R16)/(R15 + R16))\|<3.5 | 1.057 |
| (501) | TL/IH<1.6 | 1.388 |
| (601) | \|(f1 + f2)/f3\|<8.0 | 2.065 |
| (701) | (Vd2/Vd3)/(Vd4/vd5)<3.5 | 1.098 |
| (801) | \|(f4 + f5 + f6)/f7\|<14 | 0.266 |

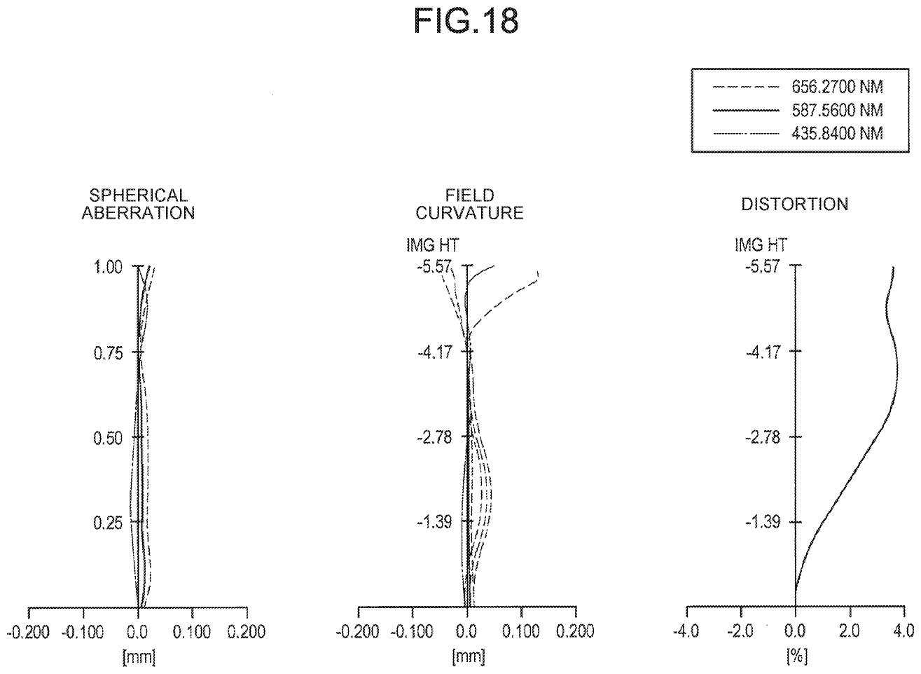

FIG. 18 is a longitudinal aberration diagram in a visible light wavelength band acquired by the imaging lens 100 according to the ninth example.

### 2.10. Tenth Example

Subsequently, the tenth example of the imaging lens 100 according to the present embodiment will be specifically explained.

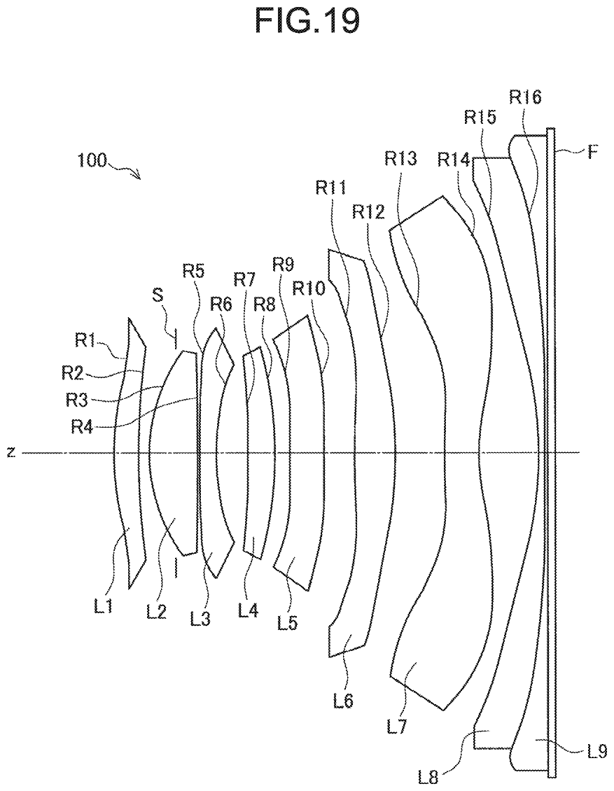

FIG. 19 is a diagram illustrating a structure of the imaging lens 100 according to the tenth example. The imaging lens 100 according to the tenth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 37 to Table 39 show specific lens data of the imaging lens 100 according to the tenth example. More specifically, Table 37 shows basic lens data of the respective lenses provided in the imaging lens 100 according to the tenth example. Table 38 shows basic lens data about the entire system (or the first lens group La1 and the second lens group La2) of the imaging lens 100 according to the tenth example. Table 39 shows aspheric surface data of the respective lenses provided in the imaging lens 100 according to the tenth example. What is described in the respective tables are similar to those of the above examples and, therefore, explanation thereof is omitted.

TABLE 37
Tenth Example Lens Data 1

| | | | Refrac- | | |
|---|---|---|---|---|---|
| Surface | Curvature | | tive | Abbe | Focal |
| number | radius | Interval | index | number | length |
| R1 | 4.4547 | 0.4384 | 1.5400 | 54.0000 | 17.635 |
| R2 | 8.0297 | 0.1923 | — | — | — |
| R3 | 3.6826 | 0.8450 | 1.5400 | 54.0000 | 6.247 |
| R4 | −40.3530 | 0.0300 | — | — | — |
| R5 | 52.0306 | 0.3200 | 1.6320 | 21.5000 | −9.225 |
| R6 | 5.2562 | 0.2887 | — | — | — |
| R7 | −245.4473 | 0.4887 | 1.5400 | 54.0000 | 19.113 |
| R8 | −9.9803 | 0.2725 | — | — | — |
| R9 | −69.8110 | 0.5956 | 1.5800 | 30.0000 | −28.466 |
| R10 | 21.8400 | 0.5519 | — | — | — |
| R11 | 24.3248 | 0.7144 | 1.5360 | 54.0000 | 10.421 |
| R12 | −7.3135 | 0.8716 | — | — | — |
| R13 | 7.6878 | 0.6000 | 1.5360 | 53.0000 | −9.502 |
| R14 | 2.9781 | 1.0696 | — | — | — |
| R15 | −5.8378 | 0.1000 | 1.6200 | 48.0000 | −12.711 |
| R16 | 86.8190 | 0.0500 | 1.3840 | 71.2000 | −558.385 |

TABLE 38
TENTH EXAMPLE LENS DATA 2

| | |
|---|---|
| Fno | 1.680 |
| Focal length of entire system of | 6.230 |
| imaging lens | |
| Focal length of first lens group | 6.052 |
| Focal length of second lens group | −13.898 |
| Half angle of view | 39.896 |
| Angle of view | 79.791 |
| Entire optical length | 7.800 |
| Image height | 5.560 |

TABLE 39
Tenth Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.45472E+00 | — | −1.58118E−02 | — | −1.40302E−03 | — | 1.76644E−04 |
| R2 | 8.02966E+00 | — | −1.17717E−02 | — | 1.70919E−03 | — | −1.30951E−04 |
| R3 | 3.68260E+00 | — | 1.94130E−02 | — | 7.68909E−04 | — | 1.39221E−04 |
| R4 | −4.03530E+01 | — | 9.06517E−03 | — | −5.03211E−03 | — | 1.23087E−03 |
| R5 | 5.20306E+01 | — | 3.94823E−04 | — | −3.37347E−04 | — | 8.67233E−04 |
| R6 | 5.25621E+00 | — | −2.70459E−03 | — | 5.34804E−03 | — | −4.35230E−04 |
| R7 | −2.45447E+02 | — | −7.26707E−03 | — | −2.43651E−03 | — | −1.96640E−04 |
| R8 | −9.98030E+00 | — | −1.83918E−03 | — | −8.76393E−03 | — | 3.89543E−03 |
| R9 | −9.33322E+00 | −9.12393E−03 | 3.02238E−03 | −1.94073E−02 | 4.46550E−03 | 5.99094E−04 | −5.88306E−05 |
| R10 | −9.80322E+00 | −1.49701E−02 | 4.60306E−03 | −1.41741E−02 | 5.32536E−04 | 1.62616E−03 | 1.09516E−04 |
| R11 | 1.00000E+01 | −1.41814E−02 | 1.51398E−02 | −9.07483E−03 | 5.65133E−05 | 4.59223E−05 | 6.33015E−05 |
| R12 | −3.28274E+00 | −1.73112E−02 | 1.68898E−02 | −2.88917E−03 | −1.10328E−03 | 2.49813E−04 | 8.91775E−05 |
| R13 | 7.69882E−02 | −2.17644E−02 | −4.25873E−02 | 1.04342E−02 | 1.06799E−03 | −8.70720E−05 | −8.64914E−05 |
| R14 | −5.40490E+00 | −1.65781E−02 | −2.38845E−02 | 1.01616E−02 | −6.83941E−05 | −5.39375E−04 | 6.22746E−05 |
| R15 | 0.00000E+00 | — | 3.92038E−03 | — | −1.33684E−04 | — | 1.24270E−05 |
| R16 | 0.00000E+00 | — | −2.17565E−03 | — | −7.81613E−05 | — | 2.19866E−05 |

| | A9 | A10 | A11 | A12 | A13 | A14 | A15 |
|---|---|---|---|---|---|---|---|
| R1 | — | 3.86839E−05 | — | −8.81874E−06 | — | — | — |
| R2 | — | 3.14409E−05 | — | −3.13734E−06 | — | — | — |
| R3 | — | −9.54160E−05 | — | 5.23825E−06 | — | — | — |
| R4 | — | −1.23957E−04 | — | 3.84750E−06 | — | — | — |
| R5 | — | −5.54201E−05 | — | −1.09227E−05 | — | 1.42099E−06 | — |
| R6 | — | 3.46503E−04 | — | −3.81850E−05 | — | 5.67771E−06 | — |
| R7 | — | 5.79627E−04 | — | −1.12888E−04 | — | 1.17705E−05 | — |
| R8 | — | −7.67986E−04 | — | 9.15265E−05 | — | −5.58178E−06 | — |
| R9 | 1.94098E−04 | 6.25899E−05 | −4.80404E−06 | −2.33078E−05 | −5.77204E−06 | 5.38633E−07 | −8.54789E−08 |
| R10 | −2.00024E−05 | −2.62275E−05 | 9.61653E−07 | 1.11245E−07 | 1.24321E−07 | 3.61767E−07 | 5.26494E−08 |
| R11 | −1.05800E−05 | 4.55979E−06 | 3.76993E−06 | −1.01604E−06 | 3.63487E−07 | −1.25367E−07 | 3.58158E−08 |
| R12 | −8.33187E−06 | −4.60211E−06 | −4.34401E−07 | −1.46957E−08 | 8.07152E−08 | 9.52255E−09 | −2.94343E−09 |
| R13 | 1.55911E−06 | 2.35188E−06 | 2.24143E−08 | −5.05993E−08 | 2.84909E−10 | 5.43261E−10 | −6.82796E−11 |
| R14 | 4.37314E−07 | 4.62411E−07 | 7.75071E−08 | −4.86488E−08 | −5.77552E−10 | 1.30559E−09 | −7.85724E−11 |
| R15 | — | −6.94483E−07 | — | 1.26769E−08 | — | — | — |
| R16 | — | −1.12979E−06 | — | 1.77977E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | −8.41904E−08 | −9.53383E−08 | −6.53758E−08 | −1.64080E−08 | 2.35982E−08 |
| R10 | −1.71296E−08 | −1.87260E−08 | −7.09569E−09 | 8.93916E−11 | 6.68034E−10 |
| R11 | 6.06680E−09 | −2.07277E−09 | −1.46963E−09 | −1.34961E−10 | 6.50068E−11 |
| R12 | −1.53320E−10 | −1.51821E−11 | −8.71212E−12 | −2.58015E−12 | −1.57875E−12 |
| R13 | −5.30678E−12 | −1.22136E−12 | −1.79852E−13 | 4.18801E−14 | 3.78402E−14 |
| R14 | −2.52004E−11 | −2.21925E−12 | −8.27683E−14 | 7.52295E−14 | 4.74512E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 40 below.

TABLE 40

| | | |
|---|---|---|
| (101) | 5.0<f/(\|fa1/fa2\|)<500 | 14.308 |
| (201) | 10<\|fa2/(f9/f8)\|<5000 | 610.566 |
| (301) | \|(f8*Nd8)/(f9*Nd9)\|<30 | 0.051 |
| (401) | \|((R15 − R16)/(R15 + R16))\|<3.5 | 1.144 |
| (501) | TL/IH<1.6 | 1.403 |
| (601) | \|(f1 + f2)/f3\|<8.0 | 2.589 |
| (701) | (Vd2/Vd3)/(Vd4/Vd5)<3.5 | 1.395 |
| (801) | \|(f4 + f5 + f6)/f7\|<14 | 0.112 |

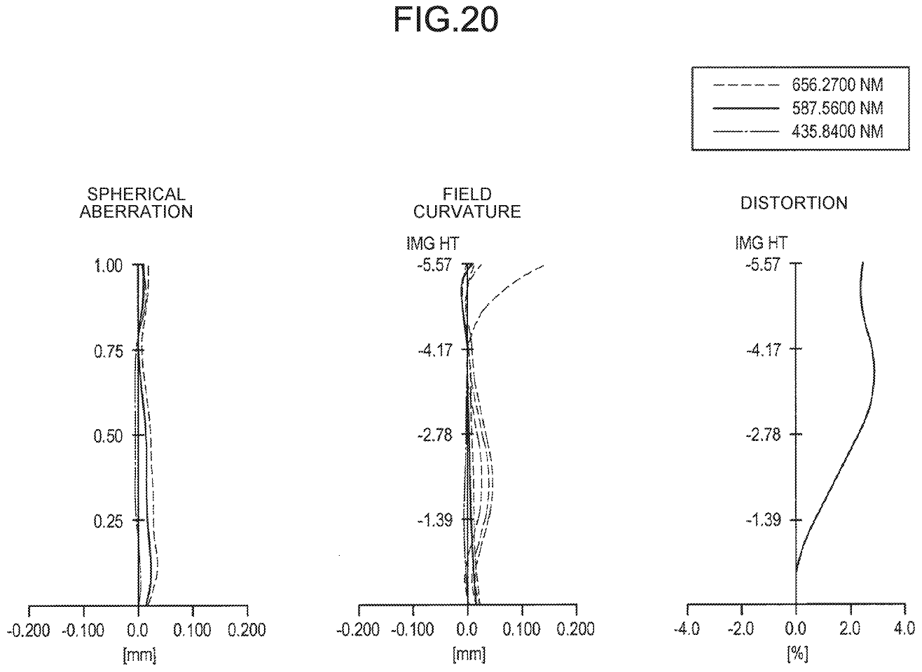

FIG. 20 is a longitudinal aberration diagram in a visible light wavelength band acquired by the imaging lens 100 according to the tenth example.

### 2.11. Eleventh Example

Subsequently, the eleventh example of the imaging lens 100 according to the present embodiment will be specifically explained.

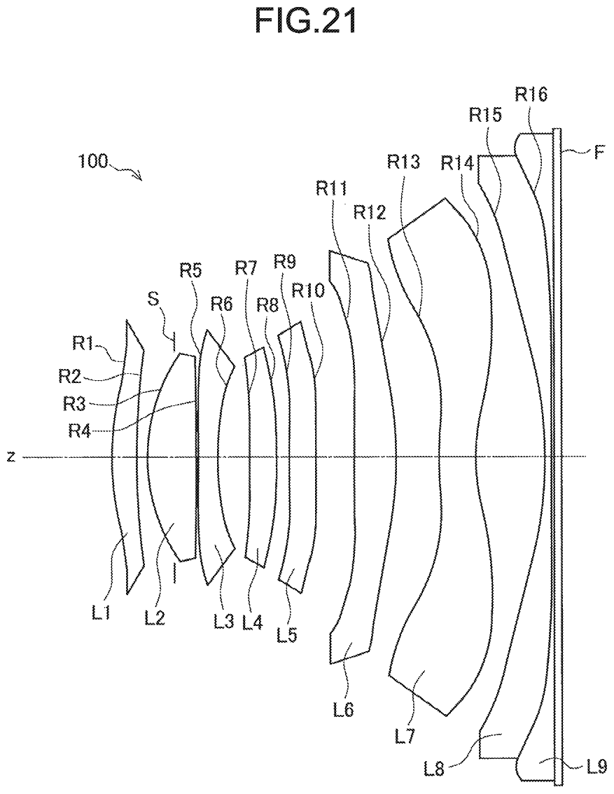

FIG. 21 is a diagram illustrating a structure of the imaging lens 100 according to the eleventh example. The imaging lens 100 according to the eleventh example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 41 to Table 43 show specific lens data of the imaging lens 100 according to the eleventh example. More specifically, Table 41 shows basic lens data of the respective lenses provided in the imaging lens 100 according to the eleventh example. Table 42 shows basic lens data about the entire system (or the first lens group La1 and the second lens group La2) of the imaging lens 100 according to the eleventh example. Table 43 shows aspheric surface data of the respective lenses provided in the imaging lens 100 according to the eleventh example. What is described in the respective tables are similar to those of the above examples and, therefore, explanation thereof is omitted.

TABLE 41
Eleventh Example Lens Data 1

| | | | Refrac- | | |
|---|---|---|---|---|---|
| Surface | Curvature | | tive | Abbe | Focal |
| number | radius | Interval | index | number | length |
| R1 | 4.4421 | 0.4168 | 1.5400 | 54.0000 | 21.086 |
| R2 | 7.0107 | 0.1712 | — | — | — |
| R3 | 3.5804 | 0.8618 | 1.5400 | 54.0000 | 5.805 |
| R4 | −24.4499 | 0.0300 | — | — | — |
| R5 | −268.4257 | 0.3358 | 1.6320 | 21.5000 | −8.196 |
| R6 | 5.3141 | 0.3045 | — | — | — |
| R7 | 57.3283 | 0.4725 | 1.5400 | 54.0000 | 24.833 |
| R8 | −17.6186 | 0.2309 | — | — | — |
| R9 | 20.5546 | 0.4500 | 1.5360 | 54.0000 | —134.968 |
| R10 | 15.9344 | 0.6776 | — | — | — |
| R11 | 29.2620 | 0.7165 | 1.5360 | 54.0000 | 11.295 |
| R12 | −7.7084 | 0.7647 | — | — | — |
| R13 | 6.1017 | 0.6373 | 1.5360 | 53.0000 | −10.566 |
| R14 | 2.8286 | 1.2090 | — | — | — |
| R15 | −5.5424 | 0.1000 | 1.6200 | 48.0000 | −12.425 |
| R16 | −556.0270 | 0.0500 | 1.3840 | 71.2000 | 3576.150 |

TABLE 42
Eleventh Example Lens Data 2

| | |
|---|---|
| Fno | 1.680 |
| Focal length of entire system of imaging lens | 6.231 |
| Focal length of first lens group | 6.043 |
| Focal length of second lens group | −13.586 |
| Half angle of view | 39.948 |
| Angle of view | 79.897 |
| Entire optical length | 7.800 |
| Image height | 5.560 |

TABLE 43
Eleventh Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.44213E+00 | — | −1.59063E−02 | — | −1.39299E−03 | — | −1.81518E−04 |
| R2 | 7.01065E+00 | — | −1.18761E−02 | — | 1.73553E−03 | — | −1.22962E−04 |
| R3 | 3.58044E+00 | — | 1.91209E−02 | — | 7.49866E−04 | — | 1.08613E−04 |
| R4 | −2.44499E+01 | — | 1.04558E−02 | — | −4.97455E−03 | — | 1.34392E−03 |
| R5 | −2.68426E+02 | — | 2.10047E−03 | — | −7.09388E−05 | — | 7.77831E−04 |
| R6 | 5.31407E+00 | — | −2.23443E−03 | — | 5.59784E−03 | — | −5.22011E−04 |
| R7 | 5.73283E+01 | — | −7.58792E−03 | — | −2.87906E−03 | — | −1.96390E−04 |
| R8 | −1.76186E+01 | — | −1.44244E−03 | — | −9.39182E−03 | — | 3.74133E−03 |
| R9 | −9.33322E+00 | −7.39754E−03 | 2.55232E−03 | −1.96643E−02 | 4.42187E−03 | 5.98452E−04 | −5.82328E−05 |
| R10 | −9.80322E+00 | −1.35987E−02 | 2.66163E−03 | −1.45003E−02 | 5.26408E−04 | 1.64292E−03 | 1.17585E−04 |
| R11 | 1.00000E+01 | −1.38151E−02 | 1.55283E−02 | −8.82791E−03 | 1.32837E−04 | 4.78099E−05 | 5.68454E−05 |
| R12 | −3.28274E+00 | −1.98563E−02 | 1.70003E−02 | −2.73627E−03 | −1.08010E−03 | 2.58633E−04 | 9.03884E−05 |
| R13 | 7.69882E−02 | −2.35364E−02 | −4.32669E−02 | 1.03134E−02 | 1.04958E−03 | −8.69939E−05 | −8.60621E−05 |
| R14 | −5.40490E+00 | −1.38407E−02 | −2.47464E−02 | 1.01633E−02 | −5.31491E−05 | −5.36443E−04 | 6.24582E−05 |
| R15 | 0.00000E+00 | — | 4.17622E−03 | — | −8.54948E−05 | — | 8.55081E−06 |
| R16 | 0.00000E+00 | — | 7.98725E−04 | — | −2.21229E−04 | — | 2.05328E−05 |

| | A9 | A10 | A11 | A12 | A13 | A14 | A15 |
|---|---|---|---|---|---|---|---|
| R1 | — | 3.70172E−05 | — | −1.02329E−05 | — | — | — |
| R2 | — | 2.94595E−05 | — | −5.81295E−06 | — | — | — |
| R3 | — | −8.86966E−05 | — | 1.32673E−05 | — | — | — |
| R4 | — | −1.10532E−04 | — | −2.18712E−06 | — | — | — |
| R5 | — | −7.30896E−05 | — | −1.02942E−05 | — | 4.85277E−07 | — |
| R6 | — | 2.96431E−04 | — | −4.87125E−05 | — | 9.62866E−06 | — |
| R7 | — | 5.54540E−04 | — | −1.20306E−04 | — | 1.41281E−05 | — |
| R8 | — | −7.34072E−04 | — | 9.15265E−05 | — | −5.18850E−06 | — |
| R9 | 1.94825E−04 | 6.38324E−05 | −3.40844E−06 | −2.21803E−05 | −5.00282E−06 | 9.58885E−07 | 1.20006E−07 |
| R10 | −1.71791E−05 | −2.53524E−05 | 1.26054E−06 | 2.17431E−07 | 1.70981E−07 | 3.83098E−07 | 6.31922E−08 |
| R11 | −1.38847E−05 | 3.58534E−06 | 3.58114E−06 | −1.02560E−06 | 3.73862E−07 | −1.18858E−07 | 3.82364E−08 |
| R12 | −8.25213E−06 | −4.61982E−06 | −4.52464E−07 | −2.16187E−08 | 7.86010E−08 | 9.02073E−09 | −3.03762E−09 |
| R13 | 1.76735E−06 | 2.41553E−06 | 3.81732E−08 | −4.71471E−08 | 9.34592E−10 | 6.45928E−10 | −5.79893E−11 |
| R14 | 4.50697E−07 | 4.54134E−07 | 7.52025E−08 | −4.84806E−08 | −6.15140E−10 | 1.28178E−09 | −8.60235E−11 |
| R15 | — | −6.32627E−07 | — | 1.38368E−08 | — | — | — |
| R16 | — | −9.75916E−07 | — | 1.61790E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 2.11647E−09 | −6.18442E−08 | −5.24582E−08 | −1.37672E−08 | 2.38111E−08 |
| R10 | −1.28794E−08 | −1.75157E−08 | −7.29021E−09 | −3.59486E−10 | 2.76526E−10 |
| R11 | 6.79658E−09 | −1.90970E−09 | −1.45226E−09 | −1.43344E−10 | 5.79434E−11 |
| R12 | −1.63576E−10 | −1.23437E−11 | −5.93493E−12 | −1.39098E−12 | −1.08681E−12 |
| R13 | −7.47982E−12 | −2.99634E−12 | −9.06131E−13 | −2.04350E−13 | −3.80043E−14 |
| R14 | −2.67185E−11 | −2.50883E−12 | −9.08442E−14 | 7.95268E−14 | 5.34744E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 44 below.

TABLE 44

| | | |
|---|---|---|
| (101) | 5.0<f/(\|fa1/fa2\|)<500 | 14.007 |
| (201) | 10<\|fa2/(f9/f8)\|<5000 | 3910.345 |
| (301) | \|(f8*Nd8)/(f9*Nd9)\|<30 | 0.008 |
| (401) | \|((R15 − R16)/(R15 + R16))\|<3.5 | 0.980 |
| (501) | TL/IH<1.6 | 1.403 |
| (601) | \|(f1 + f2)/f3\|<8.0 | 3.281 |
| (701) | (Vd2/Vd3)/ (Vd4/Vd5)<3.5 | 2.512 |
| (801) | \|(f4 + f5 + f6)/f7\|<14 | 9.355 |

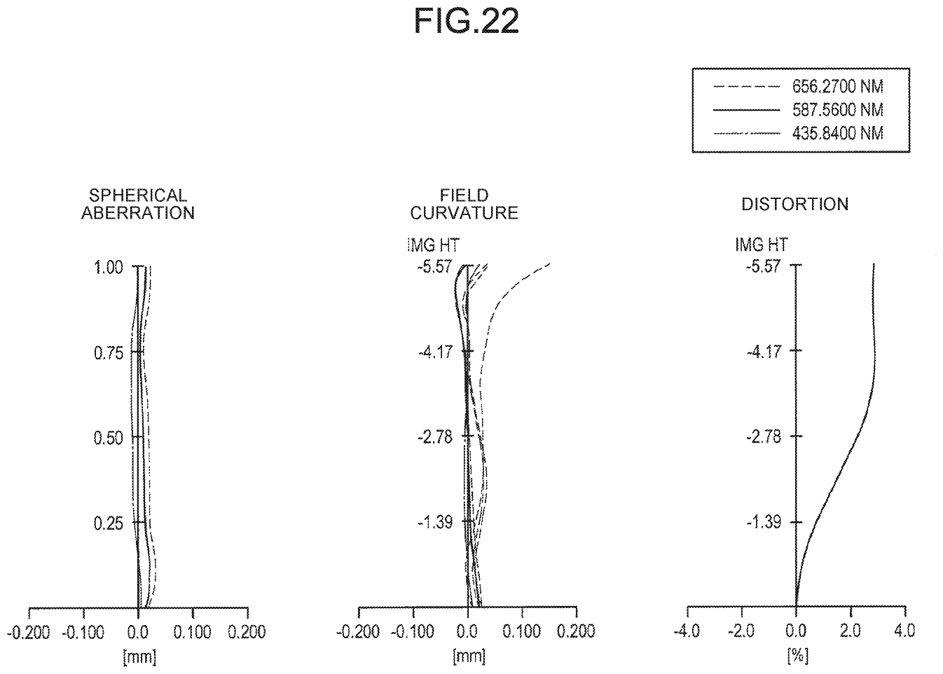

FIG. 22 is a longitudinal aberration diagram in a visible light wavelength band acquired by the imaging lens 100 according to the eleventh example.

### 2.12. Twelfth Example

Subsequently, the twelfth example of the imaging lens 100 according to the present embodiment will be specifically explained.

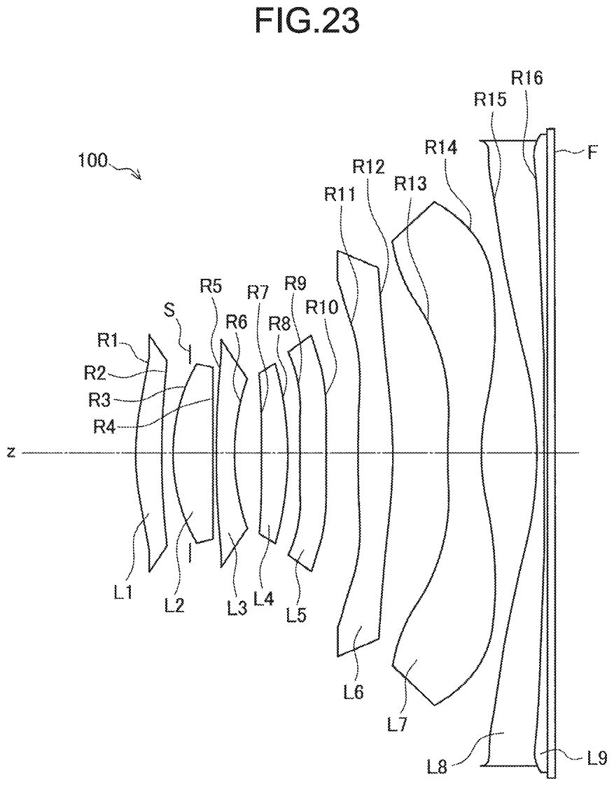

FIG. 23 is a diagram illustrating a structure of the imaging lens 100 according to the twelfth example. The imaging lens 100 according to the twelfth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 45 to Table 47 show specific lens data of the imaging lens 100 according to the twelfth example. More specifically, Table 45 shows basic lens data of the respective lenses provided in the imaging lens 100 according to the twelfth example. Table 46 shows basic lens data about the entire system (or the first lens group La1 and the second lens group La2) of the imaging lens 100 according to the twelfth example. Table 47 shows aspheric surface data of the respective lenses provided in the imaging lens 100 according to the twelfth example. What is described in the respective tables are similar to those of the above examples and, therefore, explanation thereof is omitted.

TABLE 45
Twelfth Example Lens Data 1

| | | | Refrac- | | |
|---|---|---|---|---|---|
| Surface | Curvature | | tive | Abbe | Focal |
| number | radius | Interval | index | number | length |
| R1 | 4.3922 | 0.4518 | 1.5400 | 54.0000 | 16.190 |
| R2 | 8.4455 | 0.1906 | — | — | — |
| R3 | 3.6487 | 0.6973 | 1.5400 | 54.0000 | 6.272 |
| R4 | −48.9331 | 0.0566 | — | — | — |
| R5 | 25.2539 | 0.3291 | 1.6320 | 21.5000 | −8.914 |
| R6 | 4.6035 | 0.3294 | — | — | — |
| R7 | −107.0458 | 0.4293 | 1.5400 | 54.0000 | 17.236 |
| R8 | −8.6320 | 0.2373 | — | — | — |
| R9 | −120.0072 | 0.4309 | 1.5800 | 30.0000 | −30.790 |
| R10 | 21.1356 | 0.5606 | — | — | — |
| R11 | 13.7926 | 0.5862 | 1.5360 | 54.0000 | 10.799 |
| R12 | −10.0765 | 0.9731 | — | — | — |
| R13 | 7.7144 | 0.5736 | 1.5360 | 53.0000 | −9.554 |
| R14 | 2.9961 | 0.9816 | — | — | — |
| R15 | −5.4663 | 0.1000 | 1.6200 | 48.0000 | −12.074 |
| R16 | 189.1817 | 0.0500 | 1.3840 | 71.2000 | −1216.740 |

TABLE 46
Twelfth Example Lens Data 2

| | |
|---|---|
| Fno | 1.846 |
| Focal length of entire system of imaging lens | 5.976 |
| Focal length of first lens group | 5.753 |
| Focal length of second lens group | −13.202 |
| Half angle of view | 41.276 |
| Angle of view | 82.551 |
| Entire optical length | 7.250 |
| Image height | 5.560 |

TABLE 47
Twelfth Example Lens Data 3 (Aspheric surface data)

| Surface | Conic | | | | | | |
|---|---|---|---|---|---|---|---|
| number | coefficient | A3 | A4 | A5 | A6 | A7 | A8 |
| R1 | 4.39216E+00 | — | −1.62838E−02 | — | −1.44000E−03 | — | 1.94579E−04 |
| R2 | 8.44549E+00 | — | −1.13274E−02 | — | 1.85024E−03 | — | −9.82220E−05 |
| R3 | 3.64875E+00 | — | 2.07004E−02 | — | 7.66604E−04 | — | 1.04787E−04 |
| R4 | −4.89331E+01 | — | 9.33272E−03 | — | −5.00452E−03 | — | 1.18873E−03 |
| R5 | 2.52539E+01 | — | 1.22105E−03 | — | −2.50187E−04 | — | 7.72981E−04 |
| R6 | 4.60351E+00 | — | −2.17249E−03 | — | 5.62531E−03 | — | −4.03273E−04 |
| R7 | −1.07046E+02 | — | −8.01249E−03 | — | −2.47491E−03 | — | −8.48993E−05 |
| R8 | −8.63203E+00 | — | 5.38441E−04 | — | −9.09965E−03 | — | 3.68479E−03 |
| R9 | −9.33322E+00 | −7.02795E−03 | 8.58533E−04 | −1.88644E−02 | 4.56076E−03 | 5.65184E−04 | −1.14007E−04 |
| R10 | −9.80322E+00 | −2.26708E−02 | 3.20571E−03 | −1.46320E−02 | 5.18836E−04 | 1.67268E−03 | 1.56063E−04 |
| R11 | 1.00000E+01 | 1.55960E−02 | 1.18987E−02 | −8.93290E−03 | 8.18598E−05 | 3.78548E−05 | 5.84463E−05 |
| R12 | −3.28274E+00 | −1.48716E−02 | 1.79313E−02 | −2.87972E−03 | −1.12013E−03 | 2.32814E−04 | 8.44287E−05 |
| R13 | 7.69882E−02 | −2.15959E−02 | −4.28047E−02 | 1.02673E−02 | 1.06368E−03 | −8.03181E−05 | −8.30085E−05 |
| R14 | −5.40490E+00 | −1.95857E−02 | −2.23671E−02 | 9.99560E−03 | −9.43981E−05 | −5.27850E−04 | 6.14346E−05 |
| R15 | 0.00000E+00 | — | 5.21289E−03 | — | −1.34569E−04 | — | 1.15965E−05 |
| R16 | 0.00000E+00 | — | −1.03180E−03 | — | −1.20830E−04 | — | 2.23205E−05 |

| | A9 | A10 | A11 | A12 | A13 | A14 | A15 |
|---|---|---|---|---|---|---|---|
| R1 | — | 4.24898E−05 | — | −9.34359E−06 | — | — | — |
| R2 | — | 3.38342E−05 | — | −3.31064E−06 | — | — | — |
| R3 | — | −9.27454E−05 | — | 9.07591E−06 | — | — | — |
| R4 | — | −1.23801E−04 | — | −3.24734E−06 | — | — | — |
| R5 | — | −9.32095E−05 | — | −2.07602E−05 | — | −1.19949E−06 | — |
| R6 | — | 3.31135E−04 | — | −3.48368E−05 | — | 5.65473E−06 | — |
| R7 | — | 6.21427E−04 | — | −8.11338E−05 | — | 2.35939E−05 | — |
| R8 | — | −7.29710E−04 | — | 8.75905E−05 | — | 9.77448E−07 | — |
| R9 | 1.49821E−04 | 4.35368E−05 | −1.04718E−05 | −2.35105E−05 | −5.17824E−06 | 9.22442E−07 | 1.94086E−07 |
| R10 | −9.29178E−07 | −2.01793E−05 | 1.95228E−06 | 1.95636E−07 | 5.07510E−08 | 3.11607E−07 | 4.25517E−08 |
| R11 | −1.02879E−05 | 4.87310E−06 | 3.89115E−06 | −8.65069E−07 | 3.82439E−07 | −1.09010E−07 | 3.60500E−08 |
| R12 | −8.48499E−06 | −4.50648E−06 | −4.20676E−07 | −1.05003E−08 | 7.87282E−08 | 9.75281E−09 | −2.57128E−09 |
| R13 | 1.65241E−06 | 2.30234E−06 | 2.06012E−08 | −4.95312E−08 | −1.04377E−10 | 3.83904E−10 | −9.67475E−11 |
| R14 | 5.14699E−07 | 4.48892E−07 | 6.66851E−08 | −4.93415E−08 | −1.34068E−09 | 1.06133E−09 | −1.03778E−10 |
| R15 | — | −6.98162E−07 | — | 1.45107E−08 | — | — | — |
| R16 | — | −1.03832E−06 | — | 1.53410E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 9.55170E−09 | −9.54892E−08 | −1.06704E−07 | −6.47634E−08 | −2.26671E−08 |
| R10 | −1.86429E−08 | −1.50200E−08 | −5.55781E−09 | 1.87918E−09 | 2.14864E−09 |
| R11 | 6.08131E−09 | −1.96736E−09 | −1.43484E−09 | −1.57115E−10 | 4.54685E−11 |
| R12 | −8.15952E−11 | 3.98570E−12 | −4.28822E−12 | −1.58272E−12 | −1.32811E−12 |
| R13 | −1.29274E−11 | −2.65389E−12 | −3.81315E−13 | 5.07748E−14 | 5.18936E−14 |
| R14 | −2.76622E−11 | −2.33934E−12 | 1.44245E−14 | 1.48419E−13 | 7.68536E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 48 below.

TABLE 48

| | | |
|---|---|---|
| (101) | 5.0<f/(\|fa1/fa2\|)<500 | 13.715 |
| (201) | 10<\|fa2/(f9/f8)\|<5000 | 1330.453 |
| (301) | \|(f8*Nd8)/(f9*Nd9)\|<30 | 0.022 |
| (401) | \|((R15 − R16)/(R15 + R16))\|<3.5 | 1.060 |
| (501) | TL/IH<1.6 | 1.304 |
| (601) | \|(f1 + f2)/f3\|<8.0 | 2.520 |
| (701) | (Vd2/Vd3)/(Vd4/Vd5)<3.5 | 1.395 |
| (801) | \|(f4 + f5 + f6)/f7\|<14 | 0.288 |

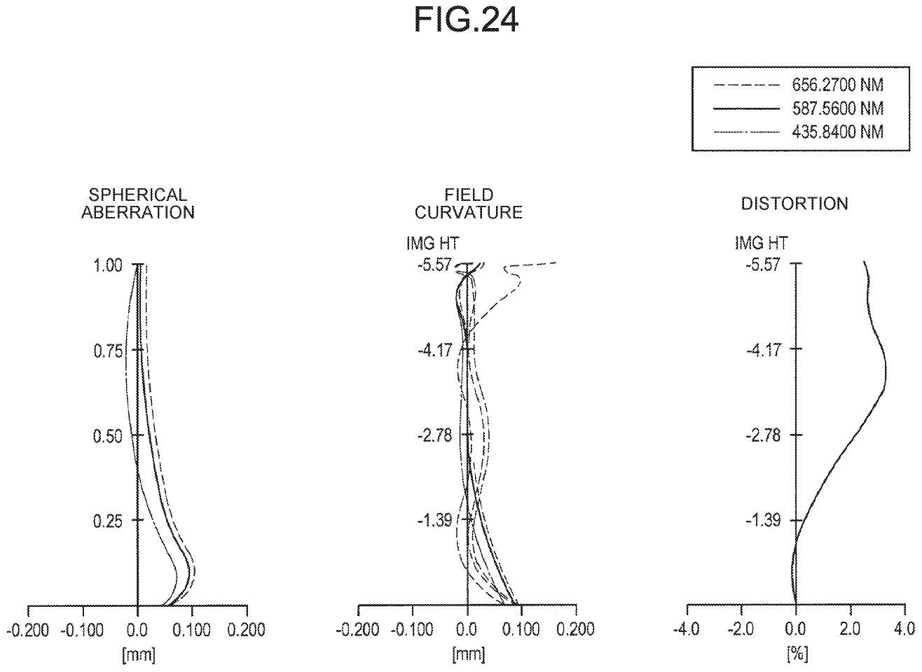

FIG. 24 is a longitudinal aberration diagram in a visible light wavelength band acquired by the imaging lens 100 according to the twelfth example.

### 2.13. Thirteenth Example

Subsequently, the thirteenth example of the imaging lens 100 according to the present embodiment will be specifically explained.

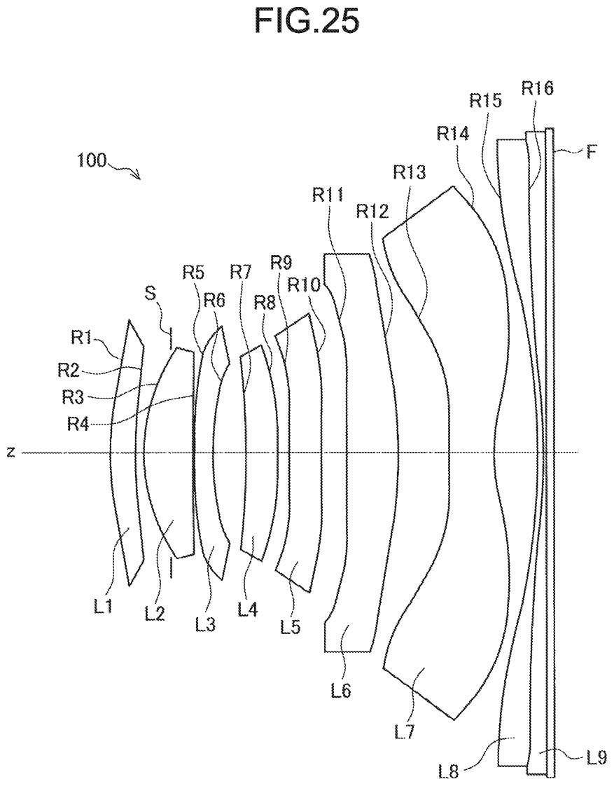

FIG. 25 is a diagram illustrating a structure of the imaging lens 100 according to the thirteenth example. The imaging lens 100 according to the thirteenth example also has nine pieces of lenses similarly to the above examples. Moreover, in terms of shape also, similarly to the above examples, the surface of the second lens L2 on the imaging object side (the first surface R3 of the second lens L2) is a convex surface, and the surface of the third lens L3 on the image side (the second surface R6 of the third lens L3) is a concave surface.

Table 49 to Table 51 show specific lens data of the imaging lens 100 according to the thirteenth example. More specifically, Table 49 shows basic lens data of the respective lenses provided in the imaging lens 100 according to the thirteenth example. Table 50 shows basic lens data about the entire system (or the first lens group La1 and the second lens group La2) of the imaging lens 100 according to the thirteenth example. Table 51 shows aspheric surface data of the respective lenses provided in the imaging lens 100 according to the thirteenth example. What is described in the respective tables are similar to those of the above examples and, therefore, explanation thereof is omitted.

TABLE 49
Thirteenth Example Lens Data 1

| | | | Refrac- | | |
|---|---|---|---|---|---|
| Surface | Curvature | | tive | Abbe | Focal |
| number | radius | Interval | index | number | length |
| R1 | 4.3630 | 0.4417 | 1.5400 | 54.0000 | 20.969 |
| R2 | 6.8143 | 0.1451 | — | — | — |
| R3 | 3.5002 | 0.8563 | 1.5400 | 54.0000 | 6.470 |
| R4 | 600.7645 | 0.0310 | — | — | — |
| R5 | 13.1144 | 0.3210 | 1.6600 | 20.5000 | −12.693 |
| R6 | 5.0676 | 0.3440 | — | — | — |
| R7 | −43.6917 | 0.5592 | 1.5400 | 54.0000 | 26.239 |
| R8 | −10.8059 | 0.2073 | — | — | — |
| R9 | 32.2024 | 0.5445 | 1.6320 | 23.6000 | −43.204 |
| R10 | 14.7228 | 0.4445 | — | — | — |
| R11 | 29.9706 | 0.8966 | 1.5400 | 54.0000 | 11.440 |
| R12 | −7.7695 | 0.8854 | — | — | — |
| R13 | 13.5599 | 0.8107 | 1.5360 | 53.0000 | −6.789 |
| R14 | 2.8069 | 0.7565 | — | — | — |
| R15 | −15.8850 | 0.1000 | 1.6600 | 19.5000 | −322.444 |
| R16 | −7.4109 | 0.0500 | 1.3840 | 71.2000 | 40.741 |

TABLE 50
Thirteenth Example Lens Data 2

| | |
|---|---|
| Fno | 1.670 |
| Focal length of entire system of imaging lens | 6.090 |
| Focal length of first lens group | 6.023 |
| Focal length of second lens group | −352.579 |
| Half angle of view | 40.223 |
| Angle of view | 80.446 |
| Entire optical length | 7.760 |
| Image height | 5.560 |

TABLE 51
Thirteenth Example Lens Data 3 (Aspheric surface Data)

| Surface | Conic | | | | | | |
|---|---|---|---|---|---|---|---|
| number | coefficient | A3 | A4 | A5 | A6 | A7 | A8 |
| R1 | 4.36303E+00 | — | −1.70634E−02 | — | −1.57451E−03 | — | 2.01569E−04 |
| R2 | 6.81435E+00 | — | −1.34053E−02 | — | 1.87612E−03 | — | −1.40375E−04 |
| R3 | 3.50022E+00 | — | 2.01449E−02 | — | 5.44134E−04 | — | 1.36088E−04 |
| R4 | 6.00764E+02 | — | 9.56914E−03 | — | −5.52020E−03 | — | 1.27821E−03 |
| R5 | 1.31144E+01 | — | −1.60933E−04 | — | −5.16762E−04 | — | 1.02445E−03 |
| R6 | 5.06761E+00 | — | −2.66729E−03 | — | 5.51265E−03 | — | −5.04736E−04 |
| R7 | −4.36917E+01 | — | −7.45262E−03 | — | −2.31283E−03 | — | −2.58988E−04 |
| R8 | −1.08059E+01 | — | −4.17740E−03 | — | −9.75071E−03 | — | 4.58207E−03 |
| R9 | −9.33322E+00 | −9.04815E−03 | 3.22111E−03 | −2.14364E−02 | 4.88255E−03 | 6.58129E−04 | −7.80693E−05 |
| R10 | −9.80322E+00 | −1.34418E−02 | 5.95202E−03 | −1.53395E−02 | 5.42212E−04 | 1.81891E−03 | 1.16520E−04 |
| R11 | 1.00000E+01 | −1.55960E−02 | 1.18987E−02 | −8.93290E−03 | 8.18598E−05 | 3.78548E−05 | 5.84463E−05 |
| R12 | −3.28274E+00 | −1.74033E−02 | 1.80333E−02 | −3.18639E−03 | −1.22542E−03 | 2.88862E−04 | 1.04862E−04 |
| R13 | 7.69882E−02 | −2.40739E−02 | −4.46863E−02 | 1.15826E−02 | 1.22108E−03 | −9.54342E−05 | −1.00652E−04 |
| R14 | −5.40490E+00 | −1.37397E−02 | −2.69344E−02 | 1.09390E−02 | −6.08346E−05 | −6.09261E−04 | 7.37071E−05 |
| R15 | 0.00000E+00 | — | 5.21289E−03 | — | −1.34569E−04 | — | 1.15965E−05 |
| R16 | 0.00000E+00 | — | −1.03180E−03 | — | −1.20830E−04 | — | 2.23205E−05 |

| | A9 | A10 | A11 | A12 | A13 | A14 | A15 |
|---|---|---|---|---|---|---|---|
| R1 | — | 4.89342E−05 | — | −9.87646E−06 | — | — | — |
| R2 | — | 4.21633E−05 | — | −2.14655E−06 | — | — | — |
| R3 | — | −1.12233E−04 | — | 7.13454E−06 | — | — | — |
| R4 | — | −1.61728E−04 | — | 1.02339E−05 | — | — | — |
| R5 | — | −4.80768E−05 | — | −1.07338E−05 | — | 1.30969E−06 | — |
| R6 | — | 4.45520E−04 | — | −4.32485E−05 | — | 6.07001E−06 | — |
| R7 | — | 6.74739E−04 | — | −1.50712E−04 | — | 1.47969E−05 | — |
| R8 | — | −9.38099E−04 | — | 1.16421E−04 | — | −7.44988E−06 | — |
| R9 | 2.26131E−04 | 7.31514E−05 | −7.09891E−06 | −2.95677E−05 | −7.08343E−06 | 1.10814E−06 | 1.52547E−07 |
| R10 | −2.66440E−05 | −3.23536E−05 | 1.08857E−06 | 1.10416E−07 | 1.49225E−07 | 4.70355E−07 | 6.67906E−08 |
| R11 | −1.02879E−05 | 4.87310E−06 | 3.89115E−06 | −8.65069E−07 | 3.82439E−07 | −1.09010E−07 | 3.60500E−08 |
| R12 | −9.87332E−06 | −5.61733E−06 | −5.59514E−07 | −2.74727E−08 | 1.02144E−07 | 1.20919E−08 | −4.08581E−09 |
| R13 | 1.84579E−06 | 2.85144E−06 | 2.19643E−08 | −6.55207E−08 | 1.05983E−10 | 6.20362E−10 | −1.16823E−10 |
| R14 | 6.89719E−07 | 5.86703E−07 | 1.00908E−07 | −6.11193E−08 | −5.56863E−10 | 1.76354E−09 | −1.03879E−10 |
| R15 | — | −6.98162E−07 | — | 1.45107E−08 | — | — | — |
| R16 | — | −1.03832E−06 | — | 1.53410E−08 | — | — | — |

| | A16 | A17 | A18 | A19 | A20 |
|---|---|---|---|---|---|
| R1 | — | — | — | — | — |
| R2 | — | — | — | — | — |
| R3 | — | — | — | — | — |
| R4 | — | — | — | — | — |
| R5 | — | — | — | — | — |
| R6 | — | — | — | — | — |
| R7 | — | — | — | — | — |
| R8 | — | — | — | — | — |
| R9 | 3.36691E−08 | −6.96912E−08 | −7.12384E−08 | −2.23294E−08 | 3.02375E−08 |
| R10 | −2.54601E−08 | −2.68108E−08 | −1.01154E−08 | 3.40879E−10 | 1.17358E−09 |
| R11 | 6.08131E−09 | −1.96736E−09 | −1.43484E−09 | −1.57115E−10 | 4.54685E−11 |
| R12 | −2.01181E−10 | −6.29222E−12 | −4.63917E−12 | −6.00047E−13 | −1.23445E−12 |
| R13 | −1.32205E−11 | −3.14087E−12 | −6.02730E−13 | 4.76578E−15 | 5.85826E−14 |
| R14 | −3.54324E−11 | −3.44056E−12 | −2.50973E−13 | 6.89847E−14 | 5.89689E−14 |
| R15 | — | — | — | — | — |
| R16 | — | — | — | — | — |

Moreover, values of parameters in above Inequation (101) to Inequation (801) implemented by the imaging lens 100 having these lens groups are as in Table 52 below.

TABLE 52

| | | |
|---|---|---|
| (101) | 5.0<f/(\|fa1/fa2\|)<500 | 356.500 |
| (201) | 10<\|fa2/(f9/f8)\|<5000 | 44.549 |
| (301) | \|(f8*Nd8)/(f9*Nd9)\|<30 | 18.183 |
| (401) | \|((R15 − R16)/(R15 + R16))\|<3.5 | 0.364 |
| (501) | TL/IH<1.6 | 1.396 |
| (601) | \|(f1 + f2)/f3\|<8.0 | 2.162 |
| (701) | (Vd2/Vd3)/(Vd4/Vd5)<3.5 | 1.151 |
| (801) | \|(f4 + f5 + f6)/f7\|<14 | 0.814 |

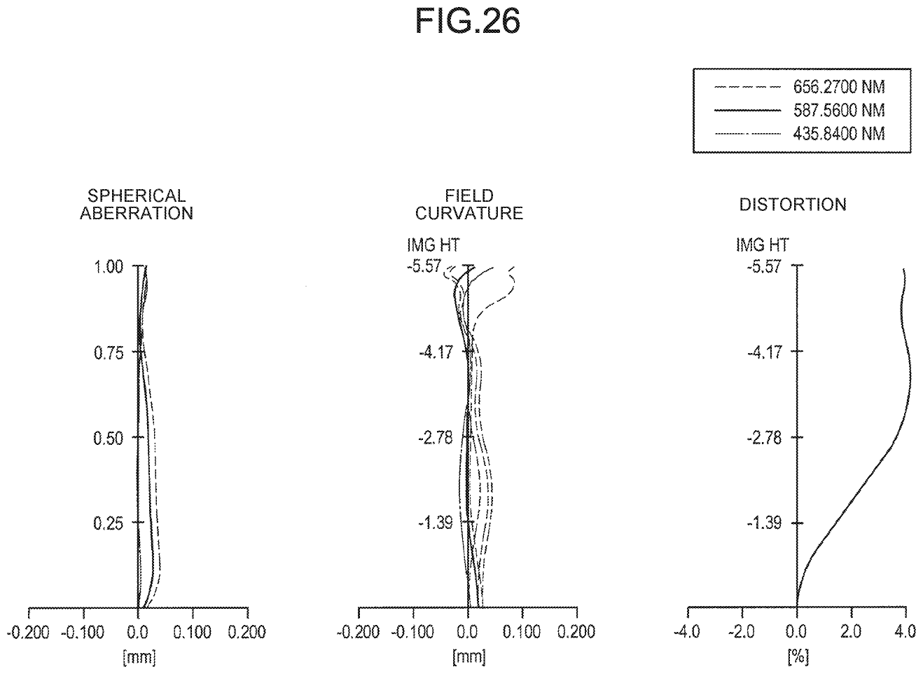

FIG. 26 is a longitudinal aberration diagram in a visible light wavelength band acquired by the imaging lens 100 according to the thirteenth example.

### 3. One Embodiment of Imaging Apparatus

Various examples of the imaging lens 100 according to the present embodiment have been specifically explained above. Subsequently, one embodiment of an imaging apparatus that is equipped with the imaging lens 100 (for example, the imaging lens 100 according to the first example to the thirteenth example) according to the present embodiment will be explained.

It is assumed that the imaging apparatus according to the present embodiment is a camera-equipped mobile phone, a smartphone, a digital still camera, or the like. Moreover, because the present disclosure enables to make the imaging lens 100 more compact and thinner, the imaging apparatus according to the present embodiment is assumed to be a particularly compact and thin apparatus. The type of the imaging apparatus, or the size thereof is not particularly limited. Moreover, an installation form of the imaging lens 100 in the imaging apparatus is not particularly limited either. For example, when the imaging apparatus is a smartphone, the imaging lens 100 may be arranged in either orientation toward a front side or a rear side of the smartphone.

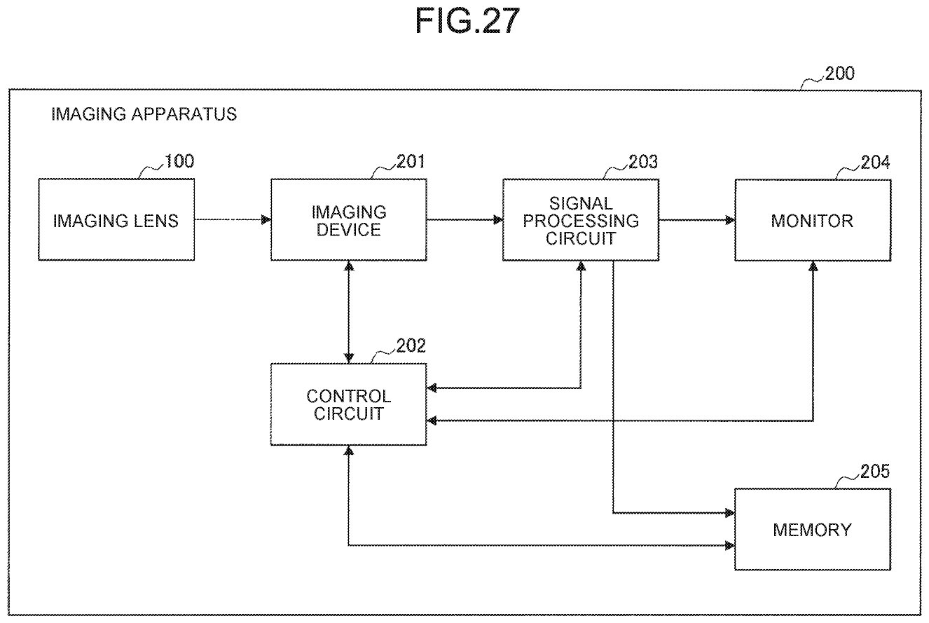

FIG. 27 is a block diagram illustrating a configuration of an imaging apparatus 200 according to the present embodiment. As illustrated in FIG. 27, the imaging apparatus 200 includes the imaging lens 100, an imaging device 201, a control circuit 202, a signal processing circuit 203, a monitor 204, and a memory 205.

The imaging lens 100 is an optical system that has been explained above. The imaging lens 100 is an optical system to form an image of a subject on the imaging device 201. The imaging lens 100 has a nine-piece lens group as explained above, and thereby has optical characteristics supporting the increased definition and size of the imaging device 201 while being compact and thin.

The imaging device 201 is configured to have multiple pixels on an image forming surface, and the respective pixels convert a subject image formed by the imaging lens into electrical signals (pixel signals). The pixel signals are read from the respective pixels by a control of the control circuit 202, and provided to the signal processing circuit 203. The imaging device 201 is, for example, a CCD sensor array, a CMOS sensor array, or the like, but not necessarily limited thereto.

The control circuit 202 is configured to overall control the respective components included in the imaging apparatus 200. For example, the imaging circuit 202 controls processing of generating a pixel signal by the imaging device 201, various kinds of processing performed by the signal processing circuit 203 with respect to the pixel signals, or the like. More specifically, when an input unit (not illustrated) receives an input from an operator of the imaging apparatus 200, the control circuit 202 generates a control signal according to the input, and provides the control signal to the imaging device 201, the signal processing circuit 203, or the like, to control various kinds of processing performed by these components. The control by the control circuit 202 is not limited thereto.

The signal processing circuit 203 is configured to perform various kinds of processing with respect to the pixel signals provided from the imaging device 201. For example, the signal processing circuit 203 performs noise removal, gain adjustment, wave shaping, A/D conversion, white balance adjustment, brightness adjustment, contrast value adjustment, sharpness (edge enhancement) adjustment, color correction, blurriness correction, and the like with respect to the pixel signals. Various kinds of processing performed by a signal processing unit 230 are not limited thereto. The signal processing circuit 203 provides the pixel signal subjected to the various kinds of processing to the monitor 204 or the memory 205.

The monitor 204 is configured to visualize the pixel signals and the like. Thus, the operator of the imaging apparatus 200 can view a captured image captured by the imaging apparatus 200.

The memory 205 is configured to store various kinds of information. For example, the memory 205 stores the pixel signals provided by the signal processing circuit 203, and the like. Moreover, the memory 205 may store information used for various kinds of processing of the control circuit 202 and the like, information output by various kinds of processing, and the like. Information stored by the memory 205 is not limited thereto.

The configuration of the imaging apparatus 200 explained, referring to FIG. 27 is only one example, and the configuration of the imaging apparatus 200 is not necessarily limited to the example in FIG. 27. More specifically, the imaging apparatus 200 is not necessarily required to have the components illustrated in FIG. 27, and may include another component not illustrated in FIG. 27. For example, an actuator that drives the imaging lens 100 (assumed to be either one out of the first lens L1 to the seventh lens L7) vertically or horizontally relative to the image forming surface can be additionally provided for autofocus or camera shake correction. In that case, the control circuit 202 can control driving of the actuator.

As above, exemplary embodiments of the present disclosure have been explained in detail with reference to the accompanying drawings, the technical scope of the present disclosure is not limited to these examples. It is obvious that those who have ordinary knowledge in the technical field of the present disclosure can think of various kinds of modification examples and alteration examples within the scope of technical idea described in claims, and these are naturally understood to be included in the technical scope of the present disclosure.

Moreover, effects described in the present specification are only explanatory and exemplary, but not limited. That is, the technique according to the present disclosure can produce other effects obvious to those skilled in the art from description of the present specification, together with the effects described above or in place of the effects described above.

Following configurations also belong to the technical scope of the present disclosure.

(1)

An imaging lens that causes an imaging device to form an image of a subject, the imaging lens comprising, sequentially from an imaging object side:

a first lens group that has a positive refractive power; and

a second lens group that has a negative refractive power, wherein

the first lens group includes, sequentially from the imaging object side,
a first lens having a positive refractive power;
a second lens having a positive refractive power;
a third lens having a negative refractive power;
a fourth lens having any one of positive and negative refractive powers;
a fifth lens having any one of positive and negative refractive powers;
a sixth lens having any one of positive and negative refractive powers; and
a seventh lens having a negative refractive power, and

the second lens group includes, sequentially from the imaging object side,
an eighth lens having any one of positive and negative refractive powers; and
a ninth lens having any one of positive and negative refractive powers.
   (2)

The imaging lens according to (1), wherein

a condition expressed by following Inequation (101) is satisfied when a focal length with respect to a d-line (wavelength approximately 587.6 [nm]) of an entire imaging lens system is f, a focal length with respect to a d-line of the first lens group is fa1, and a focal length with respect to the d-line of the second lens group is fa2.

$$\begin{matrix}( 3 ) & \\ 5.0 < \vert \frac{f}{f a 1 \text{/} f a 2} \vert < 500 & ( 101 )\end{matrix}$$

The imaging lens according to (1) or (2), wherein

a condition expressed by following Inequation (201) is satisfied when a focal length with respect to the d-line of the second lens group is fa2, a focal length with respect to a d-line of the eighth lens is f8, and a focal length with respect to a d-line of the ninth lens is f9.

$$\begin{matrix}( 4 ) & \\ 10 < \vert \frac{f a 2}{ f 9 \text{/} f 8} \vert < 5000 & ( 201 )\end{matrix}$$

The imaging lens according to any one of (1) to (3), wherein

a condition expressed by following Inequation (301) is satisfied when a focal length with respect to the d-line of the eighth lens is f8, a focal length with respect to the d-line of the ninth lens is f9, a refractive index with respect to the d-line of the eighth lens is Nd8, and a refractive index with respect to a d-line of the ninth lens is Nd9.

$$\begin{matrix}( 5 ) & \\ \vert \frac{f 8 \times N d 8}{f 9 \times N d 9} \vert < 30 & ( 301 )\end{matrix}$$

The imaging lens according to any one of (1) to (4), wherein

a condition expressed by following Inequation (401) is satisfied when a curvature radius of a surface of the eight lens on the imaging object side is r15, and a curvature radius of a surface of the ninth lens on the imaging object side is r16.

$$\begin{matrix}( 6 ) & \\ \vert \frac{r 15 - r 16}{r 15 + r 16} \vert < 3.5 & ( 401 )\end{matrix}$$

The imaging lens according to any one of (1) to (5), wherein

a condition expressed by following Inequation (501) is satisfied when an entire optical length of the imaging lens is TL, and a maximum image height on an image forming surface is IH.

$$\begin{matrix}( 7 ) & \\ \frac{T L}{I H} < 1.6 & ( 501 )\end{matrix}$$

The imaging lens according to any one of (1) to (6), wherein

a surface of the second lens on the imaging object side is a convex surface.

(8)

The imaging lens according to any one of (1) to (7), wherein

a surface of the third lens on an image side is a concave surface.

(9)

The imaging lens according to any one of (1) to (8), wherein

a condition expressed by following Inequation (601) is satisfied when a focal length with respect to a d-line of the first lens is f1, a focal length with respect to a d-line of the second lens is f2, and a focal length with respect to a d-line of the third lens is f3.

$$\begin{matrix}( 10 ) & \\ \vert \frac{f 1 + f 2}{f 3} \vert < 8.0 & ( 601 )\end{matrix}$$

The imaging lens according to any one of (1) to (9), wherein

a condition expressed by following Inequation (701) is satisfied when an Abbe number with respect to a d-line of the second lens is νd2, an Abbe number with respect to the d-line of the third lens is νd3, an Abbe number with respect to the d-line of the fourth lens is νd4, and an Abbe number with respect to the d-line of the fifth lens is νd5.

$$\begin{matrix}( 11 ) & \\ \frac{v d 2 \text{/} v d 3}{v d 4 \text{/} v d 5} < 3.5 & ( 701 )\end{matrix}$$

The imaging lens according to any one of (1) to (10), wherein

a condition expressed by following Inequation (801) is satisfied when a focal length with respect to a d-line of the fourth lens is f4, a focal length with respect to the d-line of the fifth lens is f5, a focal length with respect to the d-line of the sixth lens is f6, and a focal length with respect to the d-line of the seventh lens is f7.

$$\begin{matrix}( 12 ) & \\ \vert \frac{f 4 + f 5 + f 6}{f 7} \vert < 14.0 & ( 801 )\end{matrix}$$

An imaging apparatus comprising, sequentially from an imaging object side:

a first lens group that has a positive refractive power;

a second lens group that has a negative refractive power; and

an imaging device that converts a subject image formed by the first lens group and the second lens group into an electrical signal, wherein

the first lens group includes, sequentially from the imaging object side,
a first lens having a positive refractive power;
a second lens having a positive refractive power;
a third lens having a negative refractive power;
a fourth lens having any one of positive and negative refractive powers;
a fifth lens having any one of positive and negative refractive powers;
a sixth lens having any one of positive and negative refractive powers; and
a seventh lens having a negative refractive power, and

the second lens group includes, sequentially from the imaging object side,
an eighth lens having any one of positive and negative refractive powers; and
a ninth lens having any one of positive and negative refractive powers.

### REFERENCE SIGNS LIST

100 IMAGING LENS
L1 FIRST LENS
L2 SECOND LENS
L3 THIRD LENS
L4 FOURTH LENS
L5 FIFTH LENS
L6 SIXTH LENS
L7 SEVENTH LENS
L8 EIGHTH LENS
L9 NINTH LENS
S DIAPHRAGM
F SEAL GLASS
200 IMAGING APPARATUS
201 IMAGING DEVICE
202 CONTROL CIRCUIT
203 SIGNAL PROCESSING CIRCUIT
204 MONITOR
205 MEMORY

1. An imaging lens that causes an imaging device to form an image of a subject, the imaging lens comprising, sequentially from an imaging object side:
a first lens group that has a positive refractive power; and
a second lens group that has a negative refractive power, wherein
the first lens group includes, sequentially from the imaging object side,
a first lens having a positive refractive power;
a second lens having a positive refractive power;
a third lens having a negative refractive power;
a fourth lens having any one of positive and negative refractive powers;
a fifth lens having any one of positive and negative refractive powers;
a sixth lens having any one of positive and negative refractive powers; and
a seventh lens having a negative refractive power, and
the second lens group includes, sequentially from the imaging object side,
an eighth lens having any one of positive and negative refractive powers; and
a ninth lens having any one of positive and negative refractive powers.

2. The imaging lens according to claim 1, wherein
a condition expressed by following Inequation (101) is satisfied when a focal length with respect to a d-line (wavelength approximately 587.6 [nm]) of an entire imaging lens system is f, a focal length with respect to a d-line of the first lens group is fa1, and a focal length with respect to the d-line of the second lens group is fa2.
$$5.0 < \vert \frac{f}{ f a 1 \text{/} f a 2} \vert < 500 \qquad ( 101 )$$

3. The imaging lens according to claim 1, wherein
a condition expressed by following Inequation (201) is satisfied when a focal length with respect to the d-line of the second lens group is fa2, a focal length with respect to a d-line of the eighth lens is f8, and a focal length with respect to a d-line of the ninth lens is f9.
$$10 < \vert \frac{f a 2}{ f 9 \text{/} f 8} \vert < 5000 \qquad ( 201 )$$

4. The imaging lens according to claim 1, wherein
a condition expressed by following Inequation (301) is satisfied when a focal length with respect to the d-line of the eighth lens is f8, a focal length with respect to the d-line of the ninth lens is f9, a refractive index with respect to the d-line of the eighth lens is Nd8, and a refractive index with respect to a d-line of the ninth lens is Nd9.
$$\vert \frac{f 8 \times N d 8}{f 9 \times N d 9} \vert < 30 \qquad ( 301 )$$

5. The imaging lens according to claim 1, wherein
a condition expressed by following Inequation (401) is satisfied when a curvature radius of a surface of the eight lens on the imaging object side is r15, and a curvature radius of a surface of the ninth lens on the imaging object side is r16.
$$\vert \frac{r 15 - r 16}{r 15 + r 16} \vert < 3.5 \qquad ( 401 )$$

6. The imaging lens according to claim 1, wherein
a condition expressed by following Inequation (501) is satisfied when an entire optical length of the imaging lens is TL, and a maximum image height on an image forming surface is IH.
$$\frac{T L}{I H} < 1.6 \qquad ( 501 )$$

7. The imaging lens according to claim 1, wherein
a surface of the second lens on the imaging object side is a convex surface.

8. The imaging lens according to claim 1, wherein
a surface of the third lens on an image side is a concave surface.

9. The imaging lens according to claim 1, wherein
a condition expressed by following Inequation (601) is satisfied when a focal length with respect to a d-line of the first lens is f1, a focal length with respect to a d-line of the second lens is f2, and a focal length with respect to a d-line of the third lens is f3.
$$\vert \frac{f 1 + f 2}{f 3} \vert < 8.0 \qquad ( 601 )$$

10. The imaging lens according to claim 1, wherein
a condition expressed by following Inequation (701) is satisfied when an Abbe number with respect to a d-line of the second lens is νd2, an Abbe number with respect to the d-line of the third lens is νd3, an Abbe number with respect to the d-line of the fourth lens is νd4, and an Abbe number with respect to the d-line of the fifth lens is νd5.
$$\frac{v d 2 \text{/} v d 3}{v d 4 \text{/} v d 5} < 3.5 \qquad ( 701 )$$

11. The imaging lens according to claim 1, wherein
a condition expressed by following Inequation (801) is satisfied when a focal length with respect to a d-line of the fourth lens is f4, a focal length with respect to the d-line of the fifth lens is f5, a focal length with respect to the d-line of the sixth lens is f6, and a focal length with respect to the d-line of the seventh lens is f7.
$$\vert \frac{f 4 + f 5 + f 6}{f 7} \vert < 14.0 \qquad ( 801 )$$

12. An imaging apparatus comprising, sequentially from an imaging object side:
a first lens group that has a positive refractive power;
a second lens group that has a negative refractive power; and
an imaging device that converts a subject image formed by the first lens group and the second lens group into an electrical signal, wherein
the first lens group includes, sequentially from the imaging object side,
a first lens having a positive refractive power;
a second lens having a positive refractive power;
a third lens having a negative refractive power;
a fourth lens having any one of positive and negative refractive powers;
a fifth lens having any one of positive and negative refractive powers;
a sixth lens having any one of positive and negative refractive powers; and
a seventh lens having a negative refractive power, and
the second lens group includes, sequentially from the imaging object side,
an eighth lens having any one of positive and negative refractive powers; and
a ninth lens having any one of positive and negative refractive powers.
